(19) United States
(12) Patent Application Publication
(10) Pub. No.: US 2015/0204598 A1
(43) Pub. Date: Jul. 23, 2015

(54) PORTABLE CRYOGENIC WORKSTATION

(71) Applicant: Brooks Automation, Inc., Chelmsford, MA (US)

(72) Inventors: Rhett L. Affleck, Poway, CA (US); Anthony C. Bonora, Portola Valley, CA (US); Etienne P. Croquette, Altrincham (GB); Robert K. Neeper, Ramona, CA (US)

(21) Appl. No.: 14/600,751

(22) Filed: Jan. 20, 2015

Related U.S. Application Data
(60) Provisional application No. 61/929,306, filed on Jan. 20, 2014.

(51) Int. Cl. F25D 3/10; F25D 23/02; G01F 23/22; G05D 1/02; G05B 15/02; F25D 29/00; B65B 3/00

(52) U.S. Cl. CPC F25D 3/107; F25D 29/001; F25D 23/02; B65B 3/003; G05D 1/021; G05B 15/02; G01F 23/22

(57) ABSTRACT

A portable cryogenic workstation includes a housing having an internal cavity configured to hold one or more samples, a lid for sealing the internal cavity such that the portable cryogenic workstation is configured for transporting samples between about room temperature environments to about ultra-cold environments, at least one automation interface disposed on one or more of the housing and lid and configured for engagement with automated handling equipment, and a process data capture unit coupled to the housing and configured to capture process or ephemeral data corresponding to a predetermined processing characteristic(s) of at least one of the samples coincident with presence inside the portable cryogenic workstation.

### CROSS-REFERENCE TO RELATED APPLICATIONS

This application is a non-provisional of and claims the benefit of U.S. provisional patent application No. 61/929,306 filed on Jan. 20, 2014, the disclosure of which is incorporated herein by reference in its entirety.

### BACKGROUND

1. Field

The exemplary embodiments generally relate to sample transport containers and, more particularly, to laboratory sample transport containers.

2. Brief Description of Related Developments

Generally samples, such as biological or cryogenic samples, are shipped or otherwise transferred (such as transported within a laboratory, facility or building or transported between laboratories, facilities or buildings) using flasks. One example of a shipping container is a Dewar type flask. To insert or remove samples from these conventional shipping containers the top of the container is removed and samples are inserted or removed from the container. However, the insertion and removal of the samples from the shipping container to, for example, a sample storage location is performed in an open atmosphere.

Many cryogenic samples may require cryogenic storage temperatures to retain biological or cryogenic viability. For example, temperatures below the glass transition temperature of water, e.g. about −135° C., are known to stop most biological degradation and retain cell viability. As such, many samples are stored near liquid nitrogen temperatures. However, samples are loaded and unloaded into conventional sample storage systems (e.g. such as liquid nitrogen (LN2) Dewars and −150° C. freezers) at room temperature, thereby subjecting the samples to temperatures that are about 200° C. above their storage temperature. Generally a bucket of dry ice (e.g. with a temperature of about −78° C.) is used to move samples across the laboratory however, samples are still subjected to room temperatures during loading and unloading to the storage system.

Also, in conventional storage systems, samples in storage are subjected to temperature fluctuations. For example, conventional −150° C. chest freezers subject most stored samples to temperature swings upon opening and closing the lid. For manual LN2 Dewars, stacks of samples are removed into the room temperature environment in order to add or remove a single sample.

It would be advantageous to be able to insert and remove samples from a shipping container capable of cryogenic storage yet facilitating ease of access without heat load compromise in a controlled environment such that moisture and gases entering, for example, a sample storage system can be controlled and/or a heat load introduced into the sample storage system can be minimized to negligible levels. It would also be advantageous to protect samples within the shipping container from temperature fluctuations during the loading and unloading of samples to the sample storage system.

### BRIEF DESCRIPTION OF THE DRAWINGS

The foregoing aspects and other features of the disclosed embodiment are explained in the following description, taken in connection with the accompanying drawings, wherein:

FIGS. 1A-1M are schematic illustrations of a portable cryogenic workstation and portions thereof in accordance with aspects of the disclosed embodiment;

FIGS. 1N-1P are schematic illustrations of portions of a portable cryogenic workstation in accordance with aspects of the disclosed embodiment;

FIGS. 1Q and 1R are schematic illustrations of a portable cryogenic workstation in accordance with aspects of the disclosed embodiment;

FIGS. 1S and 1T are schematic illustrations of portions of a portable cryogenic workstation in accordance with aspects of the disclosed embodiment;

FIG. 1U is schematic illustration of a portion of a portable cryogenic workstation in accordance with aspects of the disclosed embodiment;

FIG. 2 is a schematic illustration of a representative automated sample storage system in accordance with aspects of the disclosed embodiment;

FIGS. 2A-2D are schematic illustrations of portions of the sample storage system in accordance with aspects of the disclosed embodiment;

FIGS. 2E and 2F are schematic illustrations of portions of the sample storage system in accordance with aspects of the disclosed embodiment;

FIGS. 3A and 3B are schematic illustrations of a portable cryogenic workstation interfaced with a sample storage system in accordance with aspects of the disclosed embodiment;

FIGS. 4A-4D are schematic illustrations of an interface process between a portable cryogenic workstation and a sample storage system in accordance with aspects of the disclosed embodiment;

FIGS. 4E and 4F are schematic illustrations of an interface process between a portable cryogenic workstation and a sample storage system in accordance with aspects of the disclosed embodiment;

FIGS. 5A and 5B are schematic illustrations of portions of a sample storage system in accordance with aspects of the disclosed embodiment;

FIGS. 6A-6C are schematic illustrations of an interface process between a portable cryogenic workstation and a sample storage system in accordance with aspects of the disclosed embodiment;

FIGS. 7 and 8 are flow diagrams in accordance with aspects of the disclosed embodiment;

FIG. 9 is a schematic illustration of accessing samples in a portable cryogenic workstation apart from the sample storage system and transporting the portable cryogenic workstation to the storage system;

FIGS. 9A-9F are schematic illustrations of portions of a sample storage and transportations system in accordance with aspects of the disclosed embodiment;

FIG. 9G is a schematic illustration of a facility incorporating aspects of the disclosed embodiment;

FIG. 9H is a flow diagram in accordance with aspects of the disclosed embodiment;

FIGS. 9I-9K are schematic illustrations of portions of a sample storage and transportations system in accordance with aspects of the disclosed embodiment;

FIGS. 10A-10D are schematic illustrations of a portable cryogenic workstation in accordance with aspects of the disclosed embodiment;

FIG. 11 is an exemplary flow diagram for assembling a portable cryogenic workstation in accordance with aspects of the disclosed embodiment

FIG. 12A is a schematic illustration of a sample storage system in accordance with aspects of the disclosed embodiment;

FIG. 12B is a schematic illustration of a refrigerant replenishing station in accordance with aspects of the disclosed embodiment;

FIGS. 12C and 12D are schematic illustrations of portions of a refrigerant replenishment system of a sample storage system or refrigerant replenishing station in accordance with aspects of the disclosed embodiment;

FIG. 13 is a schematic illustration of a portion of a refrigerant replenishment system of a sample storage system or refrigerant replenishing station in accordance with aspects of the disclosed embodiment;

FIGS. 14A-14D are schematic illustrations of a portable cryogenic workstation in accordance with aspects of the disclosed embodiment;

FIG. 14E is a schematic illustration of portions of a sample storage and transportations system in accordance with aspects of the disclosed embodiment;

FIG. 14F is a schematic illustration of a portion of a refrigerant replenishment system of a sample storage system or refrigerant replenishing station in accordance with aspects of the disclosed embodiment;

FIGS. 15 and 16 are schematic illustrations of a portion of a portable cryogenic workstation in accordance with aspects of the disclosed embodiment;

FIGS. 17A-17G are schematic illustrations of a sample handling station in accordance with aspects of the disclosed embodiment;

FIG. 18 is a flow diagram in accordance with aspects of the disclosed embodiment;

FIGS. 19 and 20 are schematic illustrations of portable cryogenic workstation communications in accordance with aspects of the disclosed embodiment.

### DETAILED DESCRIPTION

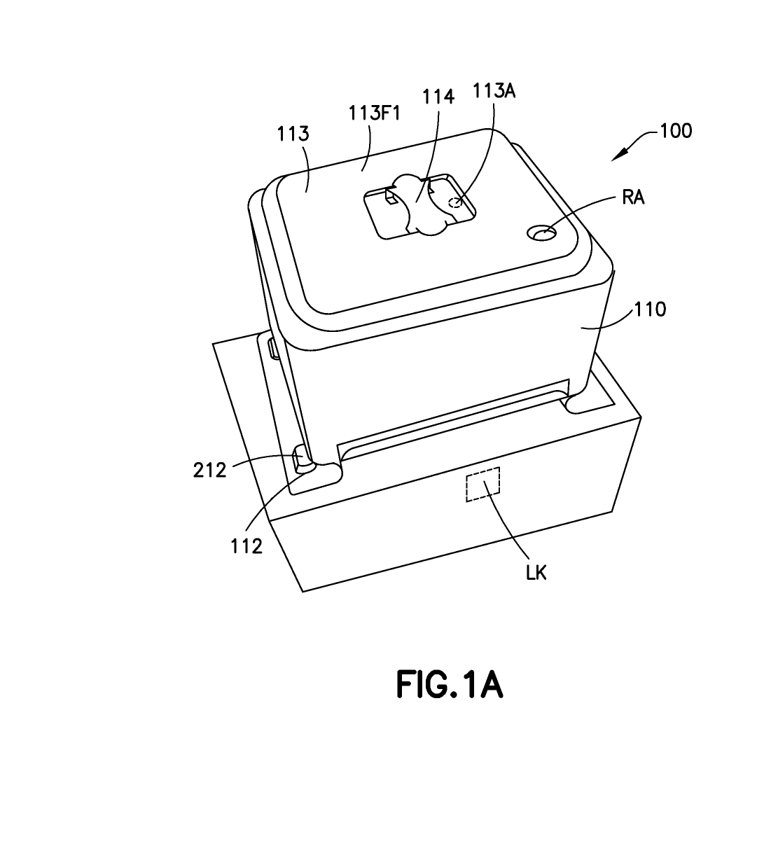

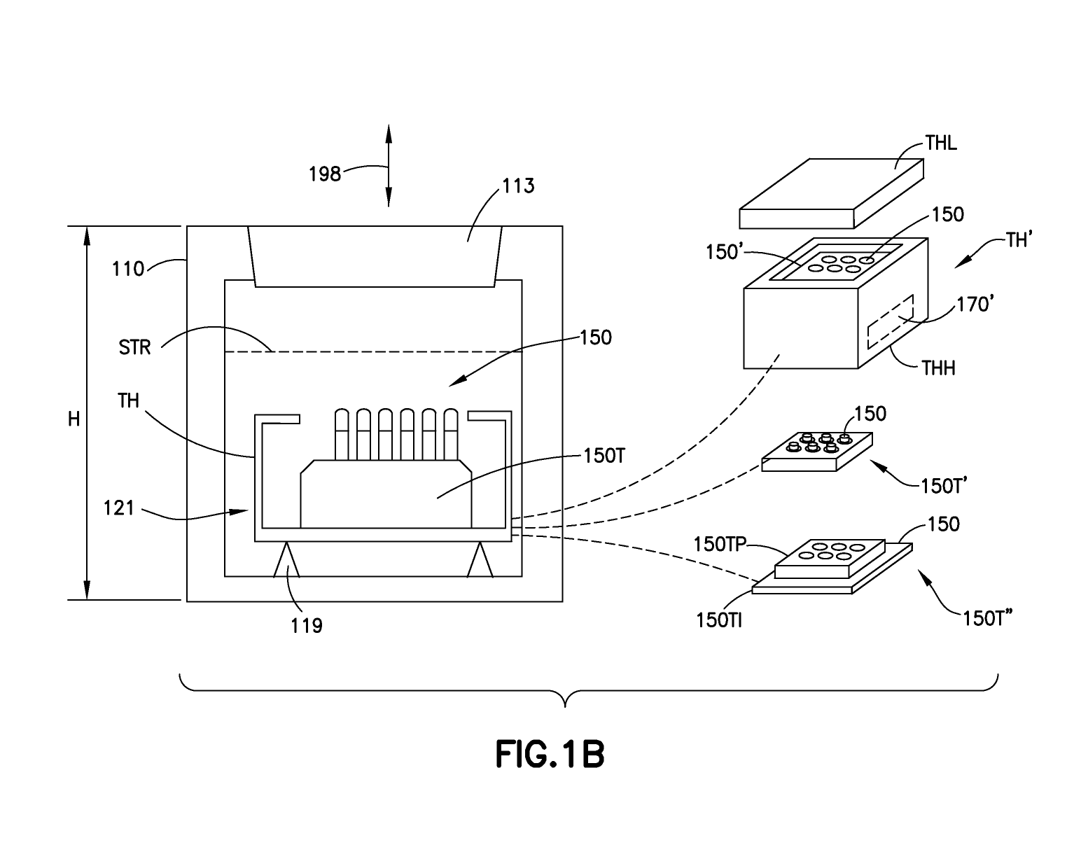

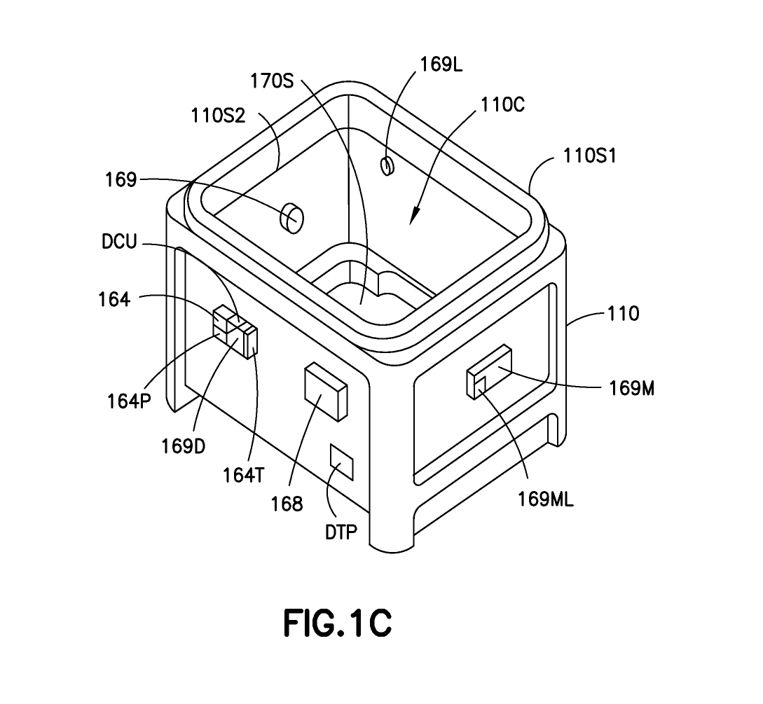

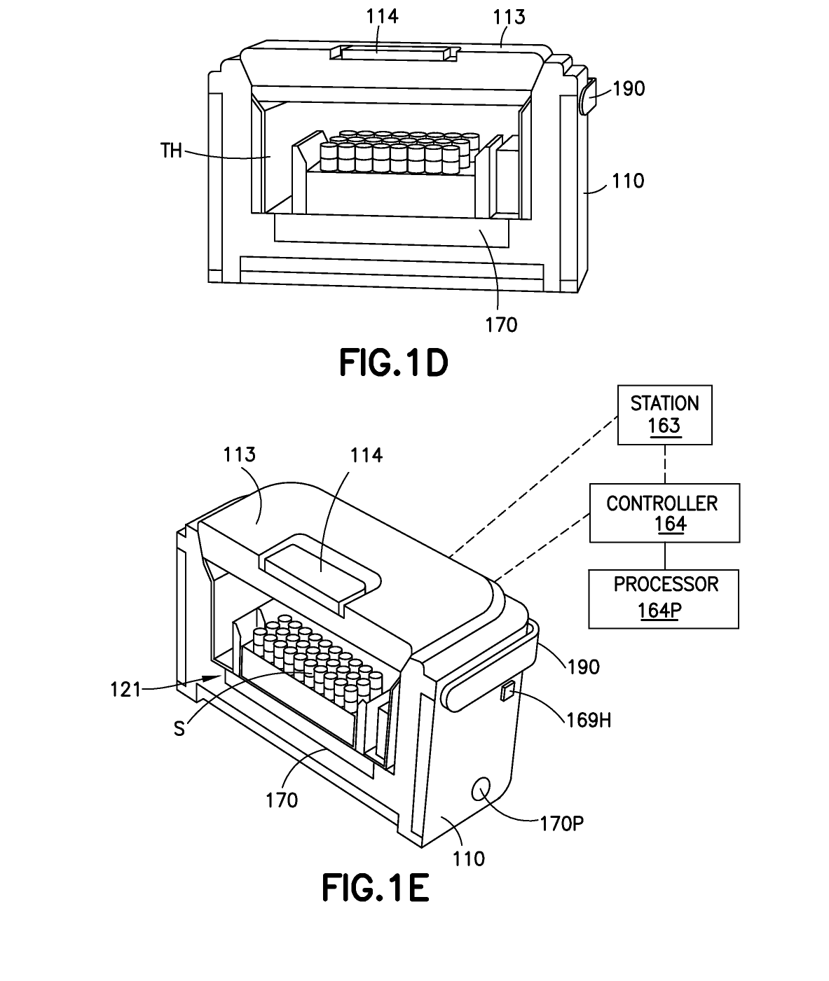

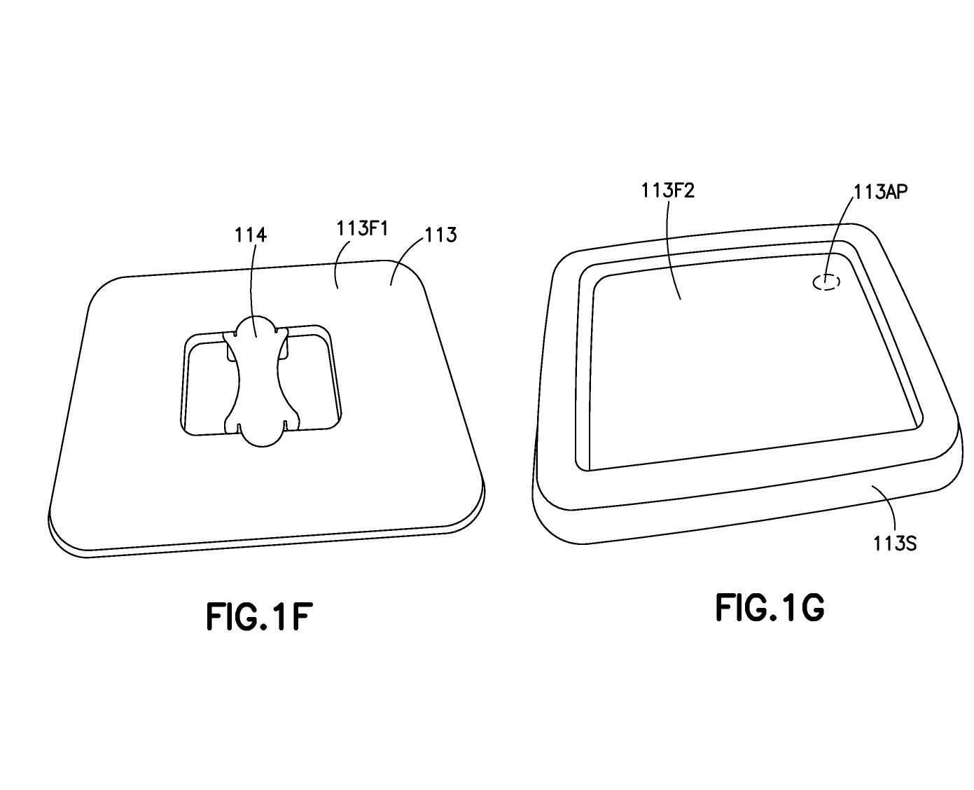

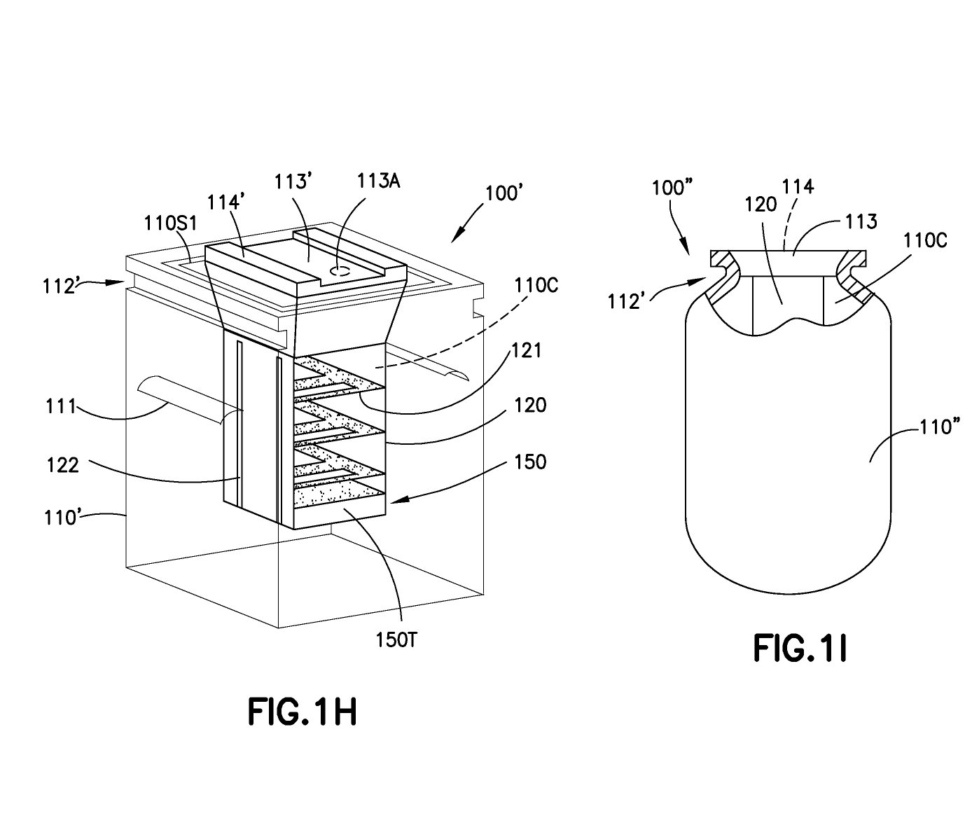

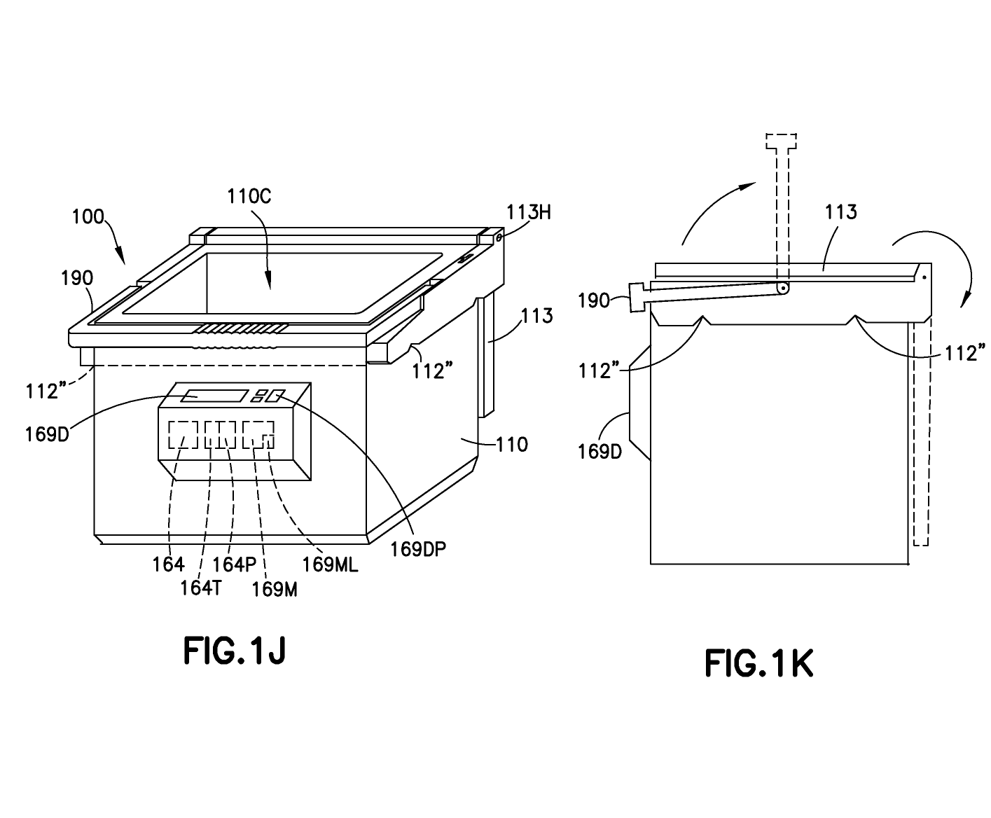

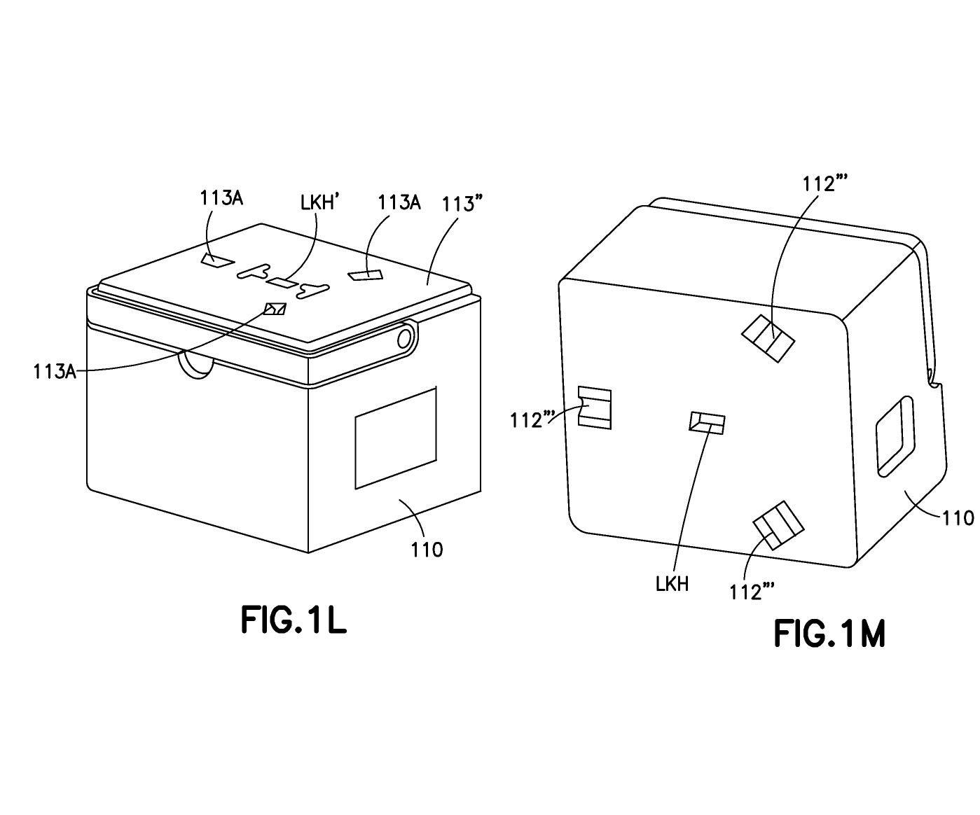

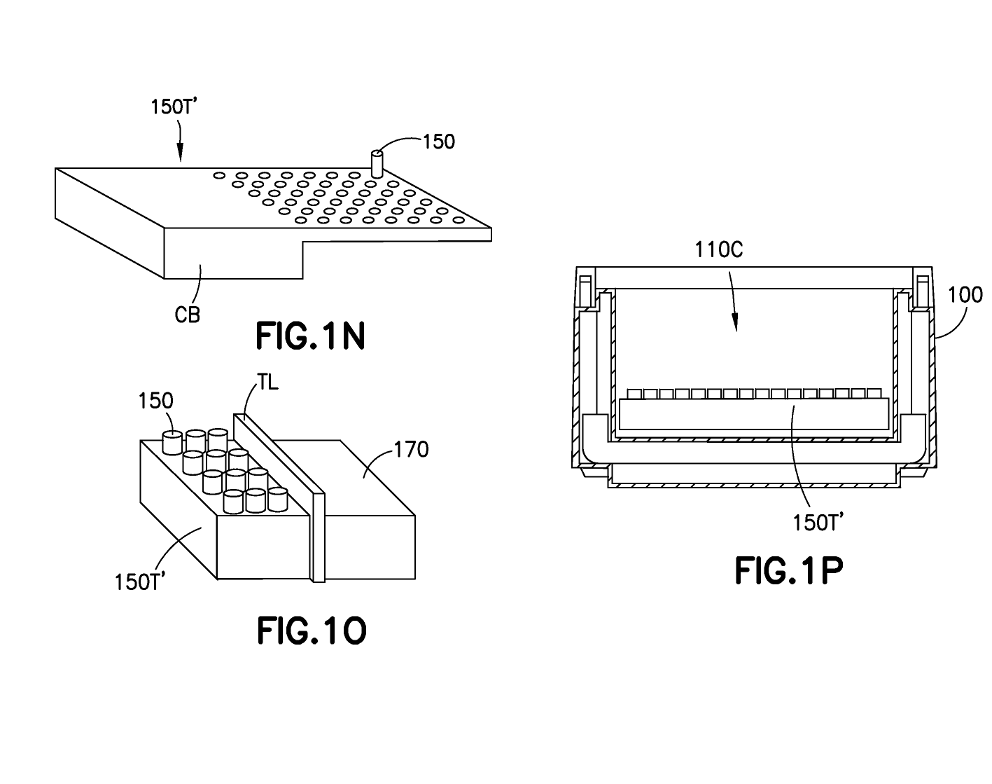

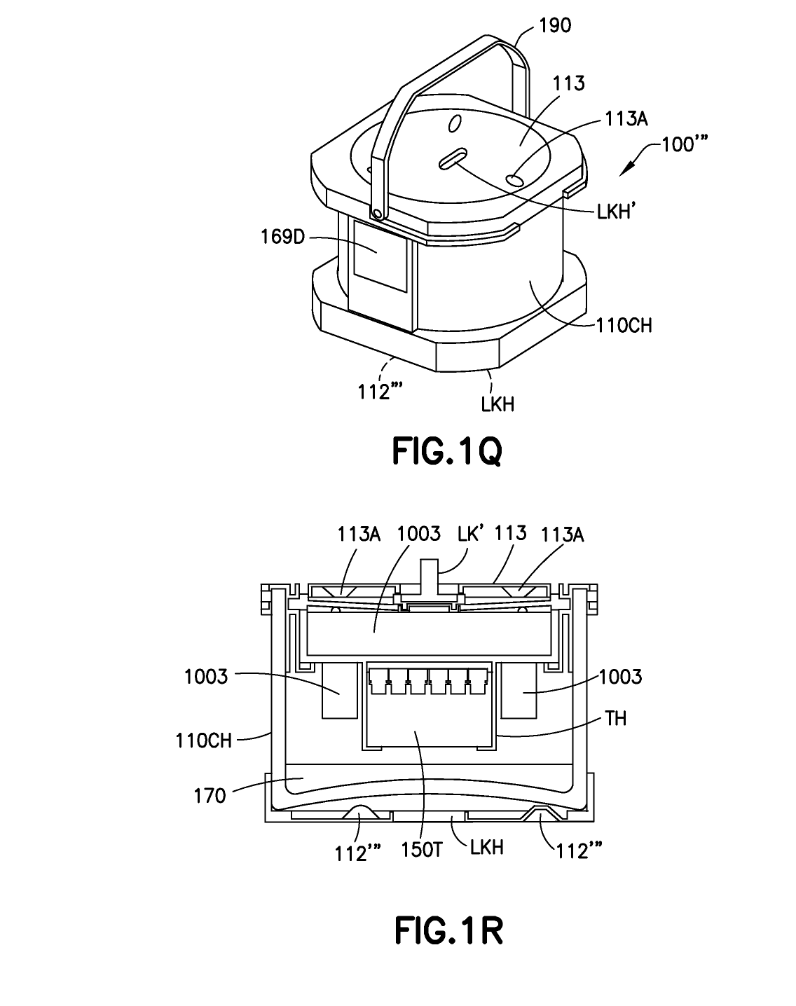

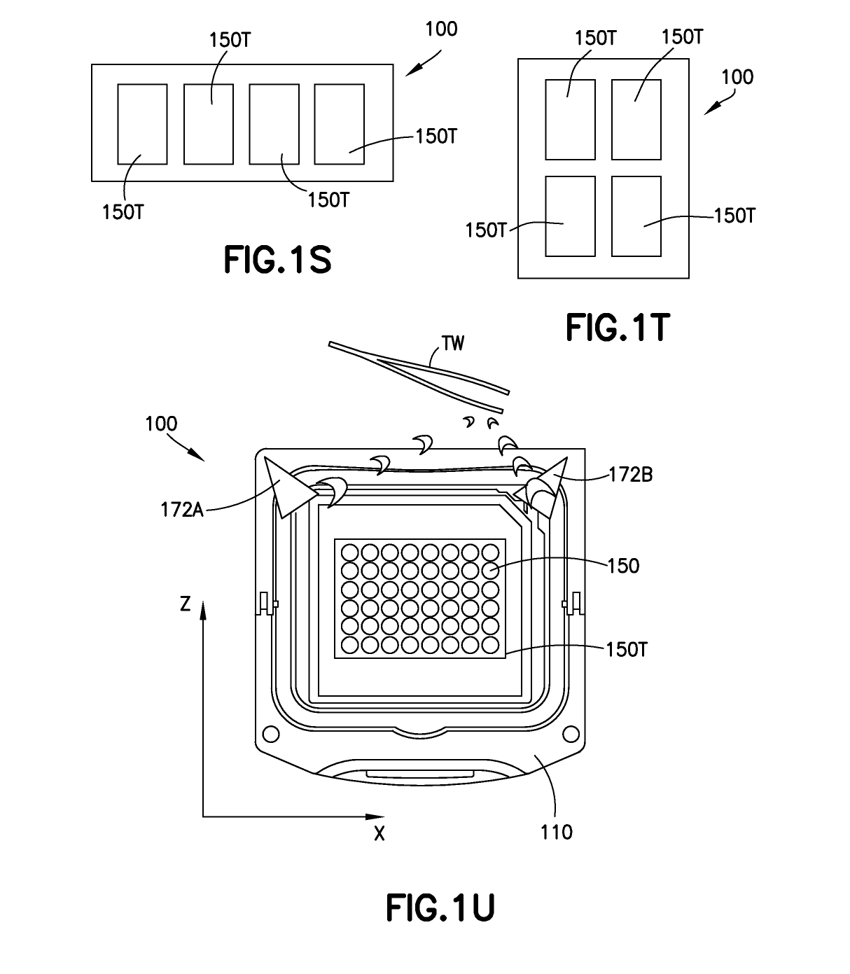

FIGS. 1A-1I illustrate a sample shipping container/carrier or portable cryogenic workstation 100, 100′, 100″, 100′″ (referred to generally herein as portable cryogenic workstations) and portions thereof in accordance with an aspect of the disclosed embodiment. Although the aspects of the disclosed embodiment will be described with reference to the drawings, it should be understood that the aspects of the disclosed embodiment can be embodied in many forms. In addition, any suitable size, shape or type of elements or materials could be used. It is also noted that the blocks illustrated in the flowcharts described herein may be executed in any suitable order. It is also noted that any one or more of the blocks illustrated in the flowcharts described herein may be omitted and may be considered optional.

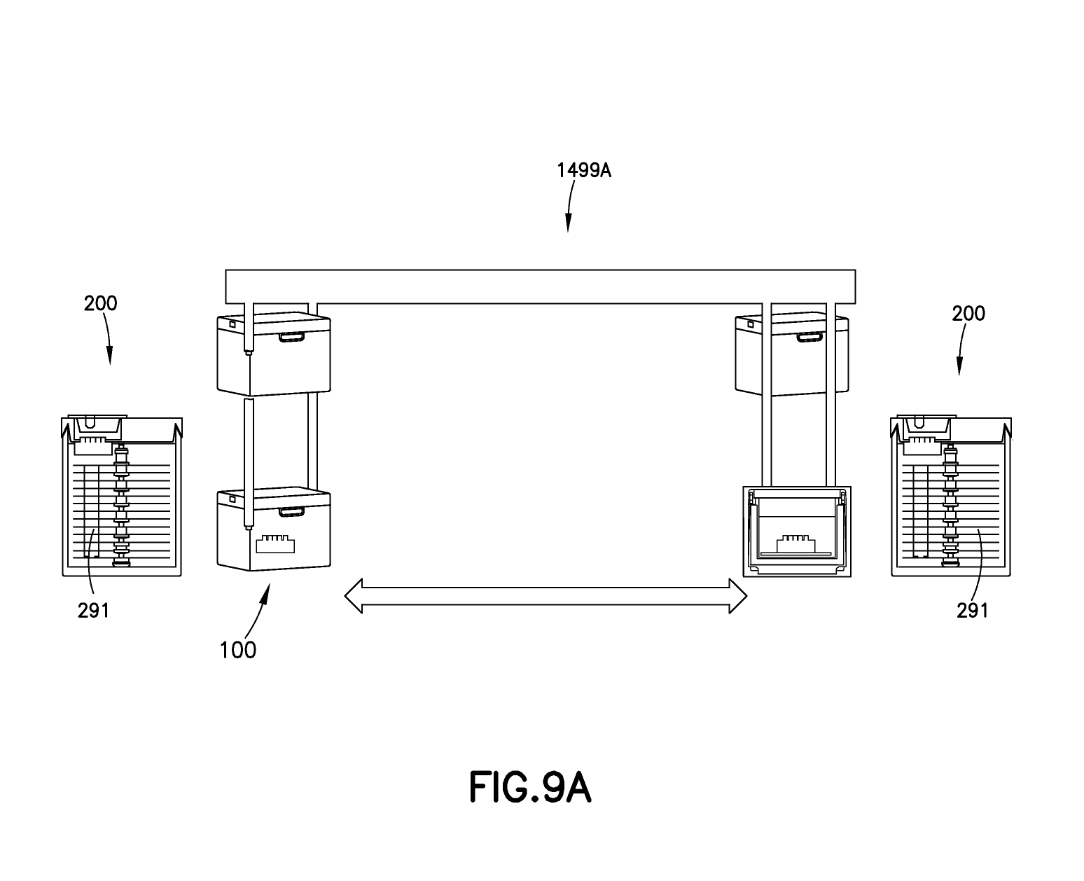

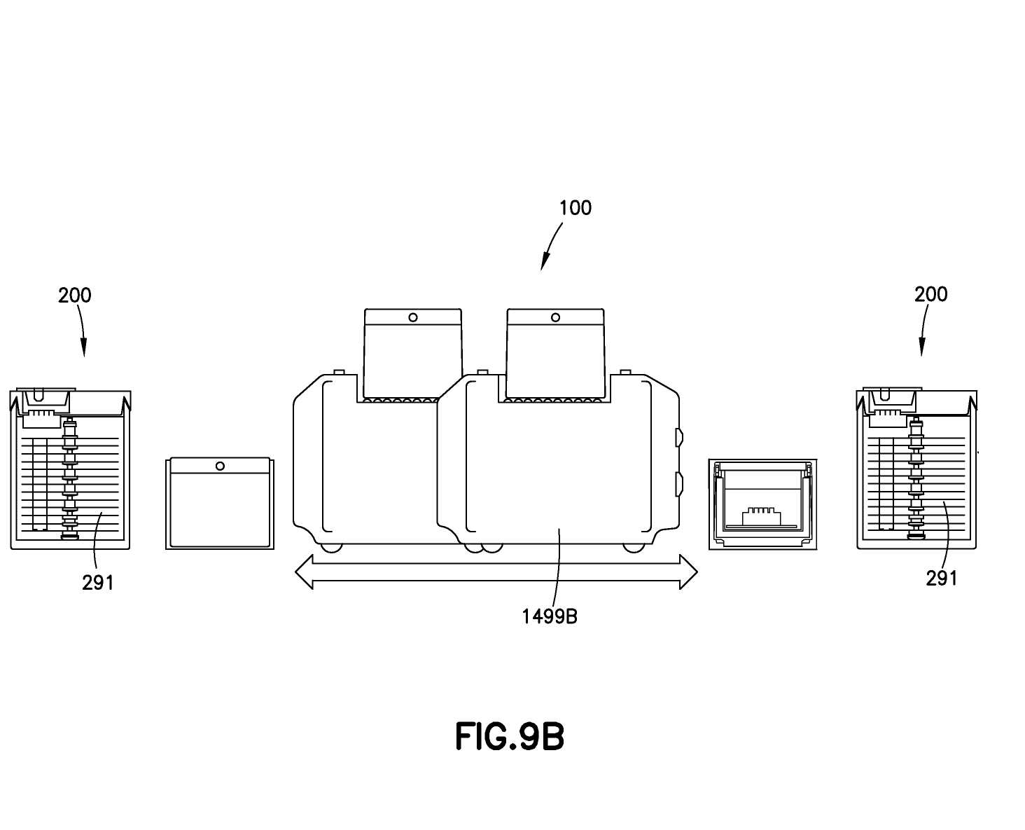

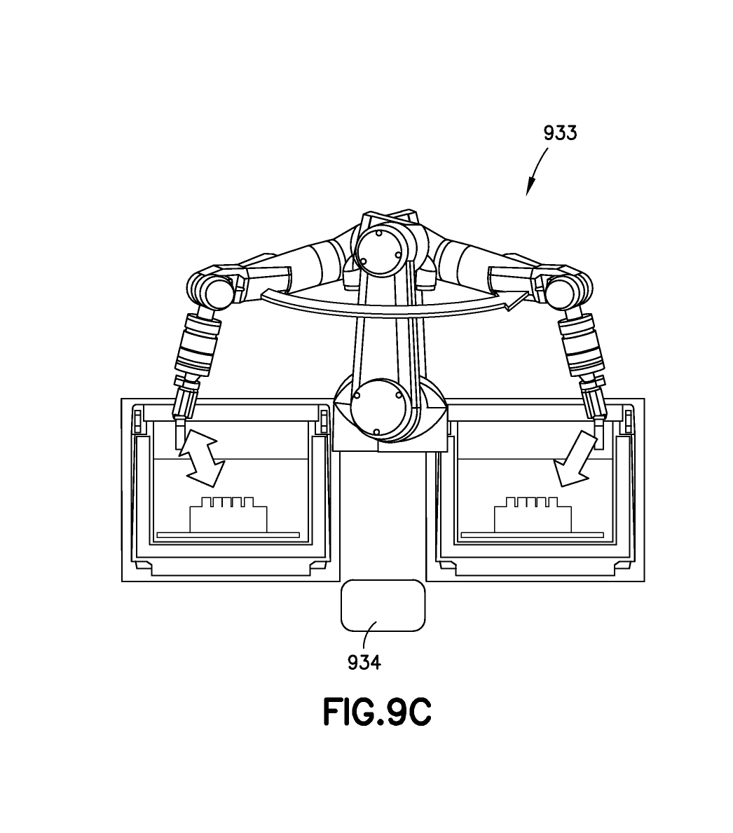

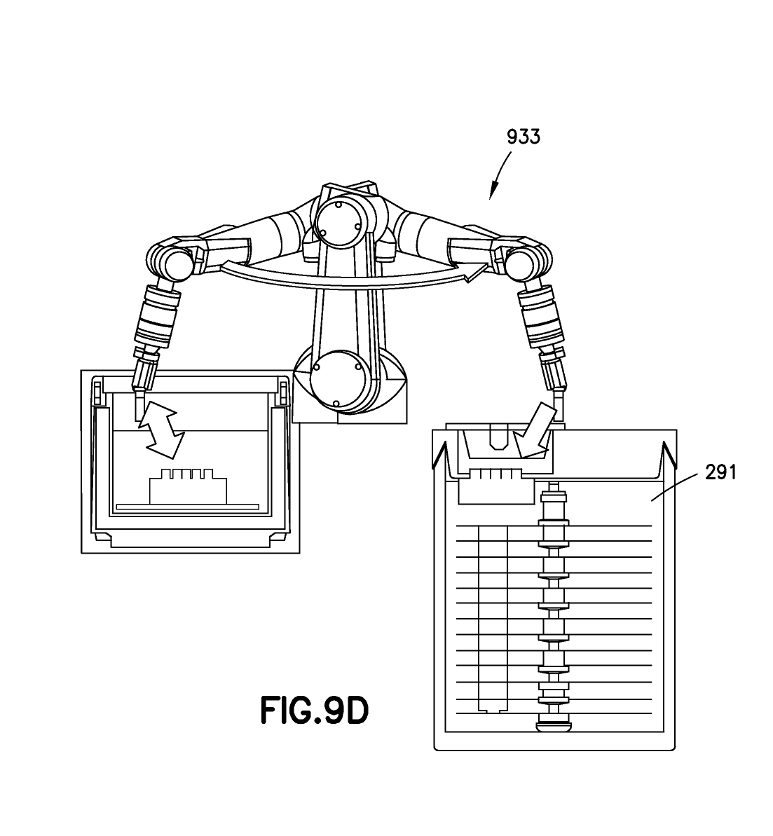

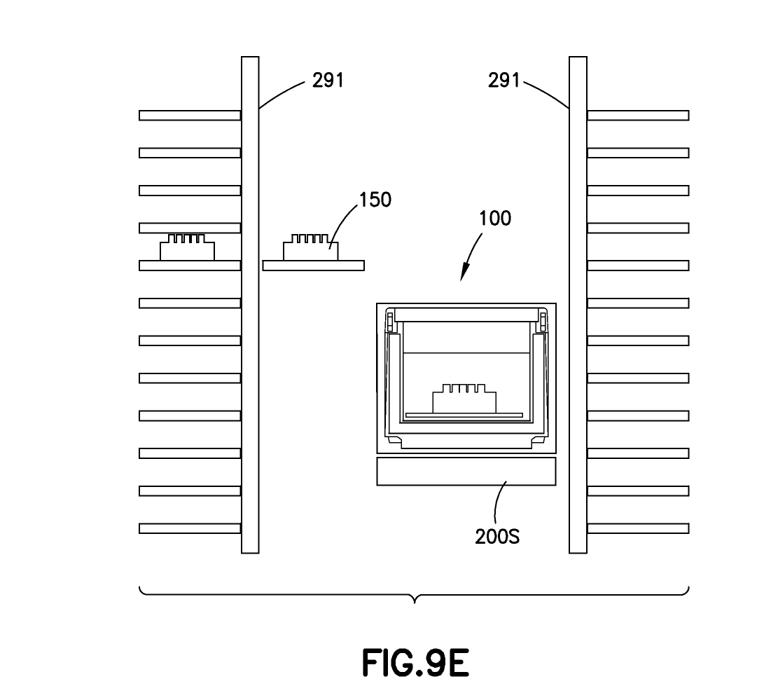

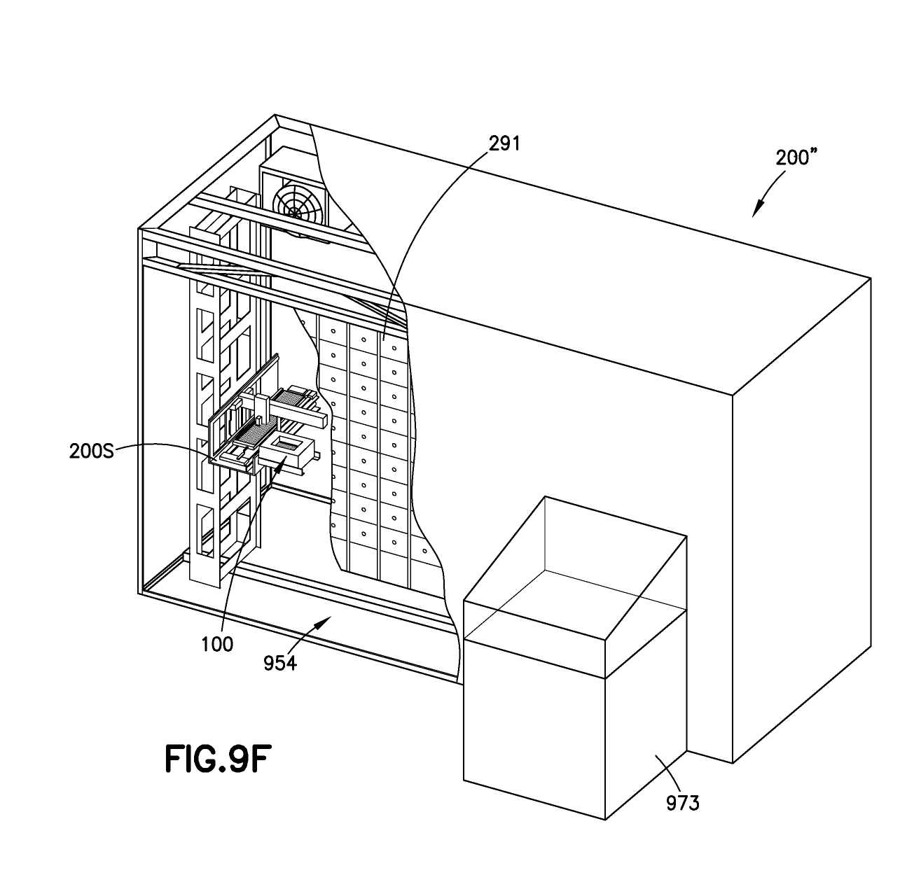

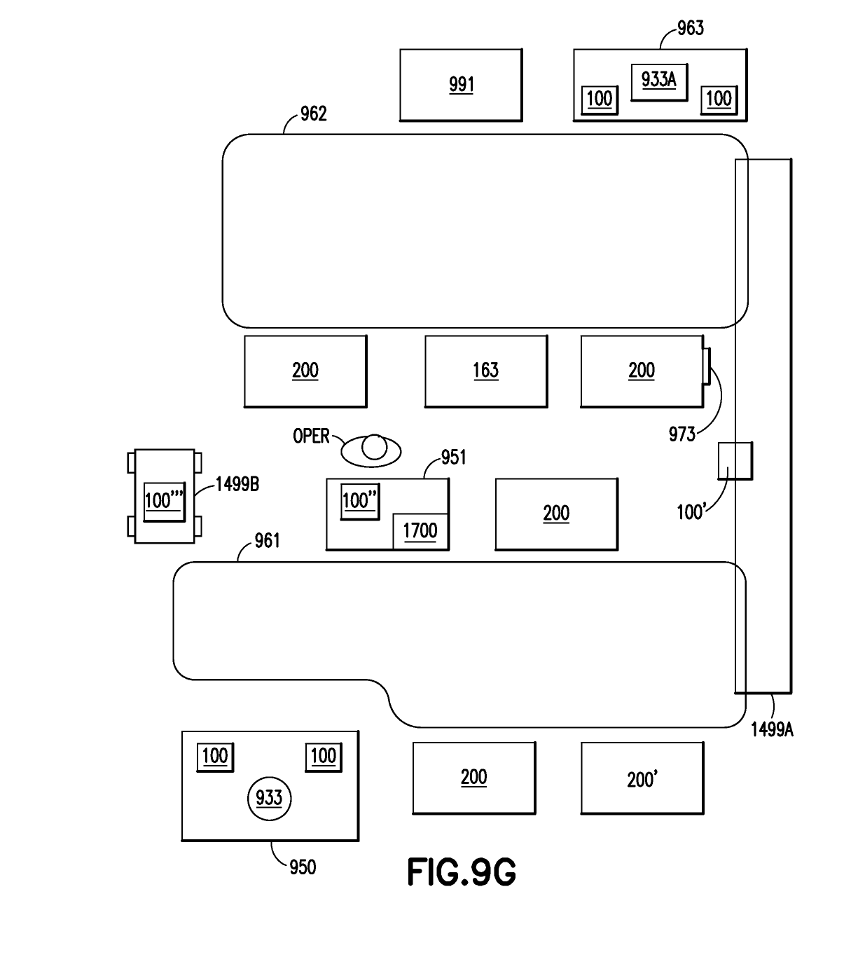

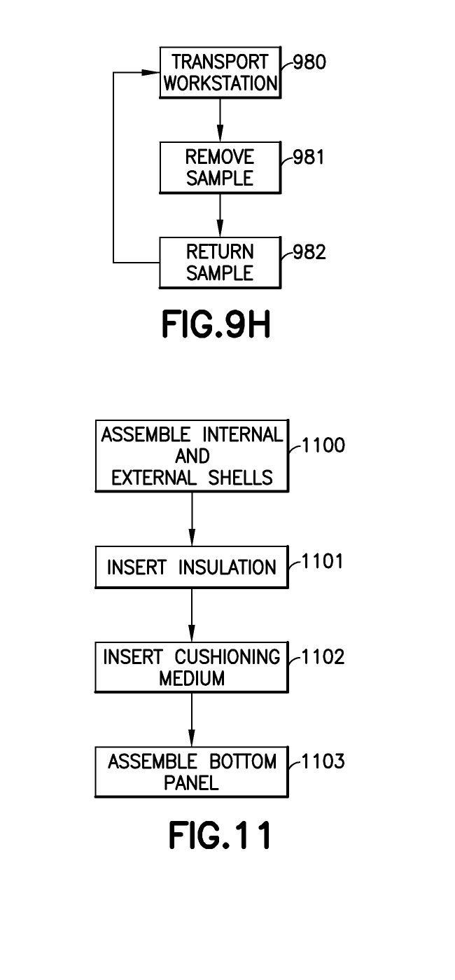

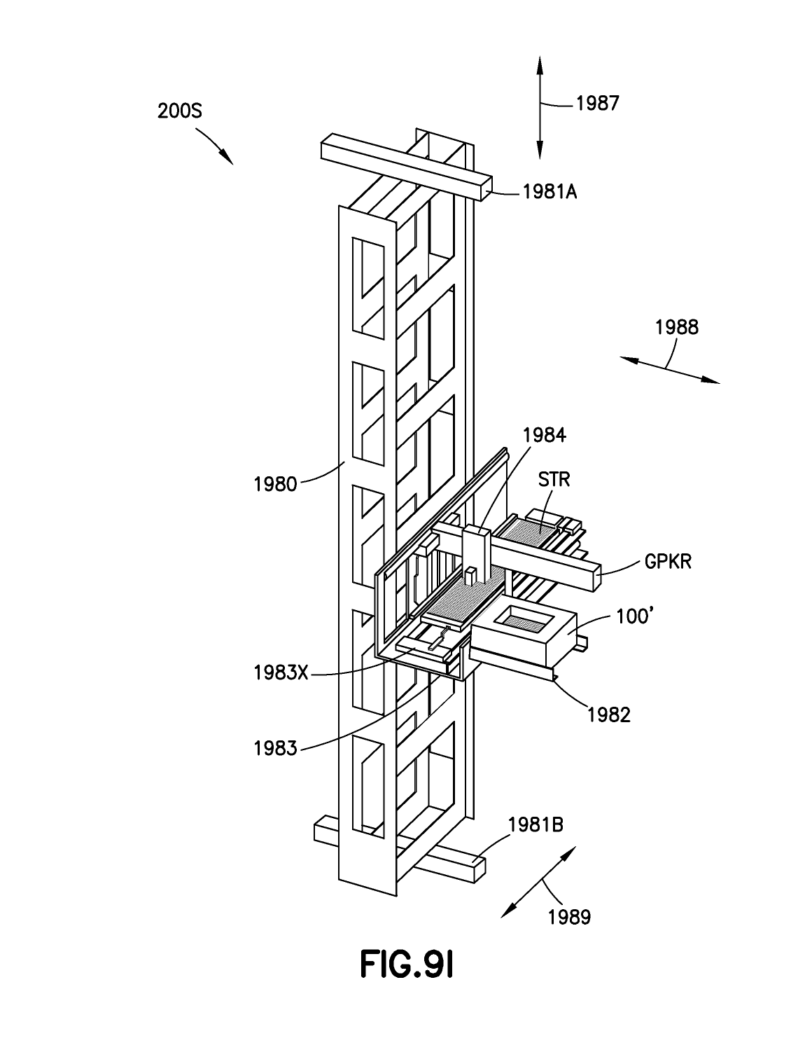

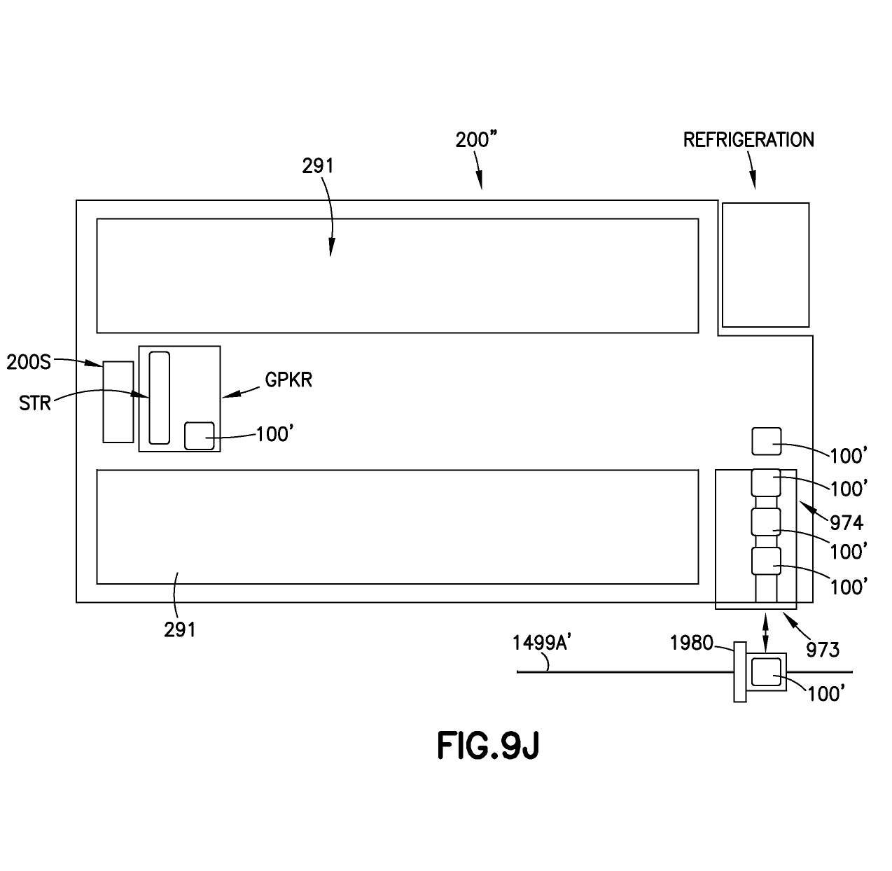

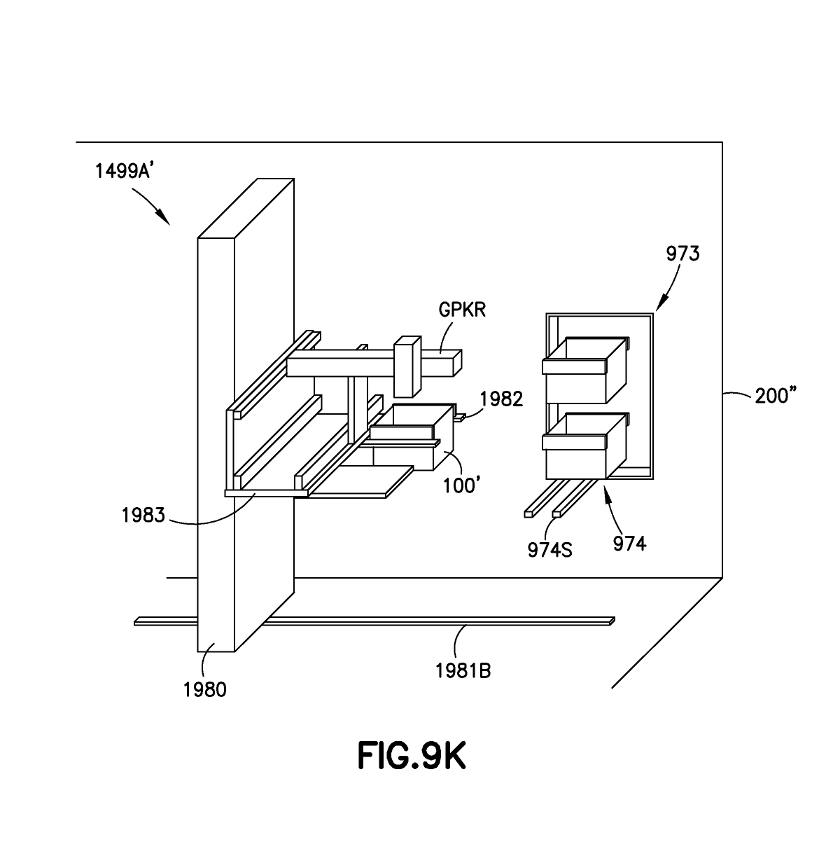

The portable cryogenic workstation 100, 100′, 100″, 100′″ may be used to transport any suitable samples such as biological and/or cryogenic samples and have any suitable shape and size to allow automated and/or manual transport of the portable cryogenic workstation 100, 100′, 100″, 100′″ as described herein. Referring to FIG. 9, as may be realized, the portable cryogenic workstations 100, 100′, 100″, 100′″ may be standalone workstations that allow cooling of the samples 150 during manual access of the samples 150 by operators at any suitable location, such as at a laboratory workbench. The portable cryogenic workstations 100, 100′, 100″, 100′″ may be transported to the sample storage system 200, 201′, 200″ for transferring the samples to and from the portable cryogenic workstation and/or replenishment of the refrigerant (which may be a phase change refrigerant or coolant such as, for example, a cryogenic liquid) within the portable cryogenic workstation as described herein. In other aspects, referring also to FIGS. 9, 9A, 9B, 9C, 9D, 9E and 9F, the portable cryogenic workstations allow biological or cryogenic samples to be shipped or otherwise transported within a laboratory, facility or building or transported between laboratories, facilities or buildings. For example, the portable cryogenic workstations 100, 100′, 100″, 100′″ may be transported between two stations (stations 200 are illustrated in FIGS. 9A and 9B for exemplary purposes only and are representative of the other storage and/or refrigerant replenishing stations described herein) with one or more of two types (e.g. external and internal) of transport systems. For example, the external transport system transports the portable cryogenic workstations 100, 100′, 100″, 100′″ between two stations externally to a housing of the two stations (e.g. where the housing is, for example, an external housing of a sample storage system 200, 200′, 200″, refrigerant replenishment stations 163, sorters 950, and/or sample selectors 991). The internal transport system transports the portable cryogenic workstations 100, 100′, 100″, 100′″ between two stations internally within a housing that may include multiple holding stations for the portable cryogenic workstations 100, 100′, 100″, 100′″ and/or samples transported therein (e.g. where the housing is, for example, a housing of a sample storage system 200, 200′, 200″, refrigerant replenishment stations 163, sorters 950, and/or sample selectors 991). Each of the two types of transport systems include an apparatus such as automated handling equipment (e.g. overhead gantries 1499A, shuttles 1499′, 200S, automated guided vehicles 1499B, etc.).

Referring to FIGS. 9F and 9J, as an example, the portable cryogenic workstations 100, 100′, 100″, 100′″ described herein may be transported within the sample storage system 200″ such that a transport shuttle 200S or any other suitable transport unit (such as gantry 1499A, shuttle 1499A′ (which is substantially similar to transport shuttle 200S) and/or automated guided vehicles 1499B) moves one or more portable cryogenic workstations 100, 100′, 100″, 100′″ from one location, such as one or more of an input/output port 973, a queuing station 974 (which in one aspect includes refrigerant replenishment), a storage location 291 or any other suitable portable cryogenic workstation holding location (which may be adjacent cold storage units or vaults 291) within the sample storage system 200″ to an area within the storage system that is adjacent one or more cold storage units or vaults 291 of the sample storage system 200″ (e.g. the transport shuttle 200S may transport the portable cryogenic workstation from one area of the sample storage system 200″ to another area of the sample storage system 200″ to collect or place samples). In one aspect, referring to FIGS. 9E and 9F, the sample storage system 200″ may be substantially similar to that described in U.S. Pat. No. 8,252,232 issued on Aug. 28, 2012 and U.S. patent application Ser. No. 13/334,619 filed on Dec. 22, 2011 having publication number 2012/0163945 (the disclosures of which are incorporated herein by reference in their entireties) such that the transport shuttle 200S and/or the area 954 in which the transport shuttle 200S operates can be maintained at a higher temperature than the one or more cold storage units 291 while the samples can be quickly transferred between the one or more cold storage units 291 and the portable cryogenic workstations 100, 100′, 100″, 100′″, maintaining the sample temperature without having to cool off the transport shuttle 200S area.

In one aspect the transport shuttle is substantially similar to that described in U.S. Pat. No. 8,252,232 issued on Aug. 28, 2012 and U.S. patent application Ser. No. 13/334,619 filed on Dec. 22, 2011 having publication number 2012/0163945. For example, referring to FIGS. 9I and 9K the shuttle 200S includes a frame 1980 and one or more tracks 1981A, 1981B along which the frame 1980 travels in the direction of arrow 1988. A conveyor unit 1983 is mounted to the frame 1980 so as to travel along the frame in the direction of arrow 1987. The conveyor unit 1983 includes an effector 1982 configured to engage the portable cryogenic workstations 100, 100′, 100″, 100′″ for picking and placing the portable cryogenic workstations 100, 100′, 100″, 100′″ at predetermined holding locations, such as those described herein. In one aspect the effector 1982 is configured to engage kinematic features of the portable cryogenic workstations 100, 100′, 100″, 100′″ so as to deterministically place the portable cryogenic workstations 100, 100′, 100″, 100′″ at a predetermined holding location, such as at a predetermined position of the conveyor unit 1983. A workpiece holder conveyor 1983X is located on the conveyor unit 1983 for transferring workpiece holders, such as trays STR, to and from the cold storage locations or vaults 291. A gantry picker GPKR having an effector 1984 (that is movable in the directions of arrows 1988, 1989) is disposed on the conveyor unit 1983 for transferring samples between the workpiece holders and the portable cryogenic workstations 100, 100′, 100″, 100′″ held on the conveyor unit 1983. As may be realized, the gantry picker GPKR, the effector 1982 and the workpiece holder conveyor 1983X are moveable as a unit with the conveyor unit 1983 in the direction of arrow 1987. In one aspect, the multiple degrees of freedom of the shuttle 200S allows the queuing station 974 to hold the portable cryogenic workstations 100, 100′, 100″, 100′″ in a two or three dimensional array where the portable cryogenic workstations 100, 100′, 100″, 100′″ are located side by side and/or one above the other.

As may be realized, the portable cryogenic workstations 100, 100′, 100″, 100′″ may allow transfer of samples in room temperature environments, cold environments (e.g. −80° C.), ultra-cold environments (e.g. −150° C. and lower) or any other environments having any suitable temperature. Referring also to FIGS. 9C and 9D the portable cryogenic workstations 100, 100′, 100″, 100′″ may also allow for transfer of samples 150 between two or more portable cryogenic workstations 100, 100′, 100″, 100′″ and/or one or more cold storage units 291 with any suitable automated transfer equipment (such as transfer robot arm 933). A cold buffer area 934 (which may be e.g. another portable cryogenic workstation, a cold plate, a dewar of refrigerant, a refrigerated compartment, etc.) may be provided to allow for, e.g. changing caps on the sample containers without warming of the samples 150 or any other suitable operation that may be performed during a sample 150 pick and place operation.

Referring to FIG. 9G, an exemplary facility is illustrated having one or more of overhead transport or shuttle systems (such as gantry/shuttle 1499A, 1499A′), automated guided vehicles 1499B and conveyors 961, 962 for transporting the portable cryogenic workstations 100, 100′, 100″, 100′″ between automated operating stations (such as automated sample storage system 200, 200′, refrigerant replenishment stations 163, sorters 950, sample selectors 991 where automation such as robot arm 933 transfers samples from one workstation to another as described herein) and manual operating stations 951 (such as a laboratory bench) that may include sample handling stations 1700 as described below. In one aspect the sample selectors 991 may be substantially similar to those described in U.S. patent application Ser. No. 14/229,077 entitled “SAMPLE SELECTOR” and filed on Mar. 28, 2014, the disclosure of which is incorporated by reference herein in its entirety. In one aspect a portable cryogenic workstation 100, 100′, 100″, 100′″ may be transported to a predetermined automated or manual operating station (FIG. 9H, Block 980). The transport of the portable cryogenic workstations may be through automated material handling system 1499A (e.g. overhead transport), 1499B (e.g. automated guided vehicle), 961 (conveyor), 962 (conveyor), shuttle 1499A′ or manually. As may be realized the automated material handling system may be configured to transfer or hand off portable cryogenic workstations to each other. For example, the overhead transport 1499A, shuttle 1499A′ and conveyors 961, 962 may be configured such that one or more of the overhead transport 1499A and shuttle 1499A′ picks and places portable cryogenic workstations from and to the conveyors 961, 962. In another aspect, the overhead transport 1499A, shuttle 1499A′ and automated guided vehicle 1499B may be configured such that one or more of the overhead transport 1499A and shuttle 1499A′ picks and places portable cryogenic workstations from and to the automated guided vehicle 1499B. In still another aspect, the automated guided vehicle 1499B and conveyors 961, 962 may be configured such that the automated guided vehicle picks and places portable cryogenic workstations from and to the conveyors 961, 962. In still other aspects the overhead transport 1499A and shuttle 1499A′ are configured such that portable cryogenic workstations are transferred between the overhead transport 1499A and shuttle 1499A′. As may be realized, the input/output port 973 of the sample storage system 200, 201′, 200″ (and input/output ports of the other cryogenic workstation holding locations, such as replenishment stations) are configured to allow transfer of the portable cryogenic workstation 100, 100′, 100″, 100′″ between the transport systems described herein and the sample storage system 200, 201′, 200″ (and other cryogenic workstation holding locations). For example, referring to FIGS. 9K and 9J the shuttle 1499A′ (which is substantially similar to shuttle 200S) places the portable cryogenic workstation 100, 100′, 100″, 100′″ on any suitable support 974S of the input/output port 974 such as by moving the conveyor unit in one or more of directions 1987, 1988, 1989. The support 974S is configured to transport the portable cryogenic workstation 100, 100′, 100″, 100′″ into the respective storage system so that the shuttle 200S picks the portable cryogenic workstation 100, 100′, 100″, 100′″ from the support 974S (such as in the queue 974) so that samples can be transferred between the portable cryogenic workstation 100, 100′, 100″, 100′″ and the cold storage or vaults 291.

Samples may be operated on in any suitable manner (such as placed into storage, analyzed, transferred to another portable cryogenic workstation, etc.) by removing one or more samples from the portable cryogenic workstation in a manner as described herein (FIG. 9H, Block 981). In one aspect any suitable automation may remove the sample trays from the 150T from the portable cryogenic workstations in a manner described herein for providing the samples to storage or to an operator OPER. In one aspect an operator may pick and place samples to and from the trays 150T while in other aspects, as described herein, any suitable automation may pick and place the samples to and from the trays 150T. The sample may be returned to the portable cryogenic workstation (FIG. 9H, Block 982) and the workstation may be transported to another operating station or to another portion of the same operating system through one or more of the transport systems 1499A, 1499B, 961, 962, 933, 933A or manually. Where the portable cryogenic workstation is transported to another portion of the same operating system 963 any suitable automation 933A, such as a robot arm or other suitable intra-station transport, conveyor, gantry, etc. may be disposed at least partly within the operating system 963 for transporting the portable cryogenic workstation.

Referring again to FIGS. 1A-1I the portable cryogenic workstation 100, 100′, 100″, 100′″ may be configured to maintain samples 150 (e.g. located in sample containers or on slides) near liquid nitrogen (LN2) temperatures (e.g. about −150° C. or less) and provide easy manual access to the samples, e.g. with a lid of the portable cryogenic workstation off, while maintaining samples (and an interior 110C of the portable cryogenic workstation 100, 100′, 100″, 100′″) at or below about −150° C. as will be described below. In some embodiments, portable cryogenic workstations 100, 100′, 100″, 100′″ maintain samples at temperatures between about −196° C. and about −30° C., between about −196° C. and about −120° C., between about −196° C. and about the glass transition temperature of water, or between about −196° C. and about −150° C.

As may be realized, the portable cryogenic workstation 100, 100′, 100″, 100′″ may be configured to mitigate the effects of moisture including condensation and/or ice that may build up within, on or around the portable cryogenic workstation 100, 100′, 100″, 100′″. For example, the portable cryogenic workstation 100, 100′, 100″, 100′″ may be constructed of any suitable material that allows the portable cryogenic workstation to be heated or otherwise warmed for drying out an internal cavity or exterior of the portable cryogenic workstation 100, 100′, 100″, 100′″. In one aspect heating elements may be provided within walls of the portable cryogenic workstation housing and/or lid such that the heating elements can be connected to a power source in any suitable manner for heating or otherwise warming the portable cryogenic workstation. In some instances, dry gas is used to purge moisture in the environment in and/or around the portable cryogenic workstation 100, 100′, 100″, 100′″. For example, when the portable cryogenic workstation 100, 100′, 100″, 100′″ is in, for example, an automated storage system, refrigerant replenishment station, or other partially or fully enclosed area, dry gas can be used to purge moisture in the environment in and/or around the portable cryogenic workstation. In some embodiments, a portion of the refrigerant (e.g., a cryogenic liquid such as liquid nitrogen) contained in the portable cryogenic workstation evaporates to provide a dry purge gas (e.g., dry nitrogen gas). In instances in which the evaporation of refrigerant from the portable cryogenic workstation is not sufficient to achieve a desired dew point in and/or around the workstation, additional dry gas can be provided by, for example, employing a heater and/or a cryogenic liquid to promote the evaporation of cryogenic liquid to form a dry purge gas.

The portable cryogenic workstation 100, 100′, 100″, 100′″can be especially prone to attracting moisture (and typically forming ice) when the workstation 100, 100′, 100″, 100′″ is charged with refrigerant. Therefore, in some aspects, refrigerant (e.g., cryogenic liquid) is added to a workstation while one or more workstations are at least partially or wholly within an enclosure as will be described in greater detail below. Within the enclosure, dry purge gas, as described above, can be used to achieve a desired dew point within the enclosure and thus prevent attracting undesired moisture to the workstation(s).

The portable cryogenic workstation 100, 100′, 100″, 100′″ may also be configured to interface with or to an automated cryogenic storage system as will also be described below. It is noted that while the portable cryogenic workstation 100, 100′, 100″, 100′″ is exemplified herein as a top loading portable cryogenic workstation having a substantially rectangular or square or cylindrical cavity in other aspects the portable cryogenic workstation 100, 100′, 100″, 100′″ may be configured as a top, side or bottom loading portable cryogenic workstation having any suitable shape and the storage system may include suitable side loading and/or bottom loading interfaces substantially similar to those described herein. In one aspect the portable cryogenic workstation may have a Dewar type flask 100″ configuration (FIG. 1I—see also FIGS. 1Q and 1R) including the features described herein such that the flask 100″ mates with the automated storage system in a manner substantially similar to that described herein. In other aspects where the Dewar type flask includes a threaded cap (not shown) for closing the flask the load port door described herein may be configured with a rotatable gripper for unscrewing the cap from the flask, however the flask may be mated with the load port and samples removed from the flask in a manner substantially similar to that described herein. In another aspect, as can be seen in FIGS. 1Q and 1R, the portable cryogenic workstation 100′″ may have a substantially cylindrical housing 110CH (e.g. forming a dewar container.) Portable cryogenic workstation 100′″ may also include the features described herein with respect to workstation 100 such that the portable cryogenic workstation 100′″ mates with the automated storage system in a manner substantially similar to that described herein with respect to workstation 100 where the lid 113 of the dewar container includes kinematic locating features 113A and a latch key engagement or other suitable coupling features that interface with a door of the a sample storage system and/or refrigerant charging/replenishment station described herein. As such the portable cryogenic workstation 100′″ includes deterministic locating features on one or more of the housing 110CH and lid 113 for effecting deterministic placement of and automated opening/closing of the portable cryogenic workstation 100′″. As may be realized, maintaining the interior 110C at suitable temperatures such as at or below −150° C. and the ability to interface the portable cryogenic workstation 100, 100′, 100″, 100′″ with automated storage systems, the automated storage system and the samples may be protected from temperature swings and water/frost ingress. In one aspect, as can be seen in FIGS. 1S and 1T, the portable cryogenic workstations (workstation 100 is illustrated for exemplary purposes only) may be configured to hold one or more sample trays (tray 150T is illustrated for exemplary purposes only). For example, the portable cryogenic workstation may hold a single tray 150T or an N×N array of trays 150T (for exemplary purposes only a 1×4 array of trays is illustrated in FIG. 1S while a 2×2 array of trays is illustrated in FIG. 1T). While the trays 150T are illustrated as being arranged in a single plane (e.g. side by side) in other aspects the trays may be located in different planes (e.g. one above the other) in addition to or in lieu of being located side by side.

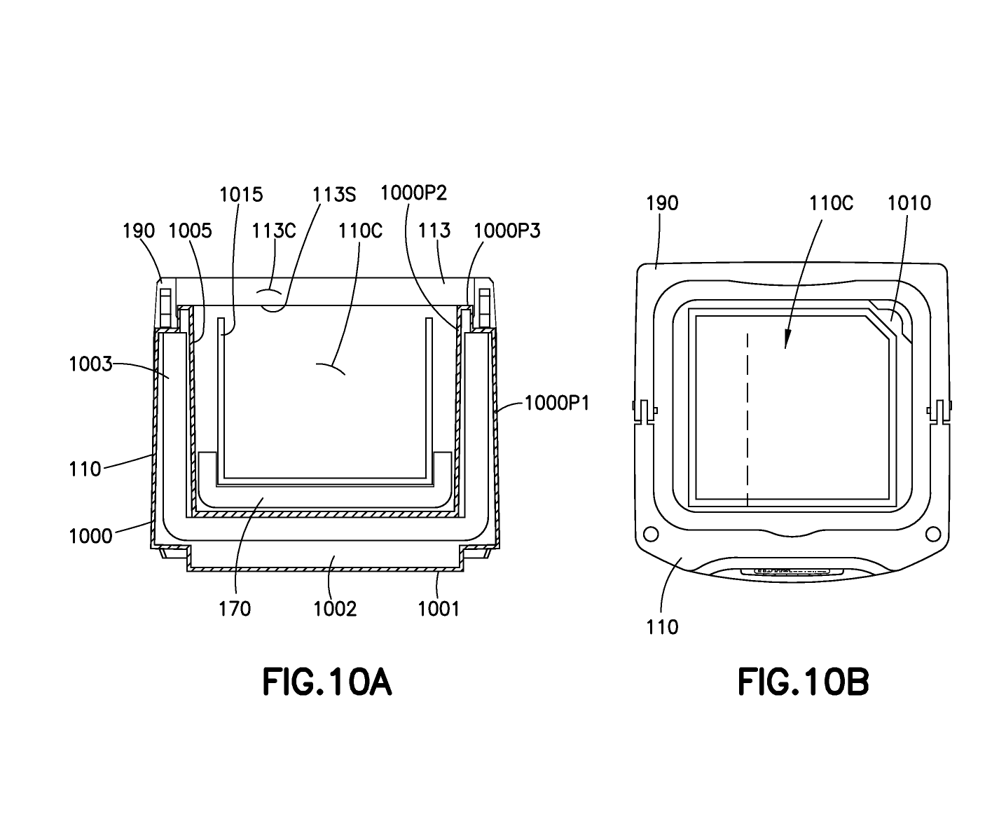

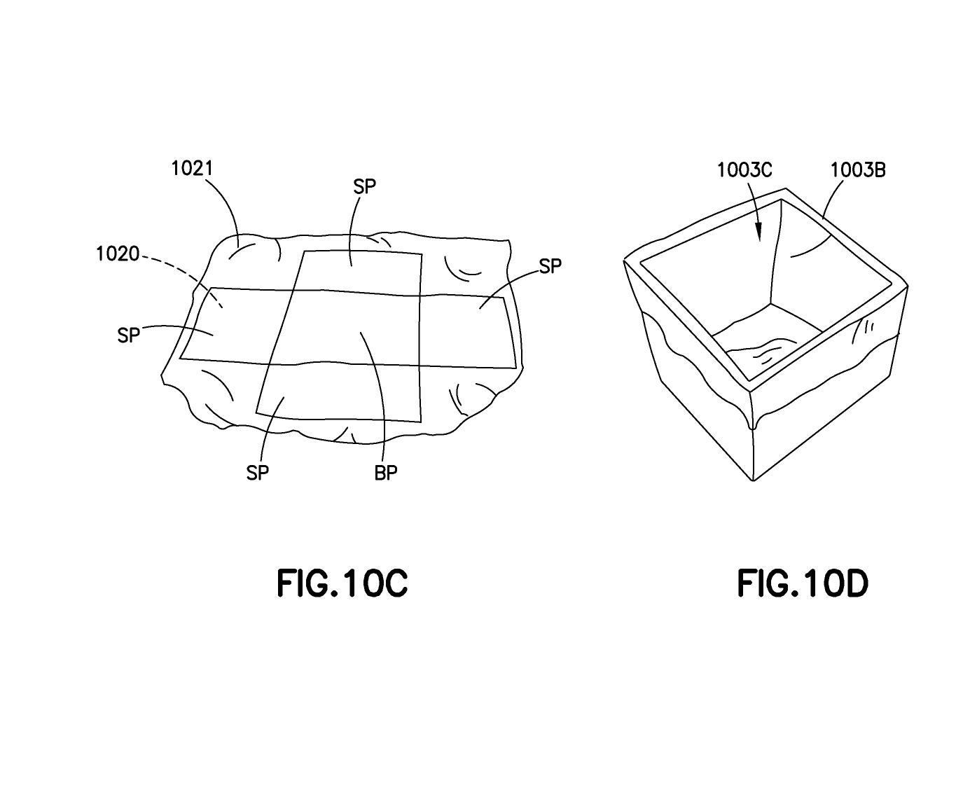

The portable cryogenic workstation 100, 100′, 100″, 100′″ may provide protection for samples 150 that are getting unloaded or loaded into storage and also provide an ability to manually manipulate samples on a bench top, while maintaining the samples at or near cryogenic temperatures while the operator is in a normal laboratory environment. In one aspect the portable cryogenic workstation 100, 100′, 100″, 100′″ provides manual (or automated) access to the samples 150, any tray or rack 150T in which the samples 150 are held and/or any suitable holder TH in which one or more trays 150T, 150T′, 150T″/samples 150 are held. In one aspect the tray or rack 150T may be any suitable well plate for holding samples. In one aspect the tray or rack 150T′ may be constructed of a thermally conductive material configured to maintain the samples at a predetermined temperature when the tray or rack 150T′ is placed in substantial contact with a refrigerant source (such as an absorbent pad 170, refrigerant unit 170′) described below) which may be referred to herein as a refrigerant or consumable media accumulator that uses a replenishable or replaceable refrigerant/coolant (also referred to herein as a consumable media). In one aspect, referring also to FIG. 1N the tray 150T′ may include a cold battery CB that operates through conductive material rather than air temperature around the samples. The cold battery CB (illustrated on a side of the samples 150 for exemplary purposes) may lose heat to the consumable media source and act as a cold heat sink for cooling the samples 150. As may be realized the sample holding areas may be disposed within the cold battery CB as illustrated in FIG. 1B. In other aspects the tray or rack 150T″ may include an interface 150TI between the tray or rack 150TP and the refrigerant or consumable media source that is configured to provide a uniform temperature distribution to the samples 150 in the tray or rack 150TP coupled to the interface 15011. In one aspect, referring also to FIG. 1O, the tray 150, 150′, 150″ (tray 150T′ is illustrated in FIG. 1O for exemplary purposes) may be separated from the consumable media source by a thin layer of insulation (e.g. such as inner shell 1005 of the housing 110 as described below—see e.g. FIG. 10A). The tray 150 150′, 150″ may abut the thin layer of insulation to allow heat transfer from the samples 150 to the consumable media source for cooling the samples 150. In yet other aspects, as can be seen in FIG. 1P, the tray 150, 150′, 150″ may be or otherwise include a substantially solid insert into which the samples 150 are placed. FIG. 1P illustrates, e.g., the tray 150T′ as having a substantially solid configuration where the tray is inserted into the portable cryogenic workstation 100, 100′, 100″, 100′″ (workstation 100 is illustrated for exemplary purposes). In one aspect the holder TH′ may be a box having a housing THH with a cavity for holding samples 150 within a cavity and a lid THL for closing the cavity. In one aspect the tray TH may be configured to hold the holder TH′. The cavity of the holder TH′ may include any suitable consumable media accumulator such as refrigerant unit 170′ configured to maintain the cavity and samples 150 therein at a predetermined temperature for a predetermined period of time. The samples 150 within the housing THH may be held in any suitable tray or rack 150′. In one aspect the tray or rack 150′ may be substantially similar to tray or rack 150T, 150T′, 150T″. The manual (or automated) access may provide for the addition and removal of the tray 150T, 150T′, 150T″ and/or holder TH to and from the portable cryogenic workstation 100, 100′, 100″, 100′″ and/or for addition and removal of individual samples 150 to and from the portable cryogenic workstation 100, 100′, 100″, 100′″. This manual access may be provided by a lid 113 that is easily manually removable. In one aspect the housing 110 may include a hinge 113H where the lid 113 pivots about the hinge 113H between a closed position (shown in FIG. 1K) and an open position (shown in FIG. 1J) where when in the closed position the lid seals the cavity 110C and when in the open position the lid 113 rests substantially against a side of the housing 110. In some embodiments, the portable cryogenic workstation 100, 100′, 100″, 100′″ includes mechanically or electronically controlled features to maintain the security of the lid 113. For example, the workstation lid may be secured with a mechanical lock and key. In other instances, the workstation lid is released only upon receipt of an electronic key code such as one entered by a user via an interface on the workstation or transmitted to the workstation (e.g., wirelessly.) In some embodiments, unauthorized opening of the workstation lid triggers an alarm to be made, a notification to be sent, and/or a data logging event to occur.

The portable cryogenic workstation 100, 100′, 100″, 100′″ may be sized and shaped and have any suitable weight such that an operator can easily lift and transport the portable cryogenic workstation 100, 100′, 100″, 100′″. For example, in one aspect the portable cryogenic workstation (including the samples and the cryogenic refrigerant/consumable media) may have a weight of about 10 pounds or less. In other aspects the portable cryogenic workstation may have any suitable weight. The housing 110, 110′, 110″, 110CH may also include any suitable handling features 111, 190 or any other suitable features that allow a human or automated gripper to hold and transport the housing 110, 110′, 110″, 110CH. In one aspect a foldable handle 190 may also provide for manual (one handed) transportation of the portable cryogenic workstation 100. The foldable handle 190 may be similar to that found on a beverage cooler that rotates substantially 90° between a deployed position and a folded position (e.g. so the handle rests against a side of the portable cryogenic workstation). In other aspects multiple handles 111 located on sides of the portable cryogenic workstation 100, 100′, 100″, 100′″ may provide for manual (two handed) transportation of the portable cryogenic workstation 100. In either case, the handles 190, 111 may be arranged to allow an operator to hold the workstation with one hand and remove the lid 113 of the workstation 100, 100′, 100″, 100′″ with the other hand. The portable cryogenic workstation 100, 100′, 100″, 100′″ may also have any suitable height H to accommodate sample containers or slides having any suitable height.

In accordance with the aspects of the disclosed embodiment the portable cryogenic workstation 100, 100′, 100″, 100′″ may provide a substantially constant cryogenic environment for the samples from the laboratory bench top to storage and back again to the laboratory bench top. The portable cryogenic workstation 100, 100′, 100″, 100′″ may also provide temperature logging, sample tracking through the laboratory, sample tracking during transportation outside of the laboratory, sample security via restriction of physical access to the samples, and linking of the pre-storage operations and history (e.g., time, temperature, nature of operations, etc.) with storage and/or post-storage operations and history, which may aid in sample processing compliance throughout the sample lifetime.

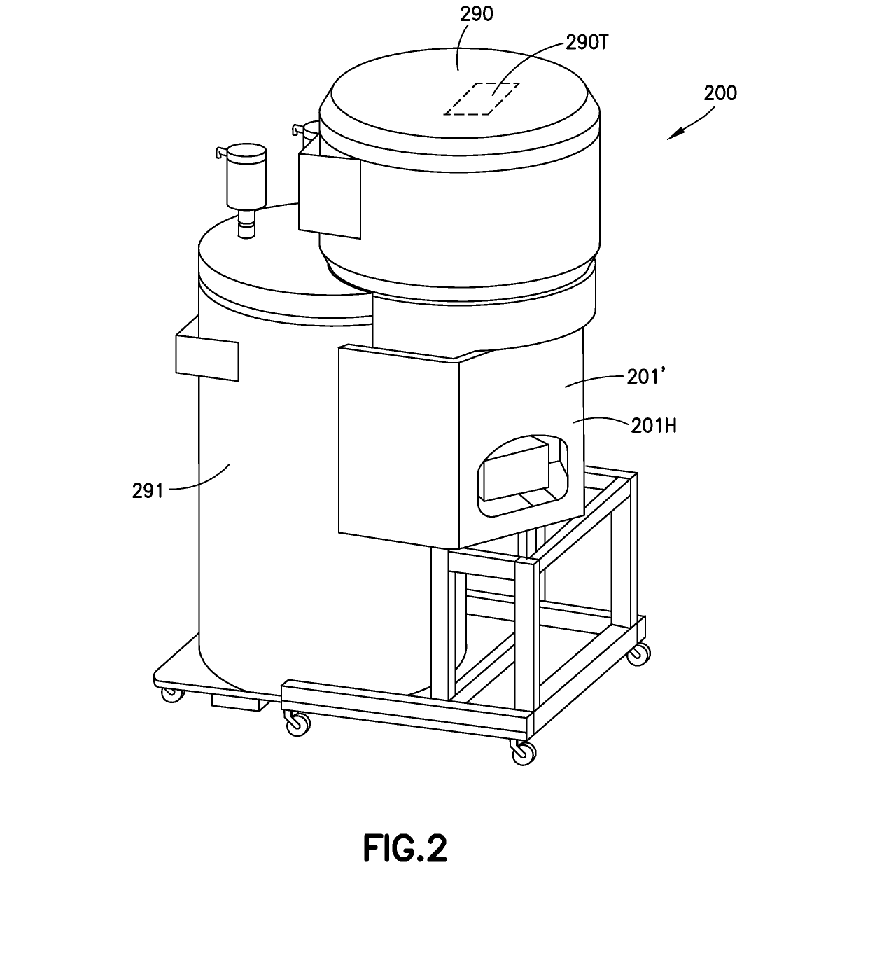

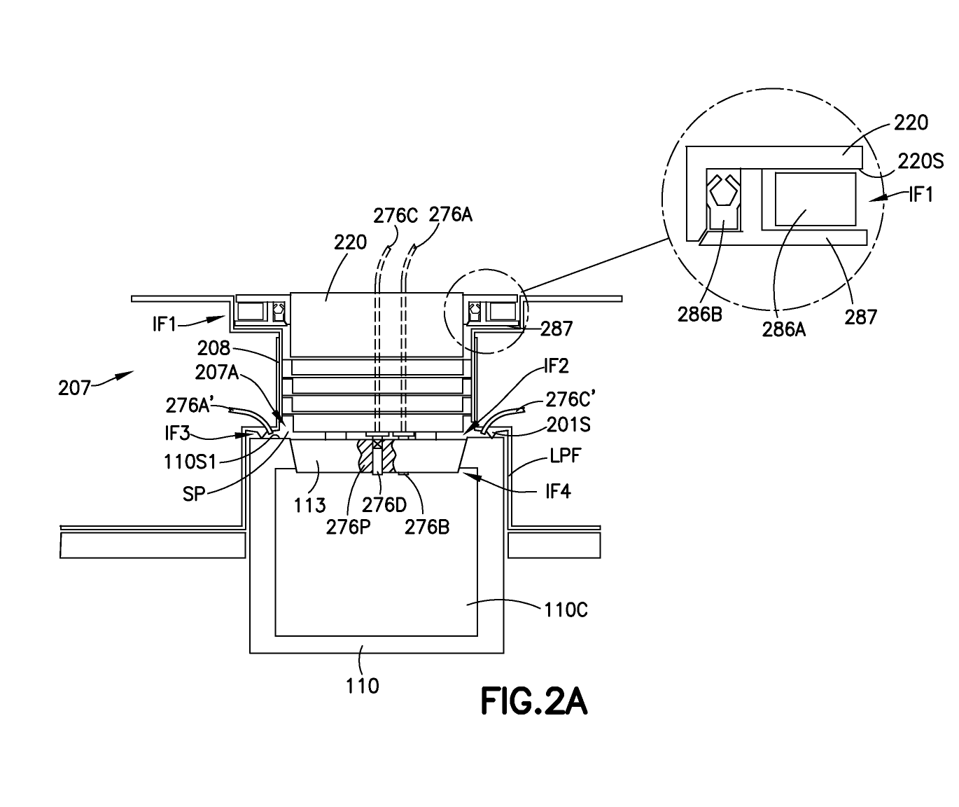

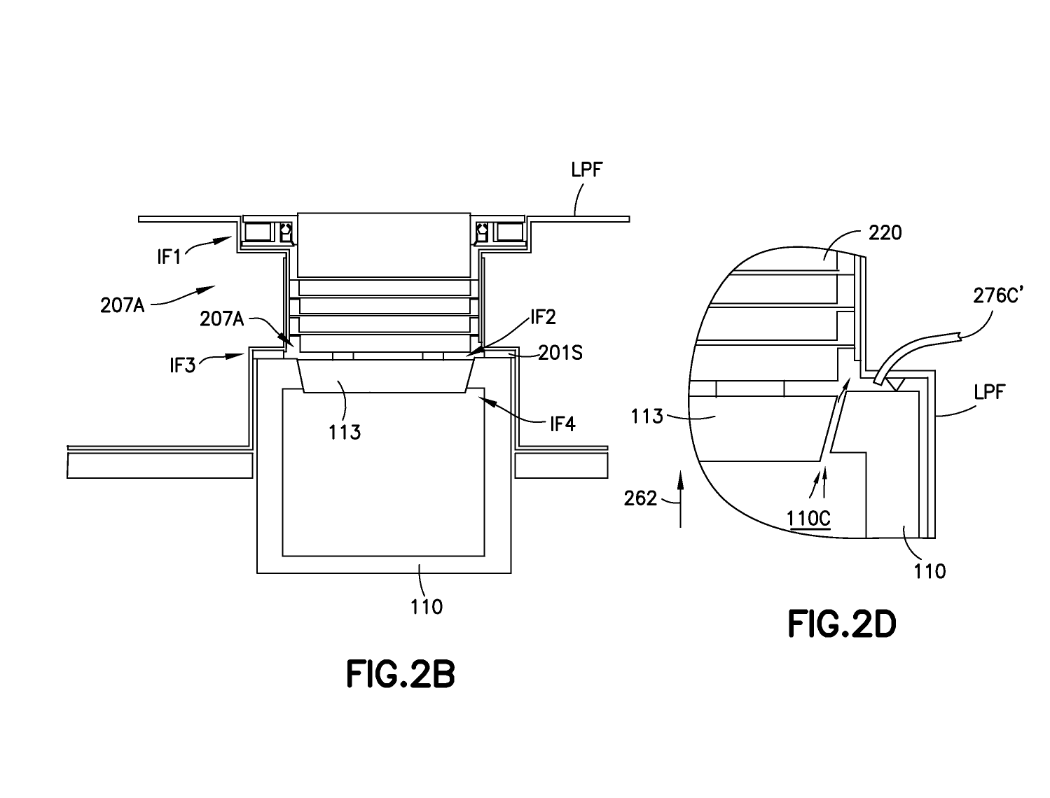

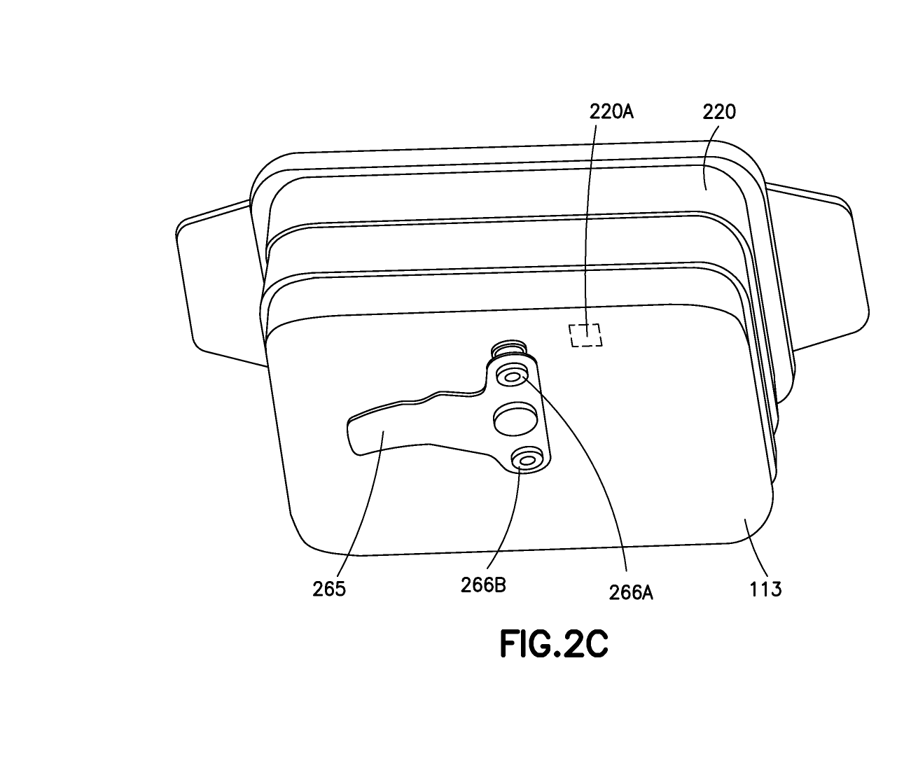

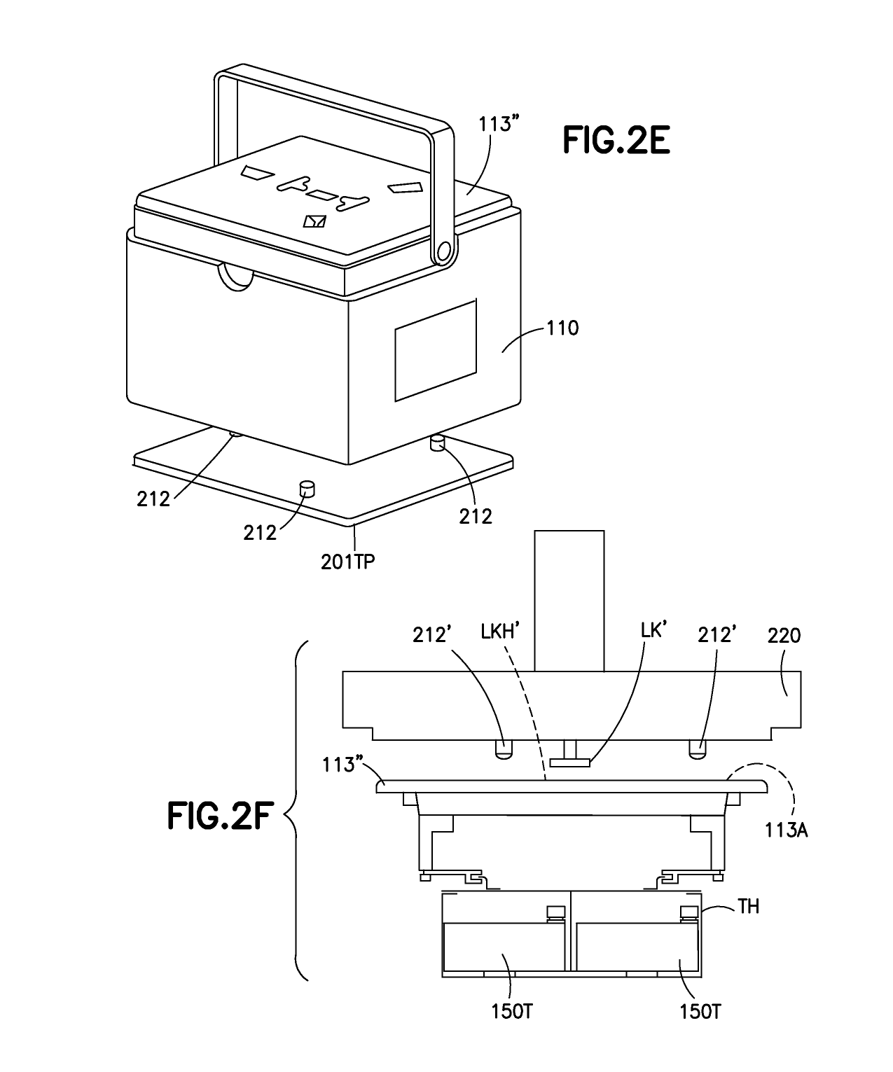

In accordance with an aspect of the disclosed embodiment the portable cryogenic workstation may include a frame forming a housing 110, 110′, 110″, 110CH. The housing 110, 110′, 110″, 110CH may be insulated and include a cavity or interior 110C in which a cartridge 120 (see FIG. 1H, that e.g. holds stacks of samples 150 in sample trays 150T in spaced apart shelves or holding areas 121) may be inserted. In other aspects the housing 110, 110′, 110″, 110CH may include a single holding area 121 configured to hold a single sample tray 150T. In still other aspects the trays 150T may be disposed in any suitable removable holder TH configured to allow an automated transport of the trays 150T from and to the cavity 110C. The cavity may be shaped and sized to allow operator access, such as with a gloved hand, to the samples located within the cavity. The housing 110, 110′, 110″, 110CH may include a sealing surface 11051 disposed around a periphery of the cavity 110C. The sealing surface 11051 may be configured to interface with or otherwise engage a corresponding sealing surface (see 201S e.g. FIG. 2A) of an automated storage system (as will be described below) creating or otherwise effecting a seal between the housing 110, 110′, 110″, 110CH and an opening or load port 207 of the automated storage system to, for example, minimize water ingress and heat load transfer into the storage system.

The cavity 110C may be sealed by a lid 113, 113′. The housing 110, 110′, 110″, 110CH and/or lid 113, 113′ may be insulated in any suitable manner (such as with vacuum insulation configured as a vacuum insulation panel or any other suitable insulation configuration) to maintain, for example, one or more samples 150 disposed within the cavity at a predetermined temperature, such as at e.g. −150° C. or below, for a predetermined period of time, such as about 2 hours (or any time period more or less than about 2 hours), during transport of the one or more samples 150. In one aspect the insulation may be sandwiched between an inner metal skin (e.g. disposed along the portions of the housing 110, 110′, 110″, 110CH and lid 113, 113′ that form the cavity 110C) and an outer plastic skin that forms an exterior surface of the housing 110, 110′, 110″, 110CH and lid 113, 113′. In other aspects the insulation of the portable cryogenic workstation may be effected in any suitable manner.

The lid may have any suitable shape and size so as to, for example, substantially seal the cavity 110C. The interface between the lid 113, 113′ and the housing 110, 110′, 110″, 110CH may be configured to allow for easy removal of the lid from the housing through a single axis movement of the lid relative to the housing. In one aspect the lid may be removed with no more than a single axis movement. The interface between the lid 113, 113′ and the housing 110, 110′, 110″, 110CH may be a tapered interface that allows purging of the cavity 110C (as will be described below) substantially while maintaining a controlled environment within the cavity 110C. For example, the lid 113, 113′ may have a tapered side surface 113S that interfaces (e.g. to form interface IF4 described below) with a corresponding tapered surface 110S2 disposed around a periphery of the cavity 110C. As may be realized, the two surfaces 113S, 110S2 may form a seal for substantially sealing the interior of the cavity 110C from an environment outside the housing 110, 110′, 110″, 110CH. In other aspects, the surfaces 113S, 110S2 may have any suitable shape and/or configuration for sealing the interior of the cavity 110C from an environment outside housing 110, 110′, 110″, 110CH. As may also be realized, any suitable vents or other apertures, channels and/or passage ways may be provided in the lid 113, 113′ and/or housing 110, 110′, 110″, 110CH to allow any gases created from boil off of, for example, the cryogenic refrigerant/consumable media (e.g. such as LN2) to escape from the cavity. In other aspects the surfaces 113S, 110S2 may allow gas created from the cryogenic refrigerant to vent past the lid 113, 113′. It is noted that the lid 113, 113′ may be held or otherwise coupled to the housing 110, 110′, 110″, 110CH in any suitable manner such as by, for example, releasable passive or actuable mechanical and/or magnetic couplings that may be effected by the single axis movement of the lid 113, 113′ (e.g. in the direction of arrow 198) mating the lid 113, 113′ to the housing 110, 110′, 110″, 110CH. In other aspects the foldable handle 190 may have any suitable mechanical, magnetic and/or electrical locking features/actuators such that when the foldable handle 190 is in the deployed position the locking features mate with corresponding locking features of the lid 113, 113′ for locking the lid onto the housing 110, 110′, 110″, 110CH. The lid 113, 113′ may also include any suitable handle or grasping feature 114 that allows operator and/or automated removal of the lid. In one aspect the lid and handle may be configured such that an operator may remove the lid without wearing gloves. The lid may include alignment and locating features for interfacing the lid with automated lid removal elements/features of the automated storage system. For example, the lid 113, 113′ may include any suitable number of locating/alignment features 113A (e.g. pins, recesses, magnetic, etc.) that mate with corresponding alignment features 220A of a load port door 220 (see e.g. FIG. 2C) for aligning the lid 113, 113′ with the load port door 220. The lid may also include any suitable locating/alignment features 113AP (see FIGS. 1G and 1L) that mate with corresponding alignment features of the automated storage system for parking or otherwise storing the lid within the automated storage system during transfer of samples to and from the portable cryogenic workstation 100, 100′, 100″, 100′″. In other aspects the lid 113, 113′ may be removed from the housing 110, 110′, 110″, 110CH prior to interfacing the housing 110, 110′, 110″, 110CH with the automated storage system. In still other aspects the lid 113, 113′ may be removed from the housing 110, 110′, 110″, 110CH after the housing 110, 110′, 110″, 110CH is interfaced with the automated storage system but before the housing 110, 110′, 110″, 110CH is sealed (in a manner similar to that described below) to the automated storage system.

As noted above, a cartridge 120 or holder TH may be disposed within the cavity 110C. The cartridge 120 or holder TH may include one or more spaced apart shelves or holding areas 121 configured to hold the samples 150 in, for example, any suitable spatial arrangement. In one aspect the samples 150 may be held within a tray 150T where each of the shelves 121 is configured to securely hold one or more trays 150T in any suitable manner. As shown in FIG. 1H, each of the shelves 121 may hold one tray 150T while in other aspects each shelf may hold one or more trays in a side by side and/or front to back arrangement. The cartridge 120 (and/or the holder TH described above) may include any suitable guide features 122 that interface with corresponding guide features within the cavity of the housing 110, 110′, 110″, 110CH. The guide features 122 may be for example, corresponding protrusions and recesses, guide rails and slots, pins and recesses, or any other suitable locating features. The guide feature 122 may be configured so that the cartridge 120 may be placed in the cavity in, for example, a predetermined orientation relative to the housing 110, 110′, 110″, 110CH. The cartridge 120 (and/or holder TH) may be coupled to the lid 113, 113′ in any suitable manner or otherwise formed as a unitary member with the lid 113, 113′ so that as the lid 113, 113′ is removed from the housing 110, 110′, 110″, 110CH the cartridge 120 is removed with the lid 113, 113′ for automated or manual handling of the samples. In other aspects, the cartridge 120 may be detachable from the lid 113, 113′ by, for example, an actuation of any suitable mechanism (e.g. a latch key having a key and key hole, slidable pins, magnetic latches, etc.) on the outside of the lid 113, 113′ so that the cartridge 120 may be attached to the lid 113, 113′ for automated handling or detached from the lid 113, 113′ for manual handling of the samples 150. In still other aspects, the cartridge 120 (and/or holder TH) may include grasping features that allow an automated gripper of the sample storage system to remove the cartridge or holder from the cavity 110C.

The cavity may also include a cryogenic refrigerant space in which the refrigerant (e.g. consumable media) is held within the cavity 110C for cooling the interior of the cavity and the samples therein. The cryogenic refrigerant space may be positioned within the cavity 110C at suitable location relative to the samples 150. In one aspect the cryogenic refrigerant space 170S may be located beneath the samples but in other aspects may be located at any suitable location. In one aspect the consumable media accumulator such as an absorbent pad or member 170 (FIGS. 1D and 1E) may be placed within the cryogenic refrigerant space. The absorbent pad 170 may be configured to retain or otherwise absorb LN2 (or any other suitable cryogenic refrigerant/consumable media) to prevent the LN2 from sloshing around within the cavity and form a “dry liquid nitrogen” cooling unit. In some instances, consumable media accumulator, such as absorbent pad 170, may attract moisture, for example, when the lid of the workstation is removed or before the consumable media accumulator is placed in the cavity. Such moisture may deposit on exterior and/or interior surfaces (e.g., within pores) of the consumable media accumulator. Moisture attracted to the consumable media accumulator may subsequently freeze when charged with refrigerant and thus expand as ice is formed. Therefore, in some embodiments, the consumable media accumulator is formed of a resilient material that can deform without fracturing as ice forms and melts on and/or within it. In some aspects, the consumable media accumulator is an absorbent pad made of a porous, resilient polymer material such as resilient polymer foam. In other aspects the cryogenic refrigerant space and/or consumable media accumulator may include any suitable baffles and/or retaining members to prevent the refrigerant (e.g., LN2) from sloshing around within the cavity. In still other aspects the cryogenic refrigerant space and/or consumable media accumulator may be a substantially sealed chamber with vents to allow gases created from refrigerant (e.g., LN2) boil off to escape into the cavity 110C. The sealed chamber may be formed from any suitable material that allows heat transfer between the sealed chamber and the cavity 110C for cooling the interior of the cavity and the samples therein. In still other aspects the cryogenic refrigerant space may form the consumable media accumulator. As may be realized, the portable cryogenic workstation 100, 100′, 100″, 100′″ may be configured to allow manual or automated replenishment of refrigerant (e.g., LN2). For example, the cryogenic refrigerant space and pad 170 may be disposed within the cavity to allow an operator or automated refill station (of an automated storage system or refrigerant replenishment station as described herein) to pour or otherwise transfer the refrigerant to the pad 170 (see channel 1010 in FIG. 10B which will be described in greater detail below). In one aspect the cryogenic refrigerant space 170S may be separated from the internal cavity 110C by a separation wall or basket 1015 (FIG. 10A). The separation wall 1015 may have holes or other apertures in the wall that allow refrigerant to pass between the internal cavity 110C and the cryogenic refrigerant space 170S such that the refrigerant can be replenished by pouring the refrigerant into the internal cavity such that the refrigerant passes through the holes and into the absorbent member 170. In other aspects a sealable coupling or port 170P (FIG. 1E) may be provided at any suitable location of the portable cryogenic workstation 100, 100′, 100″, 100′″ (e.g. on the housing 110, 110′, 110″, 110CH and/or lid 113, 113′) for allowing connection of any suitable refrigerant source to the portable cryogenic workstation for replenishing the refrigerant while the lid 113, 113′ remains on the housing 110, 110′, 110″, 110CH as will be described in greater detail below. As may be realized the sealable coupling 170P may be located on a side, top or bottom of the portable cryogenic workstation 100, 100′, 100″, 100′″ and may allow for an automated replenishment of the refrigerant such as when the portable cryogenic workstation 100, 100′, 100″, 100′″ is docked or otherwise interfaced with a sample storage system or at any other suitable refrigerant charging/replenishment station 163 (which may be substantially similar to automated sample storage system 200, 200′ described herein) as will be described below. In other aspects the sealable coupling 170P may allow the portable cryogenic workstation to function as a controlled rate freezer (e.g. by supplying nitrogen gas at a predetermined temperature or misted LN2 into the cavity 110C where, for example, a temperature sensor 169 provides temperature feedback to a controller 164, which in one aspect may be integral to the portable cryogenic workstation or in other aspects located on the station 163 and/or the automated sample storage system 200, 200′ and may be configured to control a rate of nitrogen gas entering the cavity 110C based on signals from the temperature sensor 169) and/or a defroster (e.g. that supplies cycles of warm and cold dry nitrogen into the cavity 110C). In other aspects, the controller 164 (integral to the portable cryogenic workstation) may be in communication with any suitable central controller (as will be described below) where the central controller is connected to the station 163 and/or automated sample storage system 200, 200′ for controlling a rate of refrigerant entering the cavity 110C. In still other aspects, the portable cryogenic workstation 100, 100′, 100″, 100′″ can function as a passive controlled rate freezer where there is no feedback from sensors or added gas supply. In this aspect the portable cryogenic workstation 100, 100′, 100″, 100′″ may cool down the samples in a repeatable manner depending on, for example, the heat capacity of the samples and their containers, e.g., including the tray the samples are located such that different trays may allow for different passive cooling rate profile to be attained. In still other aspects the sealable coupling or port 170P may be configured to allow a pouring of the refrigerant into the cryogenic refrigerant space.

As may be realized, referring again to FIGS. 1B and 1C, the refrigerant within the cavity 110C may provide a “pre-cooled” environment in which the samples are placed so that, for example, moisture and gases entering, for example, a sample storage system can be controlled and/or a heat load introduced into the sample storage system can be minimized while maintaining the samples at a predetermined temperature. It is also noted that by venting evaporated refrigerant (e.g., evaporated LN2) into the cavity 110C, the environment within the cavity 110C is substantially constantly replenished with cold, dry gas. The cold, dry gas is dense and forms a “pool” in which the samples are submerged which allows for manipulation of the samples with the lid off of the portable cryogenic workstation 100, 100′, 100″, 100′″ as the cold, dry gas pools around the samples. Although the environment within the cavity may be stirred and disturbed by manipulation of the samples, the “pool” stabilizes (as can be seen in FIG. 1B—e.g. the temperature in the portable cryogenic workstation 100, 100′, 100″, 100′″ is naturally stratified illustrated by stratification line STR) and is refilled, keeping the samples submerged in a cold, dry atmosphere (e.g. the portion of the portable cryogenic workstation where the samples are located remains at a temperature less than −150° C.)

In one aspect the portable cryogenic workstation 100, 100′, 100″, 100′″ may include any suitable identification indicia and/or any suitable sensors for monitoring the samples within the portable cryogenic workstation. For example, any suitable temperature sensor 169 (FIG. 1C) may be disposed within the cavity 110C at a location that is proximate the samples. The temperature sensor 169 may provide an estimate of the sample 150 temperature by sensing a temperature within the cavity. In other aspects the temperature sensor 169 may be in substantially direct contact with one or more sample containers (e.g. that hold the samples 150) within the cavity 110C for providing a substantially direct temperature reading of each of the one or more samples and/or an average temperature of the samples in which the sensor is in substantial direct contact. In one aspect the sensor 169 (and/or other sensors described herein) may be configured to wirelessly (or without contact) send temperature data (or any other suitable data as described herein and generally referred to as ephemeral or process data) to any suitable receiving device, such as a display unit/user interface 169D disposed on an outer surface of the portable cryogenic workstation 100, 100′, 100″, 100′″ for monitoring the process data at the portable cryogenic workstation 100, 100′, 100″, 100′″. The display unit 169D may include a process data capture unit configured to capture the ephemeral or process data corresponding to a predetermined processing characteristic(s) of at least one sample coincident with the presence of the sample within the portable cryogenic workstation. The process data capture unit DCU may also be configured to capture data related to a status (e.g. temperature, lid presence, handle position, consumable media level) of the portable cryogenic workstation 100, 100′, 100″, 100′″ and/or a date and time. In other aspects, the process data capture unit DCU may be configured to capture data related to the samples (or other items) within the portable cryogenic workstation 100, 100′, 100″, 100′″. For example, in one aspect the portable cryogenic workstations may be employed for organ transplants (e.g. transport of organs), blood sample transportation, syringe transportation and/or as a shipping container for any other suitable biological or other sample that requires cryogenic transportation. Each item (such as samples 150, organs, blood samples, syringes, etc.) within the portable cryogenic workstation 100, 100′, 100″, 100′″ may be identified in any suitable manner (such as a barcode or other identifier as described herein). The identification of the items (and their location within the portable cryogenic workstation 100, 100′, 100″, 100′″ e.g. such as when the items are located within tray 150T or other holding device) may be transferred to the data capture unit DCU to allow tracking of the items during transport and/or analysis of the items.

In one aspect the process data capture unit DCU may be in communication with any suitable data transmitter unit 164T configured to transmit the process data received from the various sensors and other ephemeral data (as described herein) to a user interface disposed remotely from the portable cryogenic workstation 100, 100′, 100″, 100′″, any suitable automated handling equipment at a location remote from the portable cryogenic workstation 100, 100′, 100″, 100′″, and/or at the automated handling equipment to which or into which the portable cryogenic workstation 100, 100′, 100″, 100′″ is interfaced. The ephemeral or process data may enable reviewing/analyzing of the data at or remotely from the portable cryogenic workstation 100, 100′, 100″, 100′″ as historical data (e.g. defining a process history) and/or in real time (e.g. where data is transmitted about every 250 milliseconds or at any other suitable time interval). The display unit/user interface 169D may include or otherwise be communicably connected the transmitter 164T, a controller 164, a processor 164P and memory unit 169M configured to allow processing and analysis of the data received from the temperature sensor 169 (or any other suitable sensors such as accelerometers, position and/or location sensors (e.g., spatial orientation or GPS sensors), weight sensors, refrigerant level sensors, pressure sensors, sensors to detect and/or measure refrigerant outgassing, etc.) and/or the identification indicia 168 (e.g. RFID tags, barcodes, etc.) as will be described below. In one aspect the process data capture unit and the transmitter unit 164T may also be configured to receive information from a user interface disposed remotely from the portable cryogenic workstation 100, 100′, 100″, 100′″, any suitable automated handling equipment at a location remote from the portable cryogenic workstation 100, 100′, 100″, 100′″, and/or at the automated handling equipment to which or into which the portable cryogenic workstation 100, 100′, 100″, 100′″ is interfaced. For example, an identification of samples loaded (e.g. barcodes or other identifiers) into the portable cryogenic workstation 100, 100′, 100″, 100′″ and/or a date and time of loading the samples may be communicated to and stored in the memory 169M.

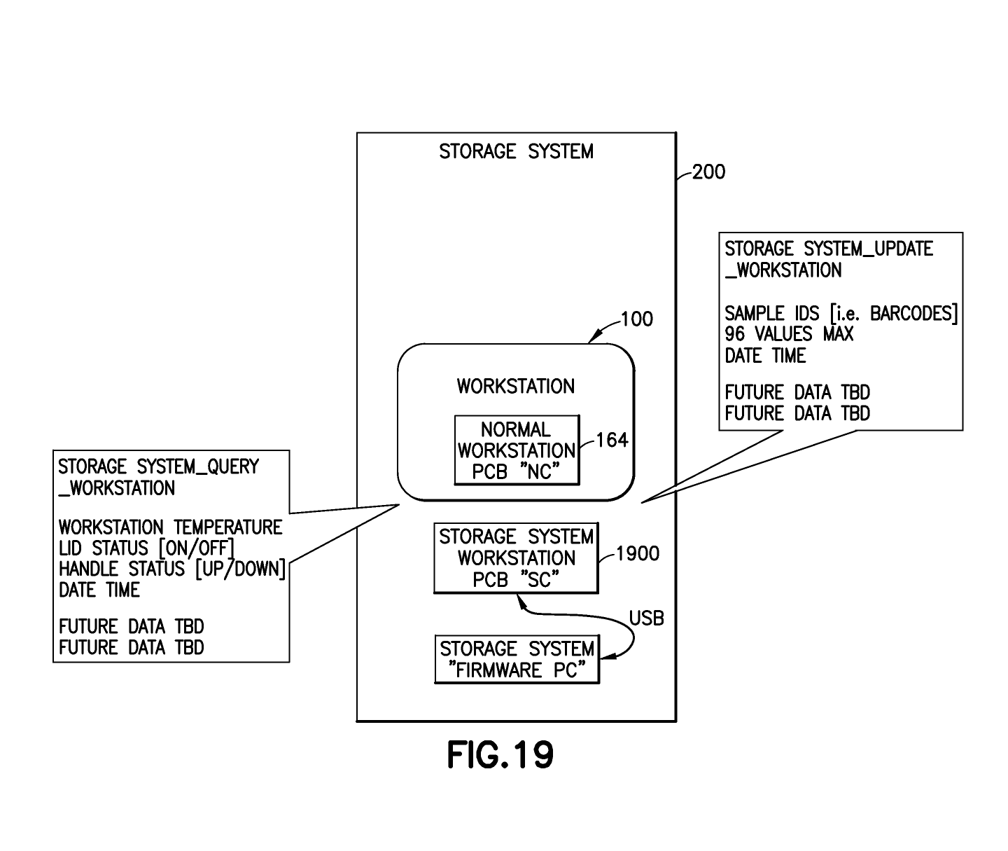

Referring to FIG. 19 the portable cryogenic workstation 100, 100′, 100″, 100′″ may wirelessly communicate to the machine in which it is placed (e.g. automated sample storage system 200, 200′, refrigerant charging/replenishment station 163, etc.). For example, the portable cryogenic workstation may provide any suitable ephemeral, process, or status data to, for example, a controller 1900 of the machine such as a temperature of the samples 150, a temperature within the cavity 110C, a consumable media level within the portable cryogenic workstation, lid presence, handle position, date, time, etc. The portable cryogenic workstation 100, 100′, 100″, 100′″ may also be configured to wirelessly receive information from the machine such as an identification of the samples 150T, a date and time the samples were made or placed in the portable cryogenic workstation. In another aspect the portable cryogenic workstation may include a data transfer port DTP (FIG. 1C) such as a USB port, serial port, Ethernet port, or other connection for allowing data transfer to and from the portable cryogenic workstation. In one aspect a user may connect a remotely located computer to the portable cryogenic workstation through the data transfer port DTP for communicating the data described herein. In another aspect the machine in which the portable cryogenic workstation in inserted may communicate with the portable cryogenic workstation through the data transfer port DTP. For example, as the portable cryogenic workstation is inserted into the machine a connector, corresponding to the data transfer port DTP, may engage the data transfer port for hard wiring a communication connection between the machine and the portable cryogenic workstation.

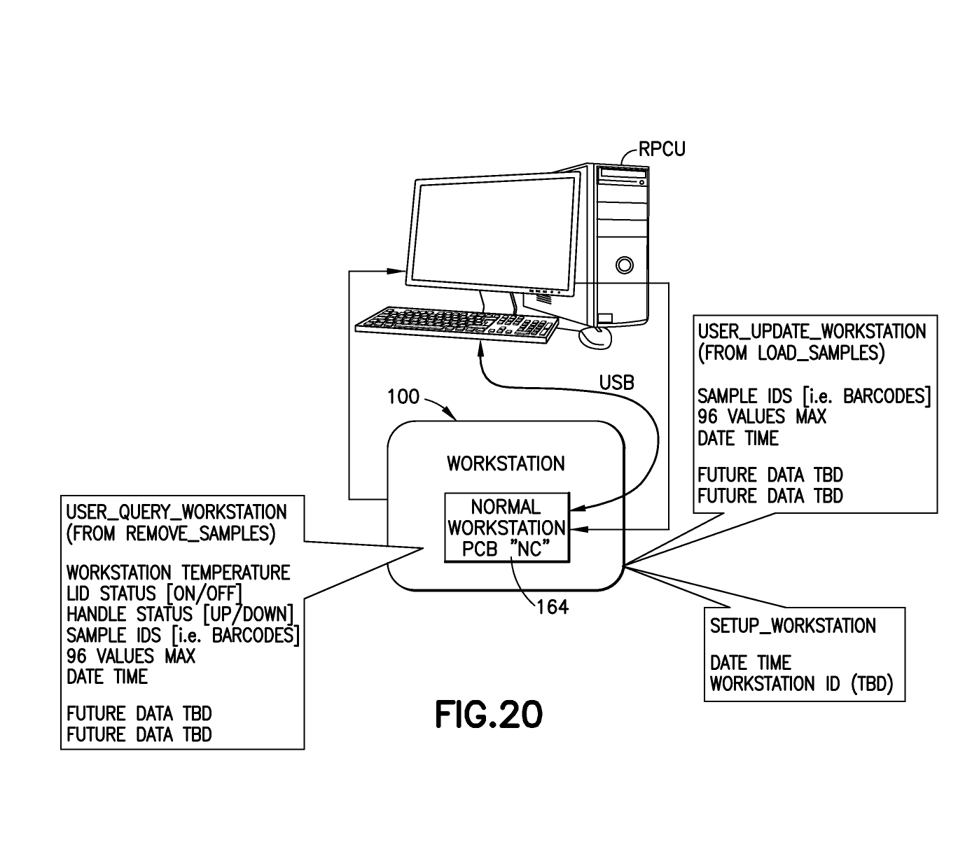

In one aspect, referring to FIG. 20, the data may be transferred to a remotely located computer RPCU or other device (either wirelessly or through a wired connection such as through data transfer port DTP or both) that allows, for example, a physician/doctor to obtain a location and/or status (which may include the data described herein with respect to the portable cryogenic workstation) of the sample 150, organ, syringe, etc. and its status. As an example, blood samples may be provided for analysis within a portable cryogenic workstation 100, 100′, 100″, 100′″ and sent to a laboratory. The physician or other authorized person may, through the remotely located computer and communication with the process data capture unit DCU, access the data stored in the memory 169M of the portable cryogenic workstation 100, 100′, 100″, 100′″ to obtain any suitable information pertaining to history, status, and/or location of the samples provided. For example, in one aspect the portable cryogenic workstation 100, 100′, 100″, 100′″ may be provided with a clock and global positioning (or other location tracking capability) such that the physician may obtain a physical location of the samples 150T. In another aspect, as each sample is removed from the portable cryogenic workstation 100, 100′, 100″, 100′″ and analyzed the process data capture unit DCU may be updated (e.g. as to which samples have been removed, analyzed and returned to the workstation) so that, for example, the physician can remotely determine which samples 150T have been analyzed. A handle position indicator may also be provided to the physician to, along with a location of the sample, may indicate tampering with the samples. Updating the data may occur through any suitable short or long range wireless communication or through a wired connection such as, for example, RFID, Bluetooth, Zigbee, induction or infrared wireless communication, ultra wideband communication, cellular, satellite, Ethernet, USB, etc. In one aspect remote access to the data of the portable cryogenic workstations may be provided through the Internet, World Wide Web or other suitable user interface accessible from the remotely located computer or other device.

For example, as described herein, the sensor 169 may communicate with a fluid supply source (which may be under the control of the controller 164) coupled with the portable cryogenic workstation 100, 100′, 100″, 100′″ so that fluid (e.g. gaseous, vapor, liquid, etc.) may be introduced into the cavity for regulating a temperature within the portable cryogenic workstation 100, 100′, 100″, 100′″ based on signals from the temperature sensor 169. In other instances, fluid may be introduced into the cavity for regulating a temperature within the portable cryogenic workstation 100, 100′, 100″, 100′″ based on signals from ambient temperature (e.g., laboratory temperature) sensors, weight sensors, fluid level sensors, gas pressure sensors, and/or sensors to detect and/or measure outgassing from the workstation (e.g., from evaporating refrigerant) or the absence of outgassing from the workstation. The wireless or contactless communication may be performed inductively or through any suitable communication protocol such as RFID, Bluetooth, Zigbee, induction or infrared wireless communication, ultra wideband communication, cellular, etc.

As noted above, identification indicia 168 may also be provided. The identification indicia may be in the form of any suitable barcode, RFID tag, re-programmable memory device or other indicia/device that identifies the samples 150 and/or rack(s) 150T within the cavity to an operator, the controller 164 and/or automated handling equipment. In other aspects the identifying indicia 168 may be a re-programmable memory device configured to store information pertaining to the samples 150 and/or rack(s) 150T within the cavity 110C and display or otherwise communicate the stored information to an operator and/or automated handling equipment such as the sample storage system. As may be realized, the re-programmable memory device may be configured to allow the sample storage system and/or an operator to re-program the memory device in any suitable manner as samples are added to or removed from a respective portable cryogenic workstation 100, 100′, 100″, 100′″.

In one aspect, the portable cryogenic workstation 100, 100′, 100″, 100′″ may have any other suitable sensors connected to the memory 169M for sensing and/or logging any other suitable data such as, for example, information regarding whether the lid is on or off (see sensor 169L in FIG. 1C), a position of the handle (sensor 169H in FIG. 1E), information regarding the type of sample container (e.g. vial type, slide, etc.), a sample descriptor, and/or a height or type of tray holder TH (or type of cartridge 120).

Process tracking data related to the samples 150 and/or portable cryogenic workstation 100, 100′, 100″, 100′″ gathered by the sensors (e.g. temperature, time, status of the portable cryogenic workstations 100, 100′, 100″, 100′″, location of the samples, identification of the samples, etc.) may be temporally stored in the memory 169M in a re-programmable manner such that the process tracking data being stored is associated with an identity of the samples (e.g. through identification of the samples with the controller using the RFID tag, other indicia or suitable user input). In one aspect the process tracking data may be accessible to the user via the display 169D so that the user may analyze the process tracking data from the portable cryogenic workstation using the display 169D (which may be a touch enabled display or have any other suitable user input devices such as a keypad 169DP—FIG. 1J), to interface with the controller 164, processor 164P and memory 169M. In other aspects other communication devices, such as a computer remotely connected to the portable cryogenic workstation through a wired, e.g. Universal Serial Bus, firewire, Ethernet, etc., or wireless computer link 169ML with the memory 169M and using any suitable communication protocols such as those described herein may be used to analyze the process tracking data. In still other aspects the process tracking data may be accessible to automation equipment such as the sample storage system described herein for automated analysis of the process tracking data. As may be realized, the information may also be transferred in any suitable manner to any suitable laboratory software or other process management and/or inventory software and/or database.

As may be realized, the process tracking data may be obtained by the sensors and stored in the memory 169M in any suitable manner and for any suitable period(s) of time. For example, in one aspect the process tracking data, including e.g. the data described above, may be a “running” data log in which process tracking data is substantially continuously gathered and stored in the memory 169M for any suitable period of time to provide a process history for the samples 150. The data log may be periodically reset in any suitable manner and at any suitable time, such as when samples are removed from the portable cryogenic workstation and different samples are inserted into the portable cryogenic workstation. In other aspects, a triggering event may cause, for example, controller 164 to begin recording process tracking data for creating the historical data log. For example, when the temperature sensor 169 senses a temperature above a predetermined threshold and/or when the lid sensor 169L senses the lid has been removed (or in response to any other suitable triggering event), a signal may be sent to the controller 164 to begin recording process tracking data from the various sensors. As may be realized, the controller 164 may be suitably configured for power management such that one or more of the memory 169M, processor 164P, display 169D and other suitable powered components of the portable cryogenic workstation 100, 100′, 100″, 100′″ remain off until a signal indicating an occurrence of the triggering event is received by the controller 164. After a predetermined period of time and/or after, for example, the temperature returns to a value below the threshold value and/or the lid is replaced, the controller 164 may turn off one or more of the memory 169M, processor 164P, display 169D and the other suitable powered components until the next triggering event occurs.

Referring to FIG. 1U, the portable cryogenic workstation 100, 100′, 100″, 100′″ may include one or more sample location sensors 172A, 172B for guiding an operator to one or more predetermined samples to be picked from the portable cryogenic workstation 100, 100′, 100″, 100′″. In one aspect the sample location sensors 172A, 172B may be any suitable sensors (such as optical, ultrasonic, infrared, capacitive, etc.) configured to detect a location of a transfer tool TW (such as tweezers, a fingertip of a glove or other tool configured to allow an operator to pick individual samples 150) relative to the samples 150 within the portable cryogenic workstation 100, 100′, 100″, 100′″. For example, as described herein, the tray 150T is located within the portable cryogenic workstation 100, 100′, 100″, 100′″ at a predetermined location such that the location of each sample is known relative to a coordinate system (Z-X) of the portable cryogenic workstation 100, 100′, 100″, 100′″. A tip of the transfer tool TW may be detected by the sensors 172A, 172B such that, for example, processor 164P of the user interface/display 164D (or other suitable user interface such as of a personal computer or a user interface incorporated into a pair of glasses that is in communication with the sensors 172A, 172B) determines the position of the tip of the transfer tool TW in the coordinate system Z-X. The user interface may provide location feedback to the operator to confirm that the operator is picking the one or more predetermined samples 150 to be picked from the portable cryogenic workstation 100, 100′, 100″, 100′″.

Referring now to FIGS. 10A-10D, an exemplary construction of the portable cryogenic workstation 100 will be described. As may be realized, portable cryogenic workstations 100′, 100″ may have a similar construction. In one aspect the housing 100 may include an outer shell 1000, an inner shell 1005 and a bottom skin 1002. The inner shell 1005 may be nested within the outer shell 1000 (e.g. the portable cryogenic workstation includes a nested wall containment housing) and may be formed in any suitable manner, such as by molding, as a unitary component (e.g. one piece) or as multiple components that are assembled together in any suitable manner (FIG. 11, Block 1100). The inner and outer shells 1005, 1000 may be constructed of any suitable material such as, for example, any suitable plastic, composite or metal. The outer shell 1000 may include an outer peripheral surface 1000P1 and the inner shell may include an inner surface 1000P2 (that forms the side walls and bottom of cavity 110C). At least one of the outer shell 1000 and inner shell 1005 may include a top peripheral surface 1000P3 that may join the outer shell 1000 and the inner shell 1005. The top peripheral surface 1000P3 may be configured to interface with the lid 113 and provide a mounting surface for any suitable components of the portable cryogenic workstation 100 such as, for example, handle 190. Any suitable insulative material 1003 may be disposed between the inner and outer shells 1000, 1005. In one aspect the insulative material 1003 may be an insulating foam while in other aspects the insulative material 1003 may be one or more insulated panels 1020 that are disposed within a vacuum sealed bag to form a one piece flat panel having jointed bottom and side panels BP, SP (e.g. a folded vacuum insulated panel layer disposed within or between the nested walls). The bottom and side panels BP, SP may be folded to form an open box 1003B (or any other suitable shape) having a cavity 1003C such that the open box 1003B may be placed between the outer and inner shells 1000, 1005 where the inner shell 1005 is disposed within the cavity 1003C (FIG. 11, Block 1101). Any suitable cushioning/insulative medium 1002, such as for example, a polyurethane foam, may be poured or otherwise inserted between the inner and outer shells 1000, 1005 and at least partly around the insulative material 1003 (FIG. 11, Block 1102). The bottom skin 1001 (which in one aspect includes the kinematic locating features and hold down features described herein) may be affixed to the outer shell 1000 in any suitable manner (such as with an adhesive, ultrasonic welding, etc.) to encase the cushioning medium 1002 and insulative material 1003 (FIG. 11, Block 1103).

In one aspect the consumable media accumulator such as absorbent/reservoir pad 170 (e.g. having an open cell structure, a baffled structure, a sponge, a foam, a cold block or any other suitable structure for retaining the consumable media) may be placed in the inner shell 1005 to form an integrated distributed cooling interface with the samples within the portable cryogenic workstation as will be described below. The absorbent pad 170 may be formed to position the separation wall 1015 at a predetermined location relative to kinematic locating features 112, 112′, 112″, 112′″ of the housing 100. In other aspects the separation wall 1015 may be located relative to the kinematic locating features of the housing in any suitable manner, such as by affixing the separation wall 1015 to the inner shell 1005. The separation wall may form a cooling interface or shield with conductive walls that may be constructed of any suitable material, such as e.g. aluminum, configured to provide distributed cooling surface (e.g. substantially uniform conductive transfer heat effected by contact with the consumable media accumulator and containers 150 disposed within the cavity 110C). In one aspect the separation wall may include locating features 119 (FIG. 1B) for locating the tray 150F and/or tray holder TH (or cartridge 120) within the housing as described herein. In one aspect the separation wall 1015 may be shaped to provide a channel or path 1010 through which refrigerant may pass. The channel 1010 may be aligned with an aperture RA in the lid 113, 113′, 113″ where refrigerant may be inserted into the channel 1010 through the aperture RA (or directly into the channel, e.g. with the lid off) for passage to the absorbent pad 170 so that the refrigerant may be replenished.

The lid 113, 113′, 113″ may be constructed in any suitable manner. In one aspect the lid may have a skin 113S and a core 113C. In one aspect the skin 113S may be over-molded on the core 113C while in other aspects the lid may be formed of any suitable number of panels assembled in a manner substantially similar to that described above with respect to the housing 110. Any suitable electronics, couplings, connections, etc. as described herein may be affixed to the assembled lid 113, 113′, 113″ and housing 110 in any suitable manner.

As noted above, referring also to FIGS. 2, 3A, 3B and 6A, the housing 110, 110′ may be configured to interface with, for example an automated sample storage system 200, 200′. It should also be understood that housing 110″, 110CH may also be configured to interface with, for example, the automated sample storage system 200, 200′ in a manner substantially similar to that described herein for housing 100, 110′. In one aspect the automated sample storage system 200, 200′ (only a portion of which is shown in the FIGS. 2A and 2B) may include a load port or loading unit 201, 201′, any suitable automated sample transfer unit 290 and one or more cold storage units or vaults 291 communicably connected to the automated sample transfer unit 290. The loading unit 201, 201′ may include any suitable load port door 220 configured to seal an opening 207A of the loading unit as will be described below. It is noted that the opening 207A when opened may communicably connect the cavity 110C with an interior of the transfer unit 290 for transferring samples 150 and/or trays 150T between the cavity 110C and the transfer unit 290. The load port door 220 may include any suitable features or members 208, such as fins, to substantially prevent frost formation between the door 220 and the load port frame LPF (see e.g. FIG. 2A).

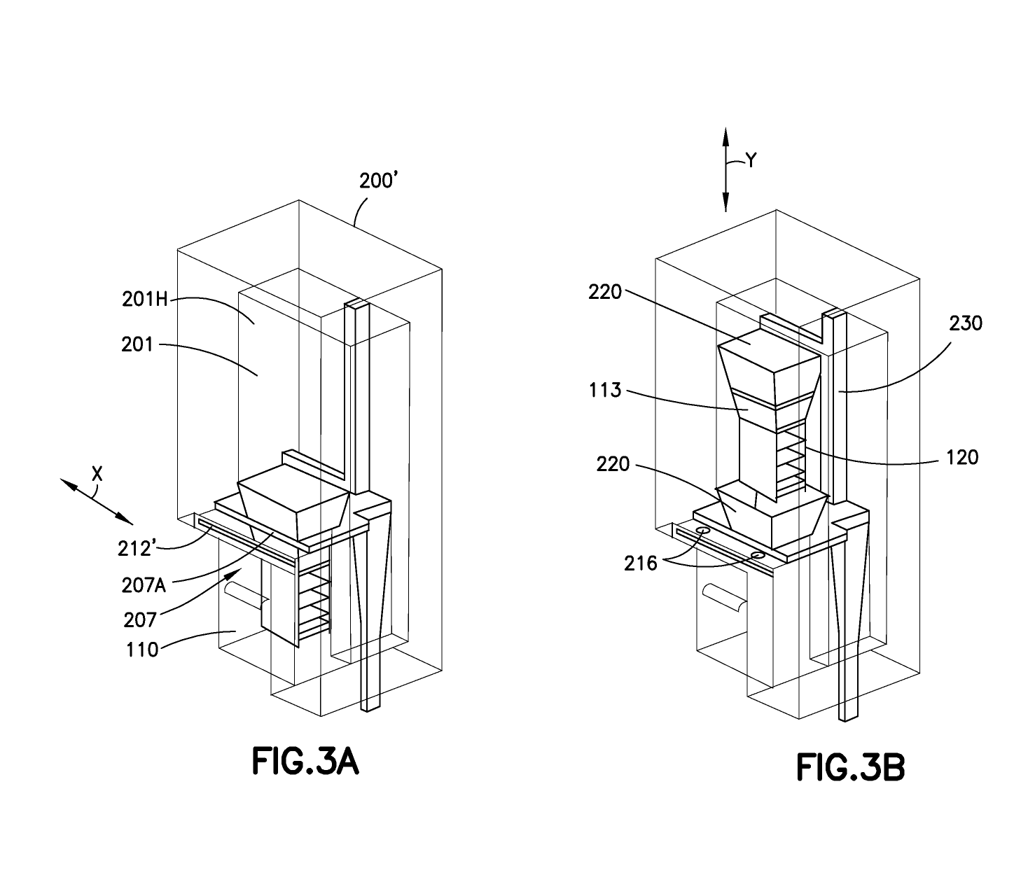

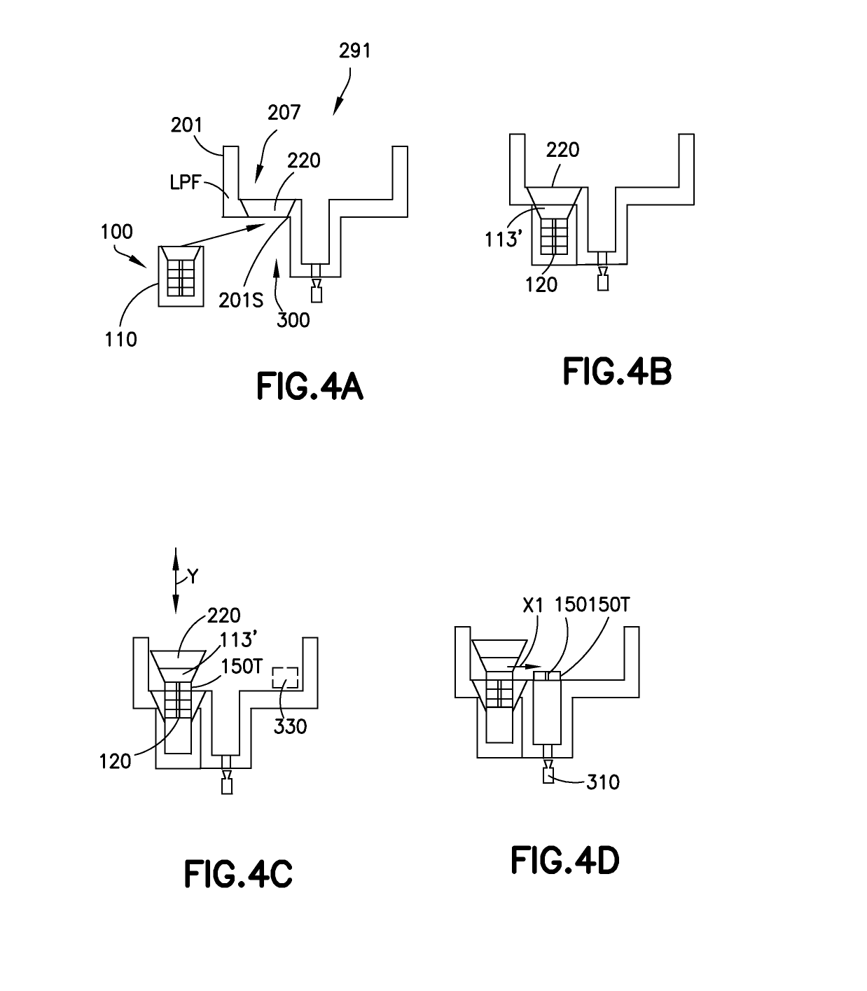

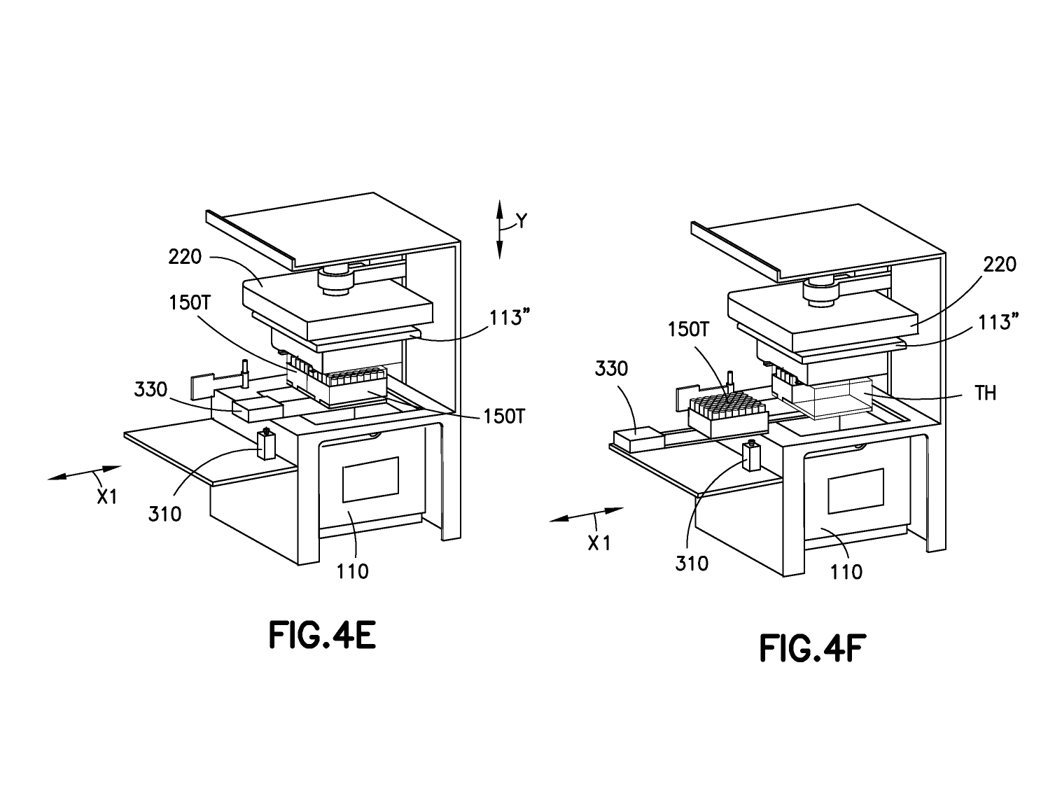

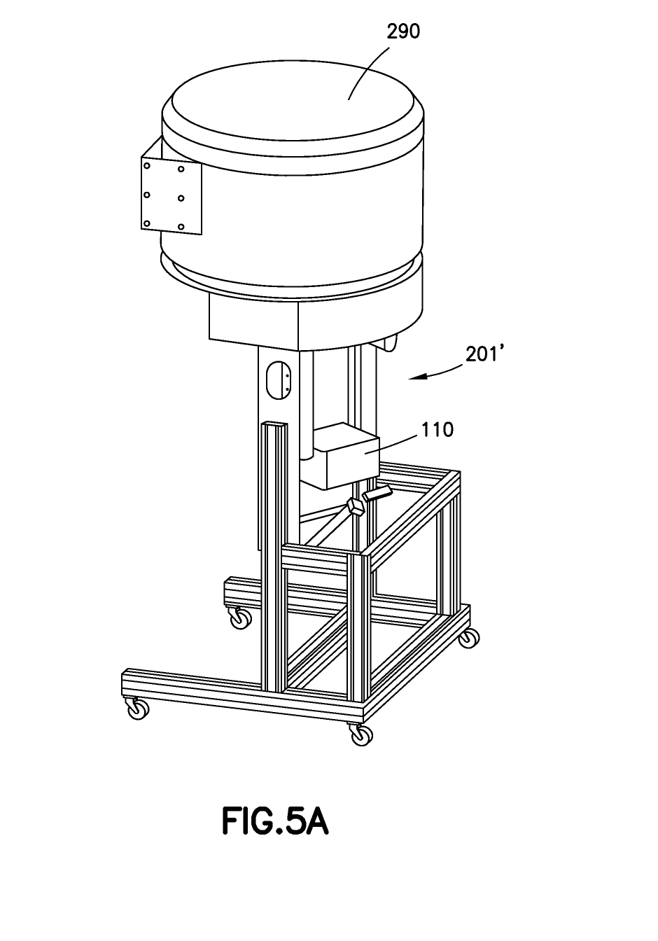

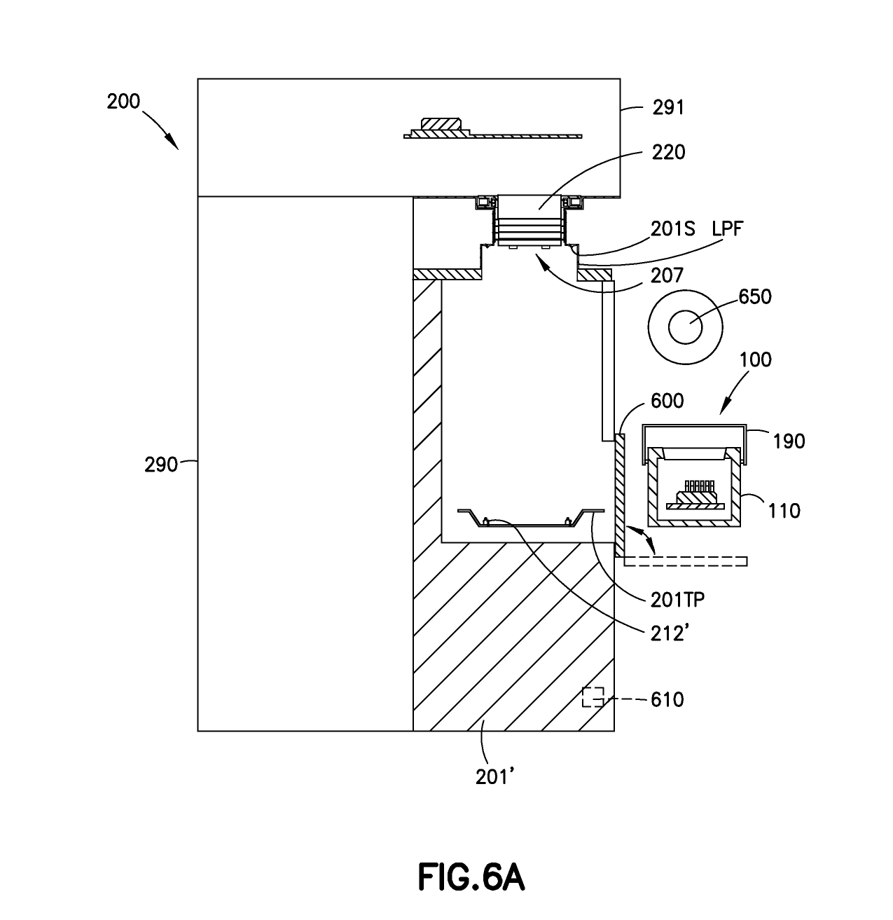

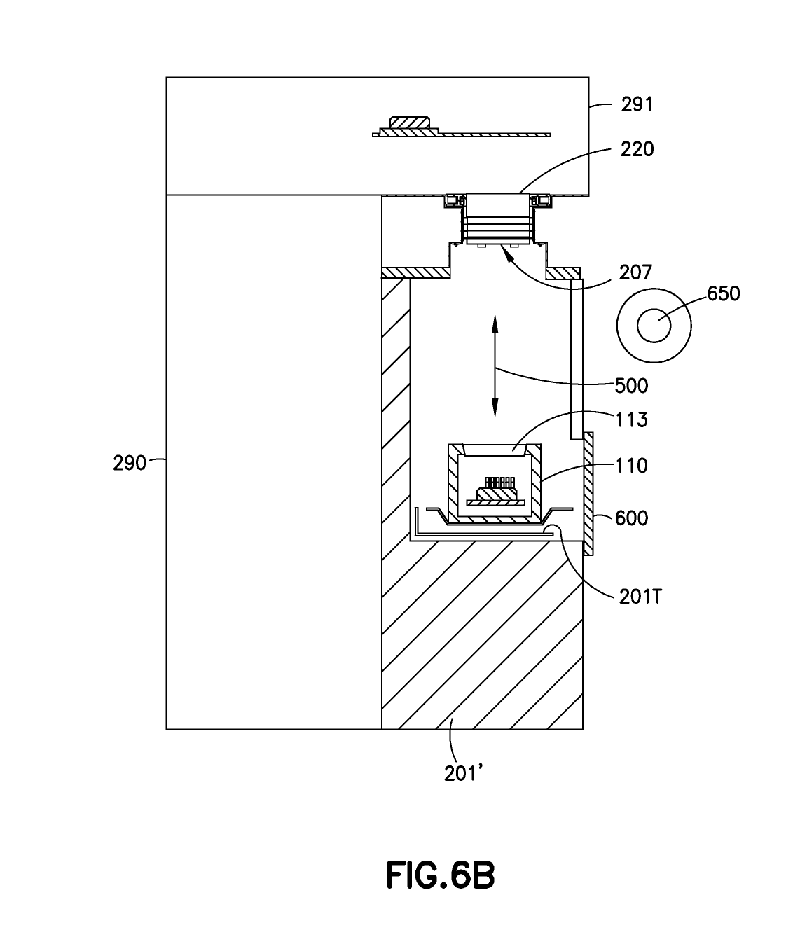

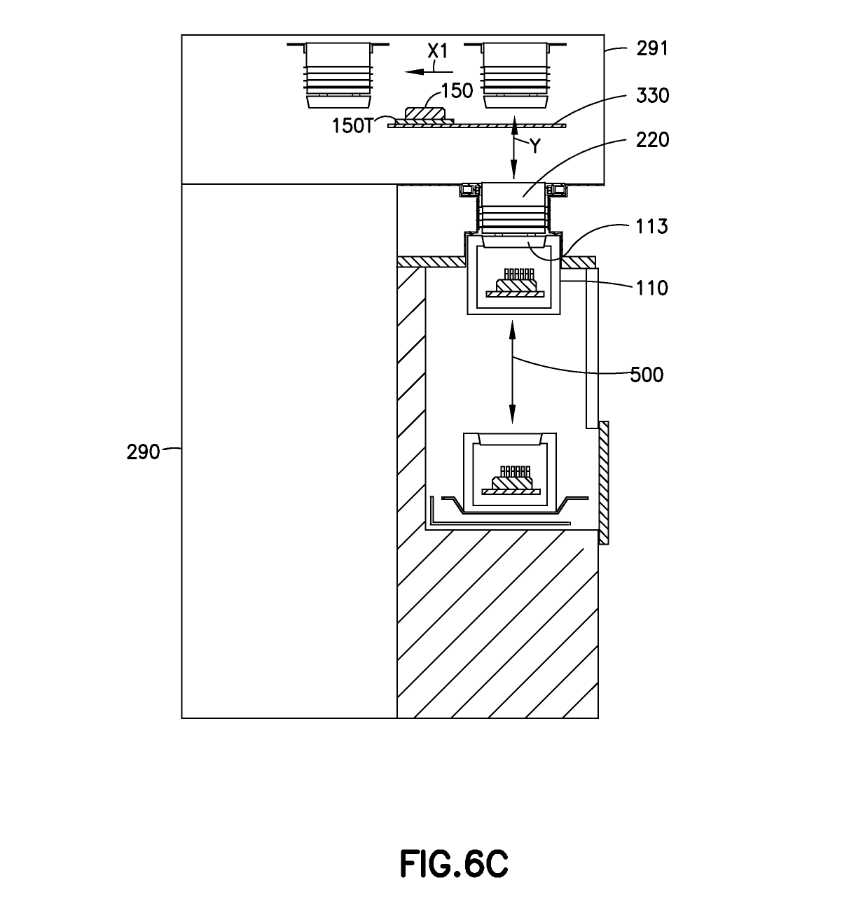

The one or more cold storage units 291 may be any suitable storage units such as, for example, a Dewar type storage unit having any suitable shape. The one or more cold storage units 291 are configured with high vacuum insulation for long term sample storage and may include high density storage shelves and trays. Trays may be moved in and out of the one or more cold storage units 291 through any suitable aperture such as an automated access door and all heat generating motors for the automation (e.g. doors and transports) are located outside the one or more cold storage units 291 and connected to internal robotics through low heat conductive connections. In other aspects the motors may be located within the storage units 291 but thermally isolated from the internal atmosphere of the storage units 291. Refrigeration for the one or more cold storage units 291 may be provided by liquid nitrogen (LN2) through a closed evaporation coil or in any other suitable manner. Spent LN2 may be exhausted from the storage units 291 in any suitable manner. In other aspects the one or more cold storage units may be cooled by mechanical refrigeration. As noted above the one or more cold storage units may be “ultra-cold” storage units configured to maintain a temperature within the storage unit at or below about −150° C. however, in other aspects any suitable temperature may be maintained within the one or more storage units. In one aspect the one or more cold storage units 291 and transfer unit 290 may be connected to each other in any suitable manner or integrated into a common housing. As may be realized, the automated sample transfer unit 290 may include a sample handling area including any suitable transport unit 290T configured to transfer one or more samples 150 and/or trays 150T of samples 150 between portable cryogenic workstations 100, 100′, 100″, 100′″ interfaced with the loading unit 201, 201′ and the one or more storage units 291. In other aspects the samples 150 may be transferred between one or more portable cryogenic workstations. In one aspect the transport unit 290T may be a common transfer unit that is common to both the sample handling area and the ultra-cold storage unit(s) 291. As may be realized, the sample handling area may be maintained at any suitable temperature such as a cold temperature or ultra-cold temperature. In one aspect the loading unit 201, 201′ may be insulated while in other aspects the enclosure may be uninsulated. In one aspect the transport unit 290T may be configured to reach into the portable cryogenic workstation 100, 100′, 100″, 100′″ housing 110, 110′, 110″, 110CH from the top down for gripping and removing one or more samples 150, the tray 150T or the tray holder TH (as illustrated in e.g. FIGS. 6A-6C). In other aspects the tray holder TH may be connected to the lid 113, 113′, 113″ in any suitable manner so that as the lid is removed into the transfer unit 290 the tray 150T travels with the lid to expose a side of the tray holder TH such that the tray 150T and the samples 150 therein are removed with a sideways transfer motion (as will be described below with respect to, e.g., FIGS. 3A-4F). In one aspect the tray holder TH may be removably connected to the lid 113, 113′, 113″ with any suitable latching mechanism such as, for example, rotary latch actuating locking rods, rack and pinion latches, push rods actuated by contact with kinematic pins, etc.

In one aspect the transfer unit 290 may include a separate, independently refrigerated, ultra-cold (e.g. −150° C.) area (e.g. a sample handling area), divided from the one or more storage units 291 by a sealed, insulated, and automated door or in any other suitable manner. In other aspects the independently refrigerated area may have any suitable temperature. The transfer unit 290 may be configured to interface with portable cryogenic workstations, as described herein, so that samples can be input to or output from the storage system. The transport unit 290T, as noted above, may be configured to transfer individual vials, tubes, or cassettes (e.g. sample containers) between standard laboratory racks/trays 150T (such as SBS racks and/or cryogenic vial boxes) and any suitable high density rack/trays. In one aspect the SBS rack may be configured to hold, for exemplary purposes only, 48, 96 or any other suitable number of samples/sample containers. In another aspect the cryogenic vial boxes may be configured to hold, for exemplary purposes only, 81, 100 or any other suitable number of samples/sample containers. The transport unit 290T may also be configured to remove the samples/trays from the cavity 110C and/or insert samples/trays into the storage units 291. The transfer unit 290 may include any suitable sensors and/or cameras configured to read sample barcodes and positions, and may act as a staging area for water ingress, where small amounts of water entering during the sample input or service operations are trapped and controlled, keeping the storage units 291 substantially frost free. Upon sample 150 input, the portable cryogenic workstation interface (e.g. IF3) is configured to seal against the housing 110, 110′, 110″, 110CH and the transport unit 290T (or a component thereof) may be configured to automatically remove the lid 113, 113′, 113″ extract a tray 150T of samples 150, optionally return an empty tray 150T to the portable cryogenic workstation 100, 100′, 100″, 100′″, and replace the lid 113, 113′, 113″ as described below. Conversely on sample 150 output, the transport unit 290T may optionally extract an empty sample tray 150T from the cavity 110C, deliver a tray 150T of samples 150 to the cavity 110C, and replace the lid 113, 113′, 113″. As may be realized, during these input and output processes, the sample handling area is sealed from an external atmosphere (e.g. a laboratory environment) such that the sample handling area is in communication only with the inside of the cavity 110C. As described herein the inside of the cavity 110C is at cryogenic temperatures (e.g., approximately LN2 temperatures) so that there is substantially no temperature fluctuation (e.g. where the sample handling area is also at cryogenic temperatures and the samples entering the sample handling area are pre-cooled by the portable cryogenic workstation 100, 100′, 100″, 100′″) or water ingress to the sample handling area. The motors of the transport unit 290T may be located outside of or otherwise thermally isolated from the sample handling area and connected to internal robotics through low heat conductive connections as described above with respect to the storage units 291.

The loading unit 201, 201′ may have a housing 201H and a closeable input/output port sealed interface or load port 207 configured to seal the cold storage unit 291 (and transfer unit 290) from an outside atmosphere and provide a sealed coupling with the portable cryogenic workstation 100, 100′, 100″, 100′″. Referring also to FIGS. 2A, 2B and 2C the sealed interface 207 may include any suitable number of interfaces configured to seal a storage atmosphere and storage temperature of one or more of the cold storage unit 291, transfer unit 290 and cavity 110C from an atmosphere and temperature external to storage atmosphere and storage temperature. In one aspect the sealed interface includes a load port door 220 to load port frame LPF (e.g. around a periphery of the opening 207A) interface IF1, a load port door 220 to portable cryogenic workstation 100, 100′, 100″, 100′″, door interface IF2, a portable cryogenic workstation 100, 100′, 100′ housing 110, 110′, 100″, 110CH to load port frame LPF (e.g. around a periphery of the opening 207A) interface IF3 and a portable cryogenic workstation door or lid 113, 113′, 113″ to housing 110, 110′, 100″, 110CH interface IF4 (which is described above). It should be understood that while the interfaces IF1-IF4 are illustrated in FIGS. 2A, 2B and 2C with respect to door or lid 113 and housing 110 that the interfaces IF1-IF4 for door 113′, 113″, 113′″ and housing 110′, 110″ 110CH may be substantially similar.

The loading unit 201, 201′ includes a closeable opening 207A that may be sealed or otherwise closed by an input/output or load port door 220. The load port door 220 may include a sealing surface 220S that interfaces (e.g. forming interface IF1) with one or more suitable seals 286A, 286B of the load port frame LPF. In one aspect the one or more seals 286A, 286B may be mounted to an insert 287 coupled to the load port frame LPF while in other aspects the one or more seals may be mounted substantially directly to the load port frame LPF around a periphery of the opening 207A. In one aspect the one or more seals may include a radial seal member 286B and seal member 286A which may be constructed of any suitable material however, in other aspects the seals may have any suitable configuration and arrangement. In one aspect the seal member 286A may be a magnetic seal that is configured to hold the surface 220S so that the surface 220S applies a compressive pressure on the seal member 286B. In other aspects compressive forces may be provided in any suitable manner for forming a seal between the seal member(s) and the door 220.

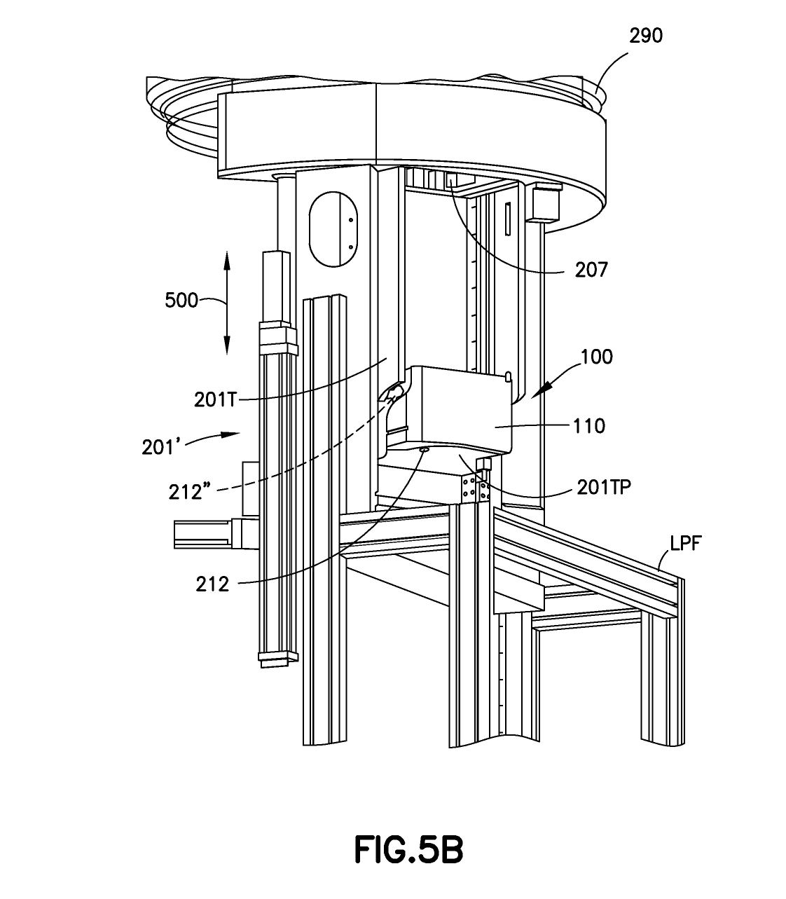

Referring to, for example, FIGS. 1A, 1H, 1I, 1J, 1K, 1L, 1M and 2E (and also to FIGS. 1Q and 1R) the portable cryogenic workstation and the loading unit 201, 201′ may be configured to interface with each other in any suitable manner. In one aspect an outside of the housing 110, 110′, 100″, 110CH may include interface/locating features 112, 112′, 112″, 112′″, such as one or more of kinematic recesses, kinematic grooves, kinematic slots apertures, kinematic pins and/or any other suitable locating features that interface with a corresponding/mating kinematic interface/locating features 212, 212′, 212″ of the loading unit 201, 201′ (see also FIGS. 1H and 5B). As may be realized, multiple sets of interface/locating features may be provided on the housing 110, 110′, 110″, 110CH to allow for a handoff of the portable cryogenic workstation between automated equipment where one effector/gripper engages a first one of the interface/locating features sets and a second effector/gripper engages a second one of the interface/locating feature sets. The locating features 112, 112′, 112″, 112′″ may be spatially related (e.g. have a known relationship) to locating features within the housing such as, for example, locating features 119 (FIG. 1B) for locating the tray 150F and/or tray holder TH (or cartridge 120) within the housing and gripping/locating features 114, 114′, 113A of the lid 113, 113′, 113″. The known spatial relationship between the locating features 112, 112′, 112″, 112′″ on the outside of the housing and the features 119, 114, 114′, 113A may allow for automation, as described herein to remove the lid 113, 113′, 113″ and samples from the housing 110, 110′, 110″, 110CH. As may be realized, any suitable jigs or fixtures may be provided to calibrate or otherwise locate the features 112, 112′, 112″, 112′″, 114, 114′, 113A, 119 relative to one another. In one aspect the housing 110, 110′, 110″, 110CH and/or lid 113, 113′, 113″ may include holding features (that may be integral with the kinematic locating features such as when kinematic slots and grooves are used as illustrated in, e.g., FIGS. 1H, 3A and 3B) that secure the housing 110, 110′, 110″, 110CH to the loading unit 201, 201′ and the lid 113, 113′, 113″ to a gripper or transport of the loading unit 210, 210′. In other aspects the holding features may be included in addition to the kinematic grooves and slots. For example, the housing 110, 110′, 110″, 110CH may include a latch key hole LKH that mates with a latch key LK (FIG. 1A) of the loading unit platform 201TP (FIG. 5B). The latch key LK may be inserted into the latch key hole LKH and rotated through any suitable angle for clamping and holding the housing 110, 110′, 110″, 110CH to the platform 201TP. The lid 113, 113′, 113″ may also include a latch key hole LKH′ that mates with a latch key LK′ of the load port door 220 in a manner similar to that described above.

The load port frame LPF may include one or more seal members 201S for interfacing with (e.g. to form interface IF3) a sealing surface 11051 of the housing 110, 110′, 110″, 110CH. In other aspects, the housing 110, 110′, 110″, 110CH may include any suitable seal members for interfacing with the load port frame LPF. In still other aspects both the load port frame LPF and housing 110, 110′, 110″, 110CH may include seals for interfacing with the other one of the load port frame and housing. The one or more seal members 201S may be any suitable seal members having any suitable configuration. In one aspect the seal members 201S are compressive seal members such that as the housing 110, 110′, 110″, 110CH is pressed against the load port frame (as will be described below) the seals are compressed to seal a space or void SP located between the interfaces IF1, IF2 and IF3.

Referring also to FIGS. 1F, 1H and 2C the load port door 220 and lid 113, 113′, 113″ (which is shown in phantom in FIG. 2C) may be configured to interface with each other (e.g. to form interface IF2) in any suitable manner. In one aspect the load port door 220 may include one or more suitable gripping features 266A, 266B that mate or otherwise interface with one or more corresponding gripping/locating features 114, 114′ of the lid 113, 113′, 113″. It is noted that the gripping features 114, 114′ of the lid may also be configured to allow an operator to grasp the gripping features for manual removal of the lid 113, 113′, 113″ from the housing 110, 110′, 110″, 110CH. In one aspect, as an example, the gripping features 266A, 266B, 114, 114′ may include movable and/or solid state (e.g. substantially no moving parts) gripping features such as mechanical gripping features, pneumatic gripping features, magnetic gripping features and/or any other suitable gripping/clamping features that allow the door 220 to releasably couple to the lid 113, 113′, 113″. As may be realized, clamping of the door 220 to the lid 113, 113′, 113″ may also cause a passive or active release of the lid 113, 113′, 113″ from the housing 110, 110′, 110″, 110CH in any suitable manner. In other aspects the lid 113, 113′, 113″ may be released from the housing 110, 110′, 110″, 110CH in any suitable manner to allow the lid 113, 113′, 113″ to be removed from the housing 110, 110′, 110″, 110CH. In one aspect as can be seen in FIG. 2C the one or more gripping features 266A, 266B may be permanent magnets. The one or more gripping features 266A, 266B may be mounted to the door 220 in any suitable manner such as with any suitable fixed or compliant (e.g. so that a surface of the magnets may be automatically oriented to substantially seat against a corresponding surface of the lid) bracket 265. The bracket 265 may be coupled to the door 220 in any suitable manner. The gripping features 114, 114′ may be constructed of any suitable ferrous material configured to react with the one or more gripping features 266A, 266B to attach the lid 113, 113′, 113″ to the door 220. In other aspects the gripping features 114, 114′ may be magnetic while the one or more gripping features 266A, 266B are constructed of any suitable ferrous material. In still other aspects the one or more the gripping features 266A, 26B may be electromagnets configured to selectively couple with the interface features 114, 114′ for attaching and detaching the door 220 from the lid 113, 113′, 113″.

As may be realized, the interfaces IF1-IF4 described above are configured to operate in a cold or ultra-cold environment such that the integrity of the seals formed by the interfaces IF1-IF4 is maintained. For example, atmospheric air, external to the one or more cold storage units 291, transfer unit 290 and/or portable cryogenic workstation 100, 100′, 100″, 100′″ passes through the seals and enters the cold/ultra-cold environment through the opening 207A (e.g. when the portable cryogenic workstation 100, 100′, 100″, 100′″ is mated with the a closeable input/output port sealed interface 207 through opening 207A) and/or enters into the cavity 110C of the housing 110, 110′, 110″, 110CH. As may also be realized, when the portable cryogenic workstation 100, 100′, 100″, 100′″ is mated with the sealed interface 207 for transporting samples to and from the one or more cold storage units 291 an atmosphere and temperature of the one or more of the cold storage units 291 and transfer unit 290 extends into the cavity 110C so that the portable cryogenic workstation 100, 100′, 100″, 100′″ forms a load lock (e.g. an environment having substantially the same temperature and atmosphere of one or more of the cold storage units 291 and transfer unit 290 where the housing 110, 110′, 110″, 110CH substantially blocks a moisture and temperature path into the cold storage units 291 and/or transfer unit 290) for transferring the samples 150. As noted above, in one aspect the lid 113, 113′, 113″ may be removed from the housing 110, 110′, 110″, 110CH prior to interfacing the housing 110, 110′, 110″, 110CH with the automated storage system, while in other aspects the lid 113, 113′, 113″ may be removed from the housing 110, 110′, 110″, 110CH after the housing 110, 110′, 110″, 110CH is interfaced with the automated storage system but before the housing 110, 110′, 110″, 110CH is sealed (in a manner similar to that described below) to the automated storage system. In these instances the lid 113, 113′, 113″ may not interface with the door 220.

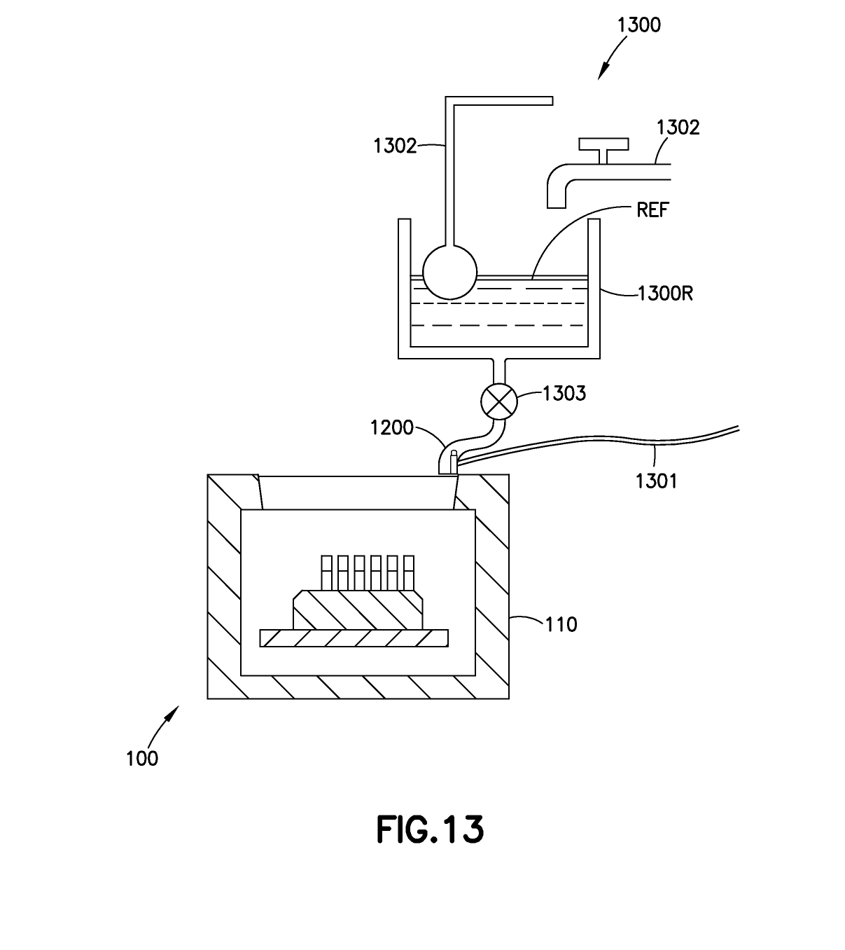

In one aspect the sealed interface 207 may be configured to purge one or more of the interior of the cavity 110C and the space or void SP between the interfaces IF1-IF4. For example, in one aspect the coupling between the lid 113, 113′, 113″ and door 220 may include purge port couplings 276P for automatically communicably connecting inlet and outlet gas lines 276A, 276C to an interior of the cavity 110C when the door 220 is coupled to the lid 113, 113′, 113″. As may be realized, the lid 113, 113′, 113″ may include fluid passages 276B, 276D (each including suitable one way valves) that couple with a respective one of the fluid lines 276A, 276C through couplings 276P. One fluid line 276A may be coupled to a fluid/refrigerant source (which may be similar to refrigerant supply (e.g. replenishment system) 1300 described below with respect to FIG. 13 or any suitable purge gas source) while the other line 276C may be coupled to a vacuum source. Here any suitable fluid and/or refrigerant may be introduced from the fluid source through one line/passage pair 276A, 276B into the cavity 110C while fluid and/or refrigerant is removed from the cavity by the vacuum source with the other line/passage pair 276C, 276D. In another aspect the purge lines 276A′, 276C′ may pass through or be incorporated into the load port frame LPF such that gas and/or refrigerant may be introduced from a gas/refrigerant source into the space SP between interfaces IF1-IF4 by line 276A′ while fluid and/or refrigerant is removed by a vacuum source from the space SP through line 276C′. As may be realized, referring also to FIG. 2D, the purge lines 276A′, 276C′ may also be employed to purge cavity 110C. For example, the door 220, which is coupled to the lid 113, 113′, 113″, may move in the direction of arrow 262 so that the seal between the lid 113, 113′, 113″ and the housing 110, 110′, 110″, 110CH is broken allowing purge gases (e.g. fluids) to flow through a passage formed between the lid 113, 113′, 113″ and the housing 110, 110′, 110″, 110CH. Here the space SP may be purged and then the cavity 110C may be purged through a removal or partial removal of the lid 113, 113′, 113″ from the housing 110, 110′, 110″, 110CH. In other aspects the door 220 may be configured to move the lid 113, 113′, 113″ in the direction of arrow 262 for purging the interior of the cavity 110C while maintaining a seal at interface IF1. For example, the door may include a drive unit coupled to the gripping features 266A, 266B for moving the gripping features 266A, 266B and lid 113, 113′, 113″ relative to the door 220. In other aspects lid 113, 113′, 113″ may be moved relative to the door in any suitable manner for purging the cavity 110C while maintaining a seal at the interface IF1.

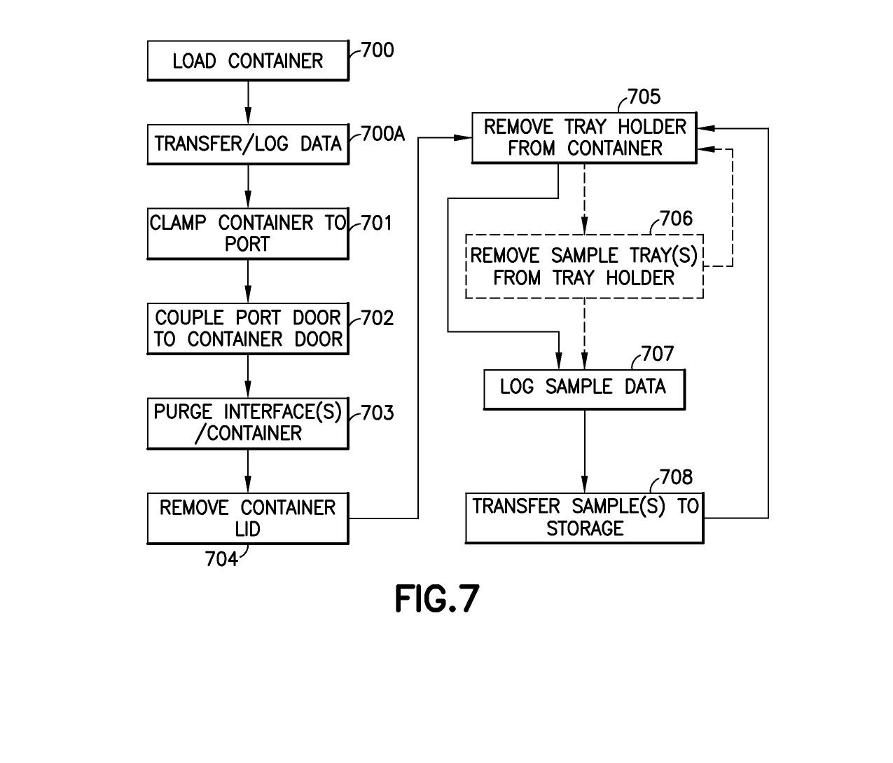

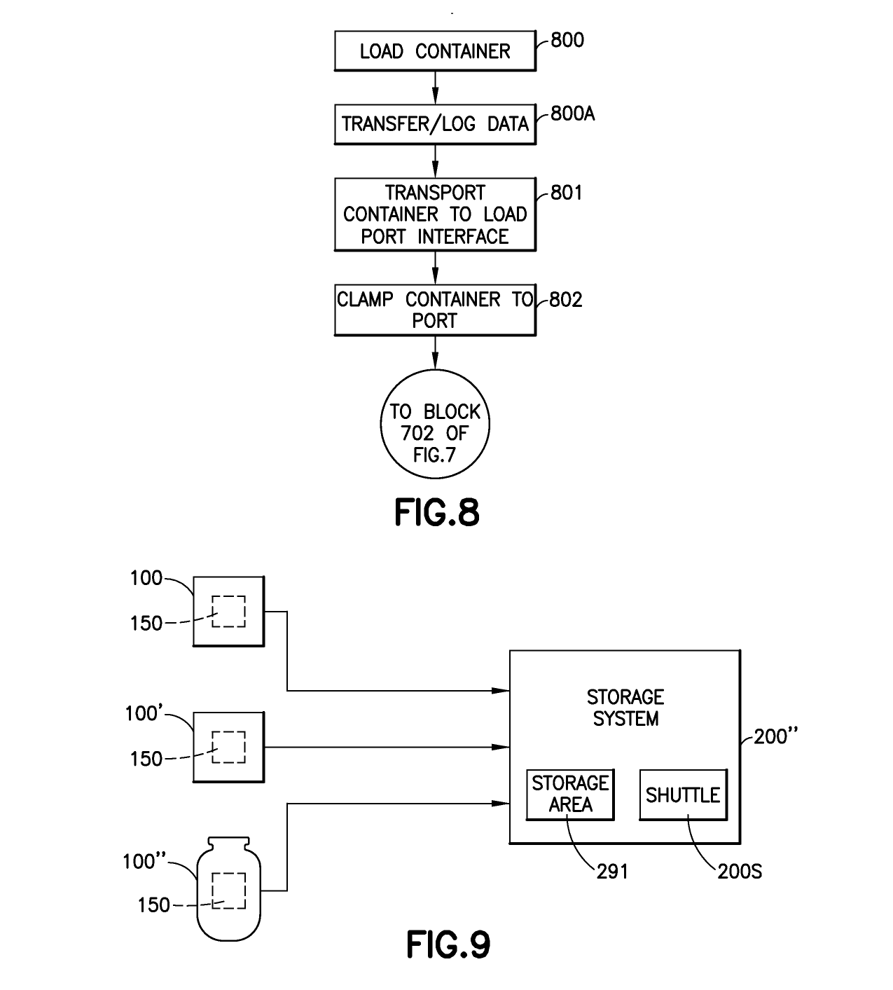

Referring now to FIGS. 3A, 3B and 4A-4D, an exemplary loading of portable cryogenic workstation 100′ to loading unit 201 and a transfer of samples from the portable cryogenic workstation 100′ to the storage unit 291 will be described. The portable cryogenic workstation 100′ is placed in an interface area 300 of the loading unit 201 for interfacing the portable cryogenic workstation 100′ with the transfer unit 291 which in this example is integral with the loading unit 201. In one aspect, as noted above, the housing 110′ includes interface/locating features 112′ which may have the form of rails and/or slots configured to mate with corresponding rails and slots 212′ of the loading unit 201. In this aspect the interface/locating features 112′, 212′ are configured such that the portable cryogenic workstation 100′ is loaded or otherwise placed on the loading unit 201 by moving the housing 110′ in the direction of arrow X, so that the features 112′, 212′ engage each other for locating and/or retaining the portable cryogenic workstation 100′ relative to the closable/sealable opening 207A of the loading unit 201 (FIG. 7, Block 700). In other aspects any suitable locating and/or retaining features may be included on the housing 110′ and/or loading unit 201 for holding and locating the portable cryogenic workstation 100′ relative to the opening 207. As noted above, any suitable information retained in a memory 169ML and/or sensor of the portable cryogenic workstation may be transferred to and logged (FIG. 7, Block 700A) by the loading unit (or vice versa).

The housing 110′ may be clamped to the loading unit 201 in any suitable manner such that a seal is formed at interface IF3 between the loading unit 201 and housing 110′ as described above (FIG. 7, Block 701). The clamping of the housing 110′ to the loading unit 201 may be performed in any suitable manner such as by, for example, any suitable clamping features 216, which in one aspect may be similar to the latch keys described above. The clamping features may be mechanical clamping features, pneumatic clamping features, magnetic clamping features and/or any other suitable clamping features. As may be realized once the seal between the loading unit 201 and housing 110′ is formed and the lid 113′ is removed the housing 110′ (e.g. the cavity within the housing) may form part of the loading unit 201.

As noted above, the opening 207A of the loading unit 201 may be sealed by a door 220. In one aspect the interface IF1 between the door 220 and the loading unit frame LPF may be a tapered interface substantially similar to the interface IF4 between the lid 113′ and the housing 110′. In other aspects the interface IF1 may have any suitable configuration such as that described above. The door 220 may interface with and clamp (or otherwise couple) to the lid 113′ (FIG. 7, Block 702) in any suitable manner (such as described herein) when the housing 110′ is clamped to the loading unit 201. The space SP (FIG. 2A) and/or cavity 110C of the portable cryogenic workstation 100′ may be purged (FIG. 7, Block 703) as described above with, for example, any suitable gas such as nitrogen or any other inert gas so that, e.g., moisture and any other contaminates may be removed from the space SP and/or cavity 110C. For example, as noted above, the door 220 and the lid 113′ may be configured such that the door 220 can remove the lid 113′ from the housing 110′ for purging the cavity of the housing substantially while maintaining a seal between the door 220 and the opening 207A. In other aspects, as also noted above, the lid 113′ and the door 220 may include pneumatic couplings 276P such that when the lid 113′ is coupled to the door 220 the pneumatic couplings are connected for allowing the purging of the cavity without removing the lid 113′ from the housing 110′. In still other aspects a seal may be formed between the lid 113′ and the door 220 so that any areas of the interface between the portable cryogenic workstation 100′ and the loading unit 201 that are not purged are sealed from the internal environment of the cold storage unit 291 and/or the sample handling area of the transfer unit 290.

The door 220 (which is clamped to the lid 113′) may be driven in, for example, the direction of arrow Y by any suitable door drive 230 (which may be a component or module of the transport unit 290T described above) for removing the lid 113′ from the housing 110′ (FIG. 7, Block 704). As noted above, a cartridge 120 or holder TH holding the samples 150 may be coupled to the lid 113′ so that as the lid 113′ is removed from the housing 110′ the cartridge 120 or holder TH (as well as the samples held thereby) is removed from the cavity 110C of the housing 110′ (FIG. 7, Block 705, see also FIG. 2F which illustrates at least two trays 150T in a holder TH that is coupled to the lid 113″). In this aspect the door 220, the lid 113′ and the cartridge 120 or holder TH are removed from a respective one of the opening 207A, housing 110′ and cavity 110C in one motion along a single axis. In one aspect the door drive 230 may move in increments (e.g. the door drive may include suitable encoders and/or sensors configured to sense the location of the shelves 121 for positioning the cartridge 120 or holder TH) to align one or more trays 150T of samples 150 with a tray removal device 330 (which may be a component or module of the transport unit 290T) that is configured to remove one or more trays 150T from the cartridge 120 or holder TH. Optionally, as each tray is aligned at a predetermined position within the enclosure, the tray removal device 330 may remove one or more trays 150T from the cartridge 120 or holder TH in the sideways direction of arrow X1 (FIG. 7, Block 706). It is noted that the cartridge 120 or tray holder TH may provide a suitable effector or gripper automation interface for handling the cartridge 120 or tray holder TH throughout the storage system. The tray 150T may be moved by the tray removal device 330 to position the samples 150 so that the samples 150 may be scanned for any suitable analysis or identification such as a dmx reading so that any information obtained may be logged into a memory of the storage system which may allow for automated retrieval of the samples 150 (FIG. 7, Block 707). For example, a camera 310 or other optical scanner may be positioned within or adjacent the sample handling area of the transfer unit 291 such that the camera 310 is able to view the samples 150. In one aspect the samples 150 may be transferred to a high density tray (not shown) and transferred with the transfer unit 290T into the cold storage unit 291 while in other aspects the tray 150T may be moved by the transport unit 290T into the cold storage unit 291 (FIG. 7, Block 708). Transfer of samples from the cold storage unit to the portable cryogenic workstation 100′ may occur in a manner substantially opposite to that described above. As may be realized, before or after a previously removed tray 150T is moved to storage the door drive 230 may further index (e.g. any suitable number of times) the cartridge 120 (FIG. 7, Block 704) for removal of the remaining trays 150T carrying samples 150 (FIG. 7, Block 706) in a manner substantially similar to that described above. Referring also to FIGS. 4E and 4F the transfer of samples 150 as described above with respect to FIGS. 3A, 2B and 4A-4D is illustrated for a portable cryogenic workstation having a lid 113″ and housing 110 that interface with the automated sample storage system with kinematic pins as described above with respect to, for exemplary purposes only, FIGS. 1L, 1M, 2E and 2F.

Referring now to FIGS. 5A, 5B and 6A-6C an exemplary loading of portable cryogenic workstation 100 to loading unit 201 and a transfer of samples from the portable cryogenic workstation 100 to the storage unit 291 will be described. In this aspect the loading unit 201′ (illustrated in FIGS. 5A and 5B without housing 201H) includes a container shuttle 201T. The container shuttle 201T includes a platform 201TP that is movable in the direction of arrow 500. As noted above, the platform 201TP may include any suitable alignment features 212, 212″ that mate with corresponding alignment features 112, 112″, 112′″ of the portable cryogenic workstation 100. In this aspect the alignment features 112, 112″, 112′″, 212, 212″ may be located at or adjacent to a bottom and/or on a side of the housing 110 but in other aspect the platform 201TP may be configured to hold or otherwise support the housing 110 in any suitable manner such that the alignment features 112, 112″, 112′″, 212, 212″ may be positioned at any suitable location on the housing 110 and/or platform 201TP. In this aspect, the loading unit housing 201H may include a movable door 600 which when opened allows operator access to the shuttle platform 201TP when the platform is in a loading position. An operator may open the door 600 and place the portable cryogenic workstation 100 on the shuttle platform 201TP so that the alignment features 112, 112″, 112″, 212, 212″ reciprocally engage one another for loading the portable cryogenic workstation in the loading unit 201′ (FIG. 8, Block 800). As noted above, any suitable information retained in a memory 169ML and/or sensor of the portable cryogenic workstation may be transferred to and logged (FIG. 8, Block 800A) by the loading unit (or vice versa). For example, the portable cryogenic workstation 100 may have any suitable sensors, as noted above, which may be in communication with the loading unit 201′. The sensors, such as sensor 169H may indicate to the loading unit 201′ that the handle 190 is in a lowered position. The loading unit 201′ may also include any suitable sensors 610 that may indicate that the door 600 is closed and/or that the portable cryogenic workstation 100 is aligned and seated on the shuttle platform 201TP. When predetermined criteria are satisfied (e.g. such as the door 600 being closed and the portable cryogenic workstation being properly seated on the shuttle platform) any suitable indicator 650 (such as, for example, an LED may be illuminated or a tone may be sounded) may be presented to the operator to indicate the loading unit 201′ is ready for operation (it is noted that loading unit 201 may be similarly configured with any suitable sensors indicating proper alignment of the portable cryogenic workstation 100′). The loading unit may include suitable lockouts that may prevent movement of the container shuttle 201T from and to the loading position until the predetermined criteria are met.

The container shuttle 201T (which is driven by any suitable drive mechanism) may move the portable cryogenic workstation 100 in the direction of arrow 500 to the closeable input/output port sealed interface 207 (FIG. 8, Block 801). The container shuttle 201T may be configured to apply clamping force to the housing 110 for forming a seal at interface IF3 (FIG. 8, Block 802). The removal of the lid 113 (e.g. before the seal at interface IF3 is formed or after the seal at interface IF3 is formed as described above) and the transport of the samples into the cold storage unit 290 may be substantially similar to that described above with respect to FIG. 7 and portable cryogenic workstation 100′.

As may be realized, the engagement between the portable cryogenic workstation 100″ and loading unit 201 and a transfer of samples from the portable cryogenic workstation 100″ to the storage unit 291 may be performed in a manner substantially similar to that described above with respect to portable cryogenic workstation 100′. However, the lid 113 may be removed in a manner substantially similar to that described above with respect to portable cryogenic workstation 100 using gripping features 114. In other aspects the lid for portable cryogenic workstation 100″ may be provided with gripping features 114′ such that the lid is removed in the manner described above with respect to portable cryogenic workstation 100′.

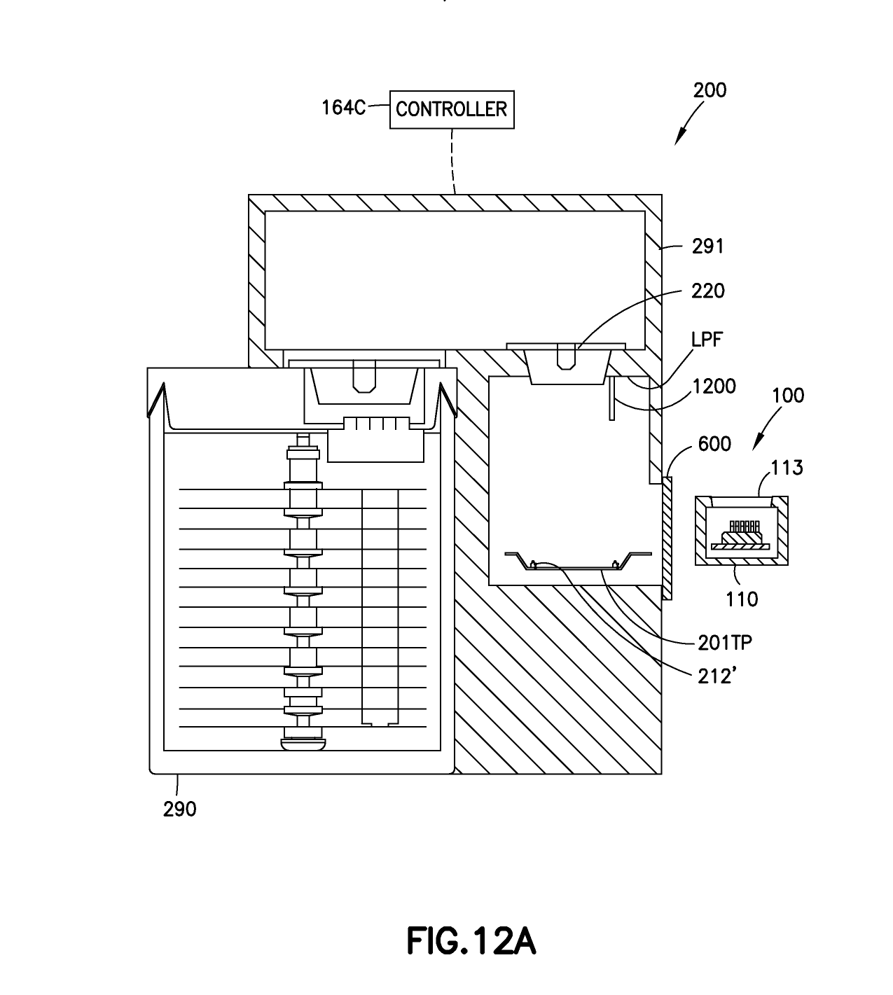

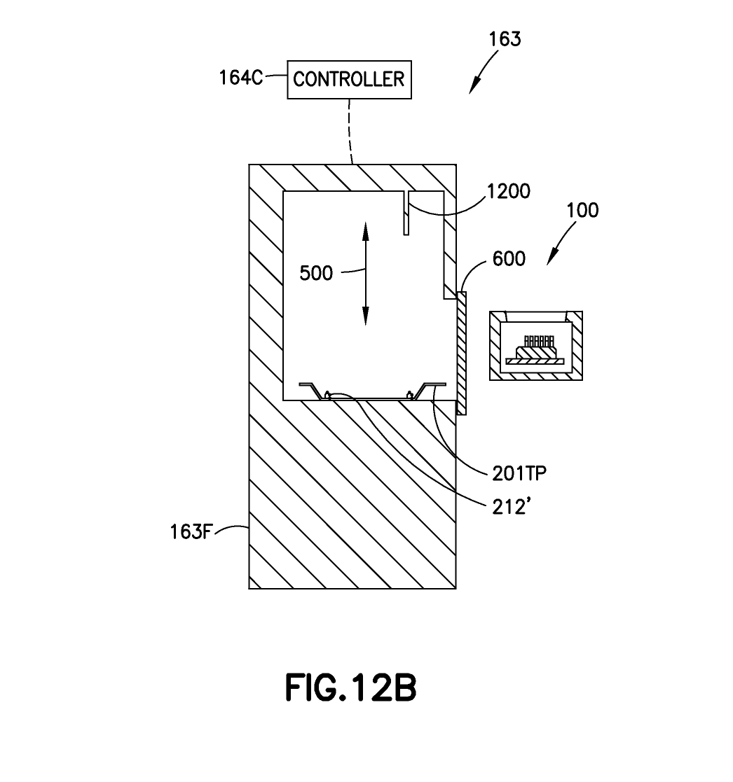

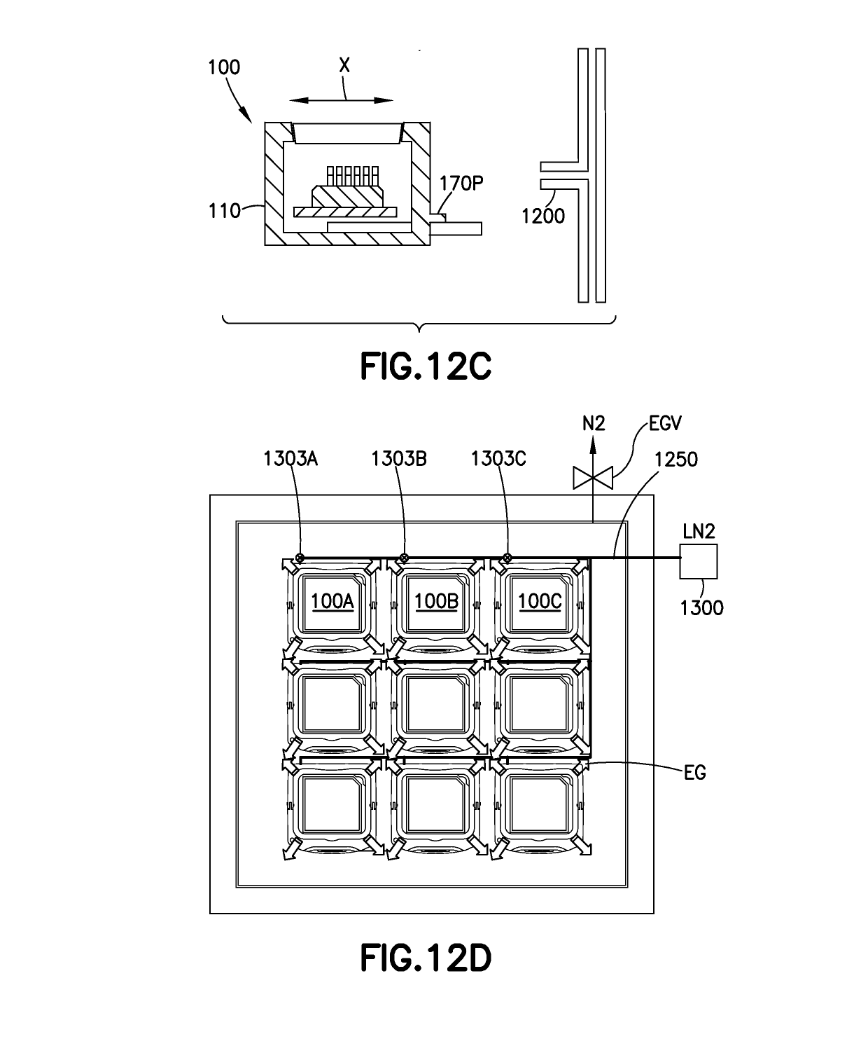

As described herein, the refrigerant within the portable cryogenic workstation 100, 100′, 100″, 100′″ may be refilled manually (e.g. by pouring or otherwise inserting the refrigerant into the portable cryogenic workstation) or autonomously through the automated sample storage system 200, 200′ or the refrigerant charging/replenishment station 163. Referring now to FIG. 12A the automated sample storage system 200 may include a refrigerant fill port or replenishing member 1200 such as a nozzle or other fluid passage that may be configured to engage an aperture on the portable cryogenic workstation 100, 100′, 100″, 100′″ and communicate with the consumable media accumulator within the portable cryogenic workstation. For example, the refrigerant replenishment member(s) 1200 may interface with aperture RA in the lid 113 (e.g. when the loading unit platform 201TP transports the portable cryogenic workstation for engagement with the load port frame LPF) for providing refrigerant to, e.g., the refrigerant source within the portable cryogenic workstation as described above. In other aspects the door 113 may include a fluid coupling system substantially similar to fluid passages 276B, 276D that couple with refrigerant replenishment member(s) (which may be similar to fluid lines 276A, 276C described above). As may be realized, where the aperture RA is located on the lid 113, the refrigerant replenishment member(s) 1200 may be disposed on the load port door 220 so as to remain engaged with the lid 113 as the lid is removed from the housing 110. It is noted that the transfer of refrigerant into the portable cryogenic workstation 100 may occur with the lid 113 attached to the housing 110 (e.g. where a vacuum source or vent disposed in the lid 113 or housing 110 provides a release of gas from the cavity 110C) and/or with the lid 113 separated from the housing 110. As may be realized, the refrigerant replenishment member(s) 1200 may be positioned relative to the kinematic locating features 212′ of the loading unit platform 201TP so as to substantially align the refrigerant exiting the refrigerant replenishment member(s) 1200 with, for example, the channel 1010 (FIG. 10B) of the housing 110 (positioned on the loading unit platform 201TP by the kinematic locating features 212′) or any other suitable location within the housing 110.

Referring also to FIG. 12B the refrigerant charging/replenishment station 163 is illustrated and may be substantially similar to the automated sample storage system 200, 200′. For example, the refrigerant charging/replenishment station 163 may include a frame 163F forming a chamber in which the loading unit platform 201TP is located. The chamber may include a loading aperture that is sealed by the door 600 which when opened allows transfer of one or more portable cryogenic workstations 100 into the chamber (either manually or through automated transport). Relative movement between each of the one or more portable cryogenic workstations 100 and one or more refrigerant replenishment members 1200 (e.g. the portable cryogenic workstations may be transferred in the direction of arrow 500 individually or as unit to engage a respective refrigerant replenishment member 1200 or vice versa or both the refrigerant replenishment member 1200 and portable cryogenic workstation may be moved towards each other) may cause engagement of the refrigerant replenishment member 1200 with a respective portable cryogenic workstation 100. The portable cryogenic workstation 100 and refrigerant replenishment members 1200 may be brought together via movement of one or more of the devices by an operator or via automation. For instance, in some embodiments the insertion of a workstation into a refrigerant charging/replenishment station 163 by a user simultaneously connects the workstation with the refrigerant replenishment member. In another aspect, referring to FIG. 12C, the portable cryogenic workstation(s) 100 may be moved in the direction of arrow X (in addition to or in lieu of movement in the direction of arrow 500) within the automated sample storage system 200, 200′ and/or station 163 so that the refrigerant replenishment member(s) 1200 engages (in any suitable manner) the sealable coupling or port 170P located on a side of the housing 110. In some embodiments and referring to FIG. 9F, a refrigerant charging/replenishment station may be a component of sample storage system 200″. For example, a refrigerant charging/replenishment station may be located within sample storage system 200″ for charging workstations carried by transport shuttle 200S or any other suitable transport unit. In some embodiments, a charging/replenishment station may form a portion of an input/output module or buffer module for sample storage system 200″ whereby portable cryogenic workstations are loaded into, removed from, and queued within sample storage system 200″.

Referring also to FIG. 12D, in one aspect the automated sample storage system 200, 200′ and/or station 163 may include a manifold of refrigerant replenishment members 1200. Here the refrigerant charging/replenishment station 163 is illustrated as having a chamber that holds an N×N array (a 3×3 array is illustrated for exemplary purposes) of portable cryogenic workstations 100. As may be realized, each N×N array may also be located in different planes (e.g. one above the other) to form a three dimensional array of portable cryogenic workstations 100. Each portable cryogenic workstation 100 may be coupled to a respective refrigerant replenishment member 1200 of the manifold 1250 in a manner substantially similar to that described above for replenishing and/or maintaining (e.g. controlled rate freezing) the refrigerant within the portable cryogenic workstations 100. In one aspect a substantially equal amount of refrigerant may be transferred to each of the portable cryogenic workstations substantially simultaneously while in other aspects, in a manner similar to that described below, one or more control valves 1303 may be provided in the manifold 1250 for controlling an amount/rate of refrigerant transferred to a respective portable cryogenic workstation 100.

As noted above, the controller 164 may be communicably coupled to the refrigerant supply 1300 for controlling a flow of refrigerant REF into one or more portable cryogenic workstations 100, 100′, 100″, 100′″ (workstation 100 is illustrated for exemplary purposes only). In one aspect the controller 164 may be in communication with a central controller 164C for controlling the flow of refrigerant REF into the one or more portable cryogenic workstations. In one aspect the refrigerant supply 1300 may include a fluid reservoir 1300R, a control valve 1303, a refrigerant level detector/sensor and a refrigerant source valve 1302. A thermocouple 1301 or other suitable sensor may be connected to the refrigerant replenishment member 1200 and be configured to monitor for the presence of liquid refrigerant at a spout of the refrigerant replenishment member 1200 after, for example, any refrigerant gases are exhausted from the refrigerant replenishment member 1200 (where the refrigerant gases are caused by, e.g., the boiling of the refrigerant within the refrigerant replenishment member 1200 before the refrigerant replenishment member 1200 cools to a temperature of the liquid refrigerant).

As described above, whether the cryogenic workstations 100, 100′, 100″, 100′″ are replenished individually or together, such as through a manifold, the portable cryogenic workstations 100, 100′, 100″, 100′″ are prone to attracting condensation and frost. Within a single cryogenic workstation replenishment station or a multiple cryogenic workstation replenishment station, such as those described above, in one aspect exhaust gas EG, such as nitrogen N2 (FIG. 12D), from the cryogenic workstation(s) 100, 100′, 100″, 100′″ dries an atmosphere around the cryogenic workstation(s) 100, 100′, 100″, 100′″ to substantially prevent condensation and frost from forming. Here the exhaust of the exhaust gas EG is controlled in any suitable manner such as with any suitable valves EGV for releasing the exhaust gas from the replenishment station enclosure. In other aspects the dryness (or dew point) of the atmosphere around the cryogenic workstation(s) 100, 100′, 100″, 100′″ is controlled in any suitable manner such as by heaters or by adding supplemental refrigerant gas (in addition to that exhausted from the cryogenic workstation(s)) to the atmosphere.

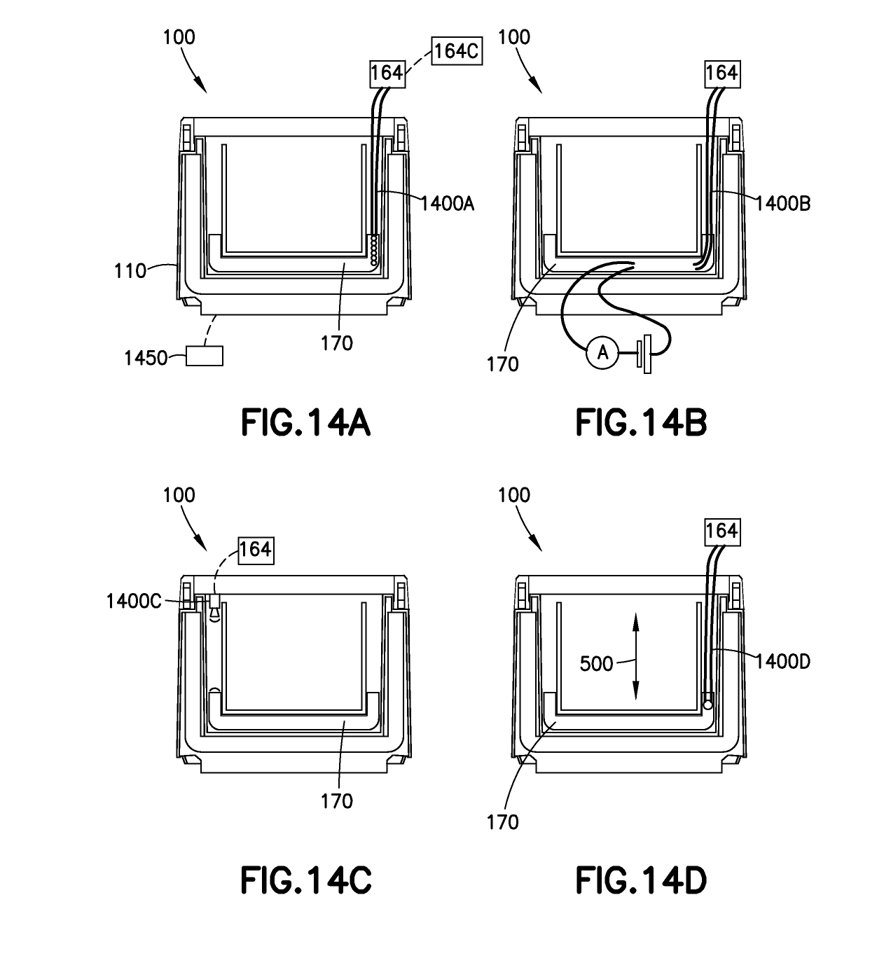

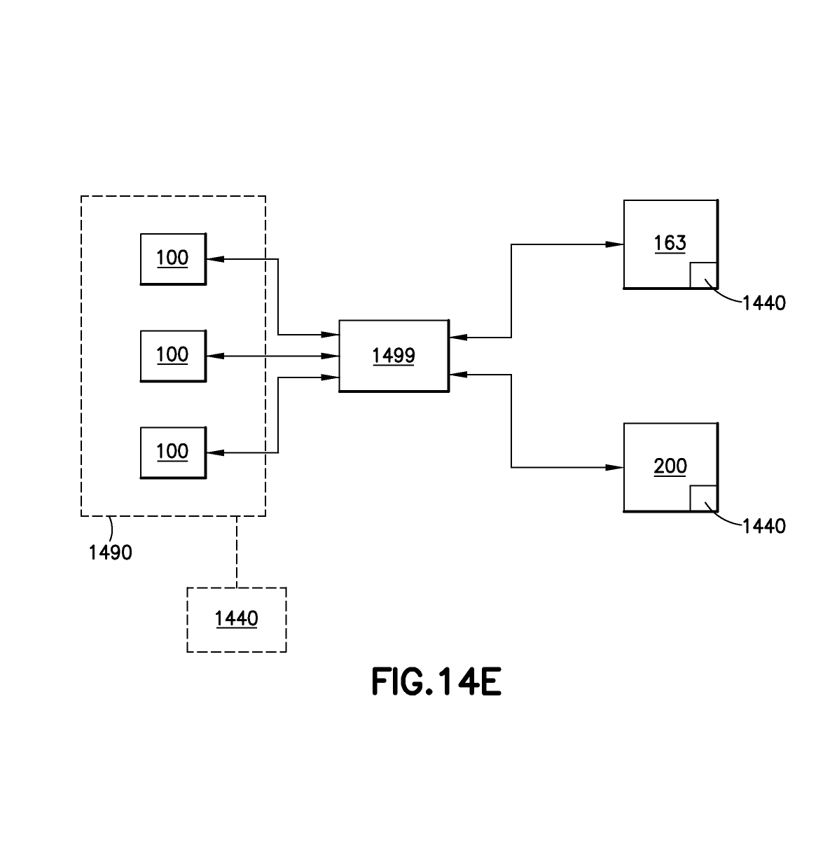

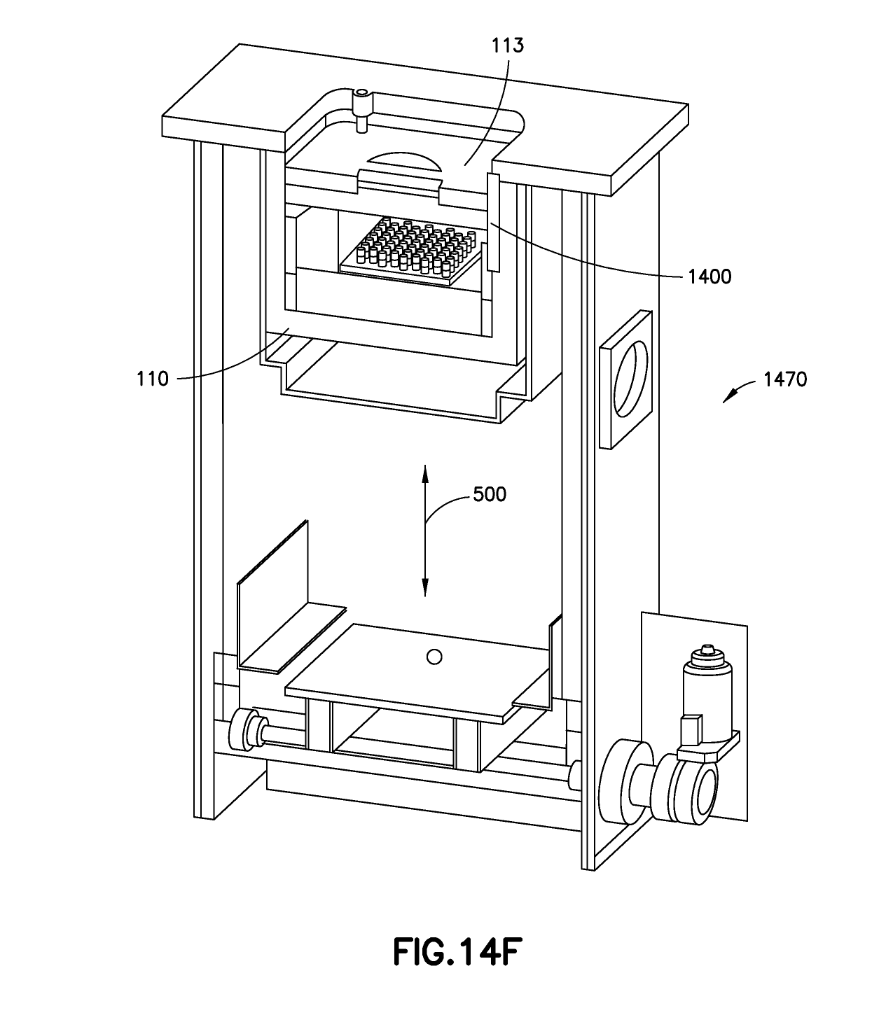

Referring also to FIGS. 14A-14D the portable cryogenic workstations 100, 100′, 100″, 100′″ and/or the automated sample storage system 200, 200′ and/or station 163 may also include any suitable refrigerant level sensor/detector 1400A, 1400B, 1400C, 1400D that may be in communication with, for example, controller 164 (or any other suitable controller such as central controller 164C) to effect an automated supplying of refrigerant to the portable cryogenic workstations 100, 100′, 100″, 100′″. In one aspect the sensor 1400A may be one or more thermocouples or temperature sensors 1400A (substantially similar to temperature sensor 169 described above) that are disposed substantially within or adjacent to the refrigerant source (such as the absorbent pad 170 or refrigeration unit 170′) and configured to measure temperature at one or more measurement heights or vertically stacked measurement levels of the refrigerant source. In one aspect the sensor 1400A may be a series of stacked thermocouples where each thermocouple in the stack corresponds to a respective one of the vertically stacked measurement levels. In another aspect the sensor 1400B may be a capacitive sensor configured to measure an amount of refrigerant based on the capacitance of the refrigerant source. In still other aspects the sensor 1400C may be an ultrasonic sensor configured to read a level of liquid refrigerant within the refrigerant source (e.g. such as through an aperture provided in the refrigerant source). In yet another aspect the sensor 1400D may be a float type sensor where the float moves in the direction of arrow 500 in accordance with a level of liquid refrigerant within the refrigerant source (a channel in which the float moves and suitable sensors for detecting a position of the float may be provided). In still other aspects, a location in which the portable cryogenic workstation is located may be provided with any suitable scale 1440 (see FIG. 14E) where a level of refrigerant is determined based on a weight of the portable cryogenic workstation 100, 100′, 100″, 100′″. As may be realized the sensors 1400A-1400D may be disposed within the portable cryogenic workstations 100, 100′, 100″, 100′″ while in other aspects the sensors 1400A-1400D may be part of a loading unit 1470 substantially similar to the sample storage workstations 200, 201′ and/or refrigerant charging/replenishment station 163 described herein so as to extend into the housing for sensing or otherwise detecting the refrigerant level. As may be realized as the portable cryogenic workstation 100, 100′, 100″, 100′″ is transferred in direction 500 within the automated sample storage system 200, 200′ to engage, for example, the seals of the load port frame LPF (FIG. 2A) or transferred in direction 500 within the station 163 for replenishment of refrigerant the sensor 1400 (similar to one or more of sensors 1400A-1400D), which may be in the form of a probe, may be inserted through an aperture in the housing 110 or lid 113 (and at least partly into e.g. channel 1010 or any other suitable channel or passage allowing contact with a refrigerant holding area of the housing 110) to detect the refrigerant level within the housing 110.

In one aspect, the refrigerant level sensors 1400A-1400D may be communicably coupled to the controller 164 in any suitable manner such as wirelessly or through a wired connection. It is also noted that controller 164 may be communicably connected to the central controller 164C through a wired or wireless connection. Where the connection between the controller 164 and the central controller 164C is a wired connection, the housing 110 may include a coupling or connector 1450 that interfaces with a corresponding coupling or connector of the automated sample storage system 200, 200′ or the refrigerant charging/replenishment station 163 for providing communication between the controller 164 and central controller 164C.

As may be realized, the refrigerant level sensors 1400A-1400D may provide remote monitoring of the refrigerant levels in each portable cryogenic workstation 100, 100′, 100″, 100′″. For example, the sensor may detect or otherwise sense a low refrigerant level and provide a suitable signal to the controller 164. In one aspect the controller 164 may provide a visual or aural indication (e.g. through the display 169D or a speaker integral with the portable cryogenic workstation) to an operator that the portable cryogenic workstation 100, 100′, 100″, 100′″ is in need of refrigerant replenishing so that the operator may effect transport of the portable cryogenic workstation 100, 100′, 100″, 100′″ to a suitable refrigerant replenishment station (e.g. automated storage system 200, 200′ or station 163). In other aspects the controller 164 may communicate with, for example, central controller 164C and indicate a low refrigerant level. Referring also to FIG. 14E, the central controller 164C may provide control instructions to any suitable automated transport 1499 (e.g. overhead gantry systems, automated transport vehicles, a transport system of the automated sample storage system 200, 200′ or any other suitable automated transport) to transport the portable cryogenic workstation to a refrigerant replenishment station of the automated sample storage system 200, 200′ or the refrigerant charging/replenishment station 163. For example, the portable cryogenic workstations 100 may be stored or otherwise queued in any suitable buffer or stocker 1490. A low refrigerant signal may be sent to controller 164 by sensor 1400A-1400D which may effect a control signal being sent to transport 1499. The transport 1499 may remove the portable cryogenic workstation 100 from the buffer 1490 and transport the portable cryogenic workstation 100 to refrigerant charging/replenishment station 163 or automated sample storage system 200, 200′ for refrigerant replenishment. In this manner a predetermined level of refrigerant may be maintained within each portable cryogenic workstation 100.

As noted above, the level of refrigerant within each portable cryogenic workstation 100, 100′, 100″, 100′″ may be communicated to central controller 164C (which may be a controller of the automated sample storage system and/or refrigerant charging/replenishment station) and/or controller 164 of the portable cryogenic workstation 100, 100′, 100″, 100′″. One or more of the controller 164 and central controller 164C may be in communication with one or more flow control valves 1303 of the refrigerant supply 1300 and effect an opening and closing of the valve to control the release of refrigerant into one or more portable cryogenic workstation based on a low refrigerant level indication from a respective sensor 1400A-1400B (or scale 1440). For example, an indication of low refrigerant level may be communicated from portable cryogenic workstation 100A such that one or more of controller 164 and central controller 164C effect an opening of flow control valve 1303A (while flow control valves 1303B, 1303C remain closed) to allow a passage of refrigerant RE from the reservoir 1300R into the portable cryogenic workstation 100A. As may be realized when one or more of portable cryogenic workstations 100B, 100C communicate a low refrigerant signal to controller 164 and/or central controller 164C the respective flow control valves 1303b, 1303C may also be opened to allow a flow of refrigerant into one or more of portable cryogenic workstations 100B, 100C.

In one aspect an amount of refrigerant transferred to each portable cryogenic workstation 100A, 100B, 100C may be based on the low refrigerant signal (e.g. the refrigerant capacity of the workstations is known and an amount of refrigerant within the workstations at the time of the low refrigerant signal is known such that the amount of refrigerant transferred is the predetermined difference between the refrigerant capacity and the refrigerant within the workstation). In another aspect, the sensor 1400A-1400D (or scale 1440) may substantially continuously (or at some predetermined time interval) send signals to the controller 164 and/or central controller 164C indicating an amount of fluid in the respective portable cryogenic workstation such that upon reaching a predetermined fluid level the respective flow control valve 1303 is closed to stop the flow of refrigerant into the portable cryogenic workstation. In still other aspects the amount of refrigerant to be transferred to one or more portable cryogenic workstations may be determined in any suitable manner. An amount of refrigerant within the reservoir 1300R may also be monitored in any suitable manner (such as those described above with respect to sensors 1400A-1400D and scale 1440). In one aspect, for exemplary purposes only, a float 1302 and valve 1302 may be provided such that as the refrigerant level within the reservoir 1300R decreases the float 1302 lowers to trigger an opening of valve 1302 which causes a flow of refrigerant REF into the reservoir 1300R. As refrigerant flows into the reservoir 1300R the float rises such that when the refrigerant reaches a predetermined level the float 1302 effects a closing of the valve 1302.

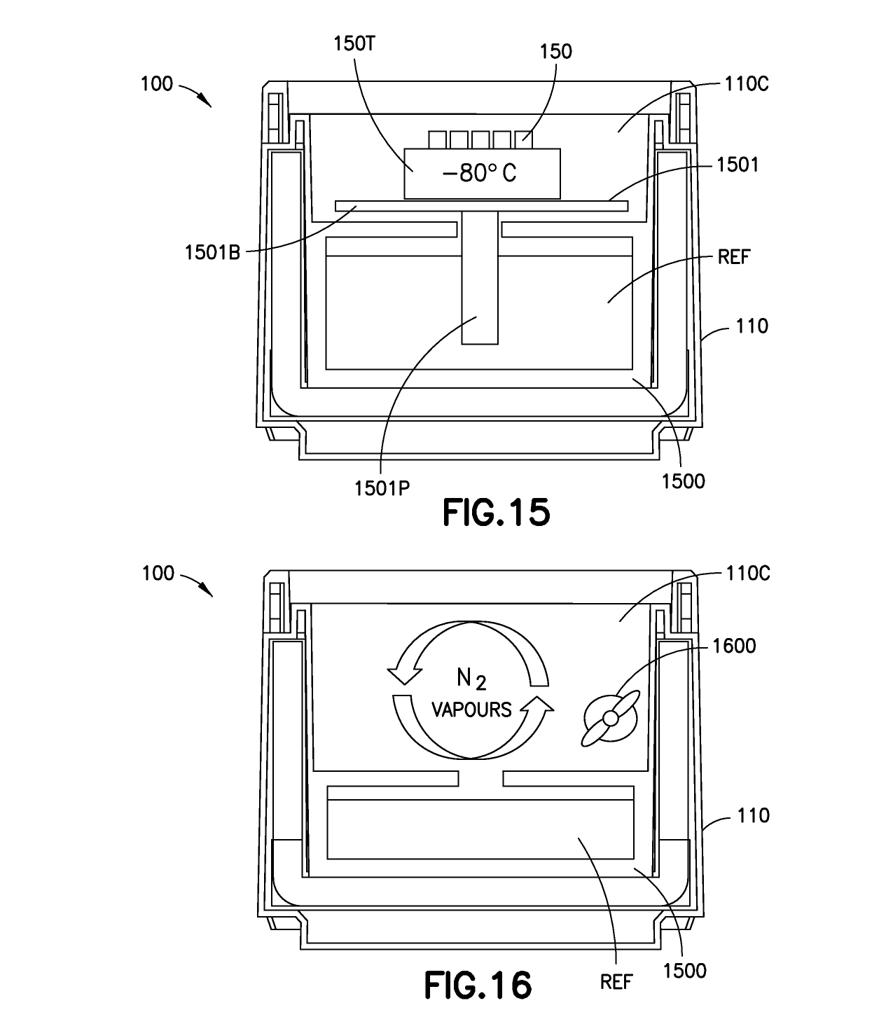

Referring now to FIGS. 15 and 16, in one aspect the portable cryogenic workstations may be configured to maintain the samples 150 at any suitable predetermined temperature such as, for example, about −80° C. or any other suitable temperature above or below about −80° C. In one aspect, the portable cryogenic workstations 100, 100′, 100″, 100′″ (workstation 100 is illustrated for exemplary purpose only) may include an insulated refrigerant tank 1500 (or any other suitable container) for holding a predetermined amount of refrigerant REF. In one aspect the tank 1500 may be refilled or otherwise replenished with refrigerant REF in a manner substantially similar to that described above. Referring to FIG. 15, a pedestal 1501 may be disposed at least partially within the cavity 110C and includes a base portion 1501B and a stanchion portion 1501P that extends into the tank 1500 to contact the refrigerant REF. The stanchion portion 1501P may be shaped and sized so that the base portion and the samples held thereon are maintained at the predetermined temperature, such as about −80° C. (or any other suitable temperature), through for example, at least thermal conduction (e.g. heat transfer through the pedestal 1501). In one aspect the samples may also be cooled by evaporating refrigerated around the samples 150. In one aspect the insulated tank 1500 may be configured to substantially prevent temperature settling within the cavity 110C at, for example, the refrigerant phase change temperature. The base portion 1501B may include tray 150T locating features substantially similar to those described above with respect to tray holder TH. In other aspects the base portion 1501B may be configured to hold a tray 150T in the manner described above. In another aspect, referring to FIG. 16, the portable cryogenic workstation 100, 100′, 100″, 100′″ may also include a fan 1600 within the cavity 110C to circulate the evaporated refrigerant (e.g. refrigerant vapors) for cooling the samples 150 in addition to or in lieu of the conductive cooling provided by the pedestal 1501.

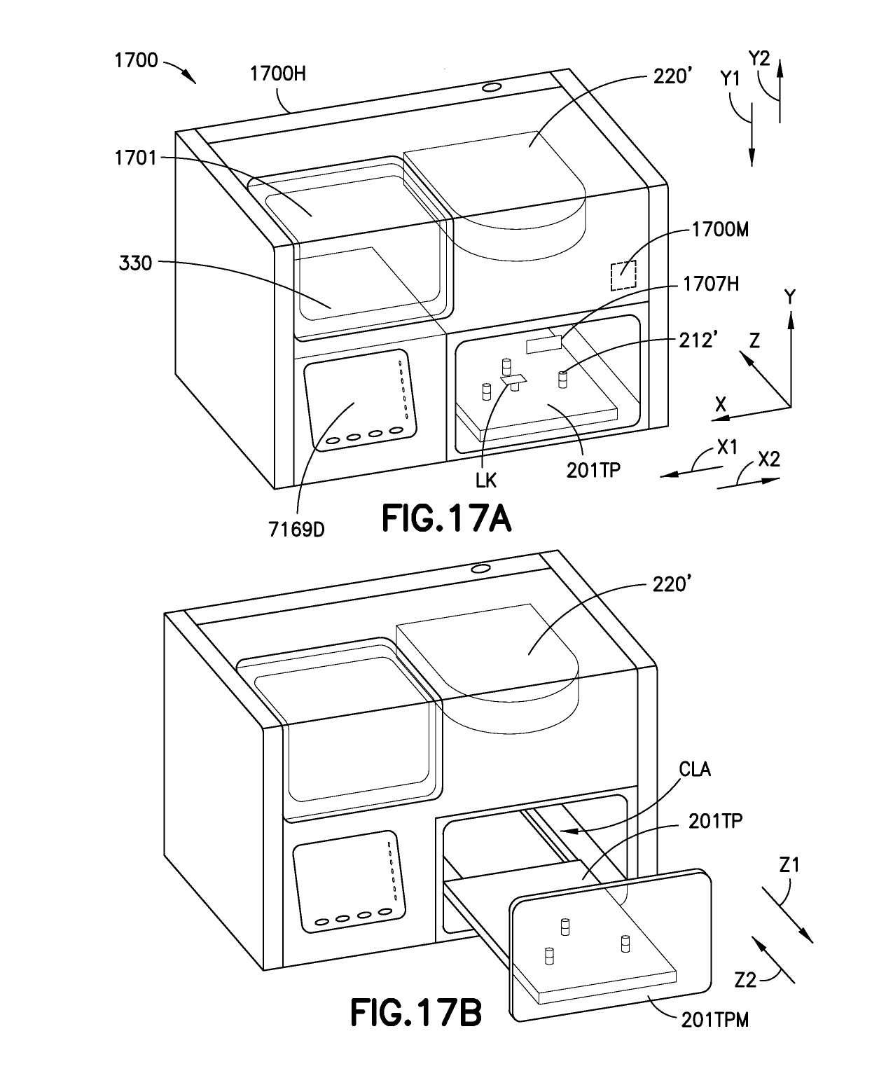

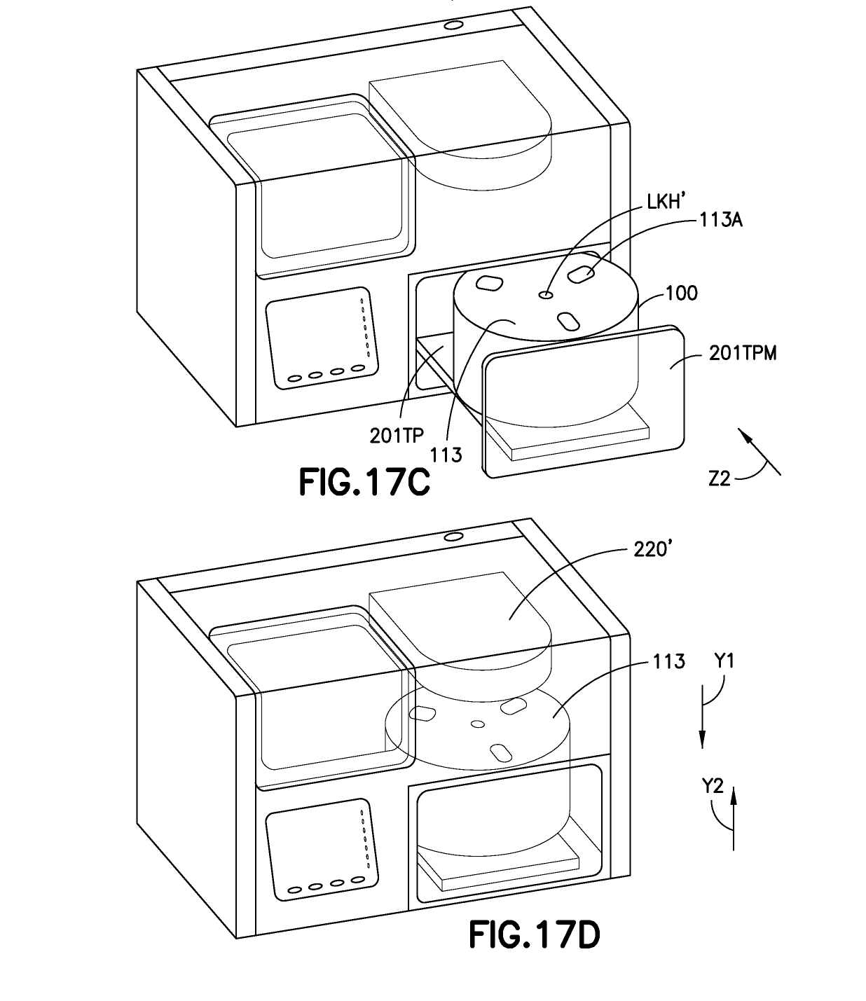

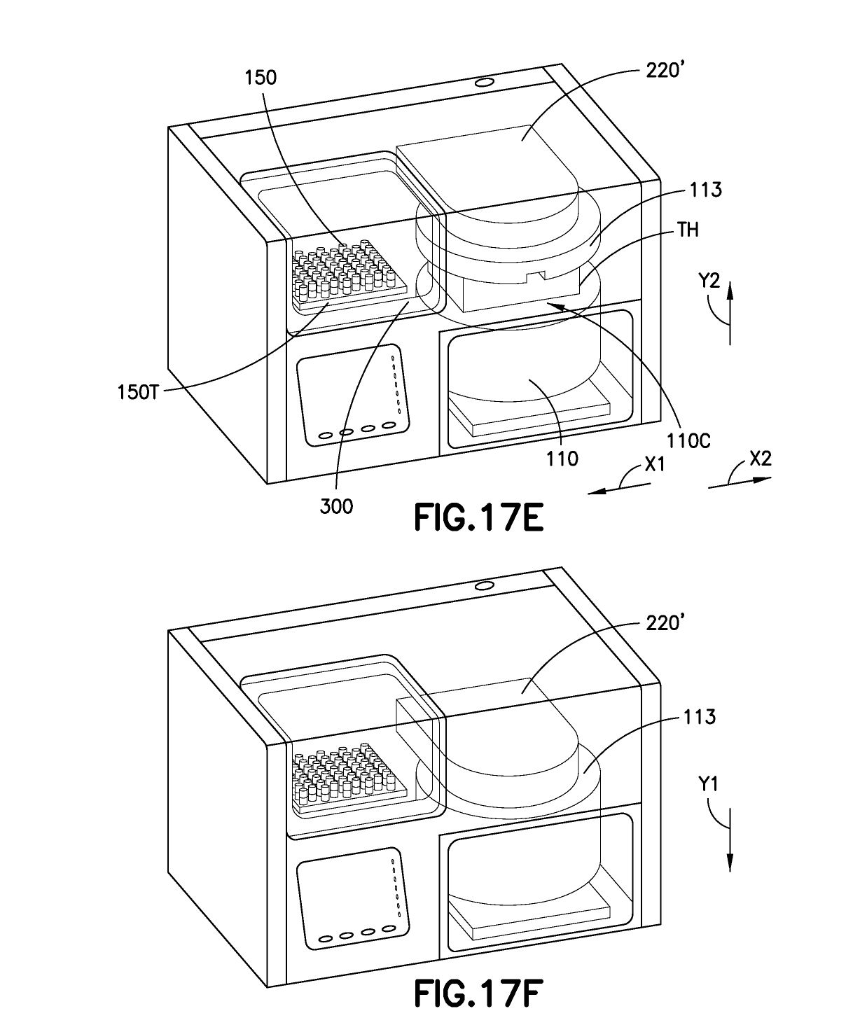

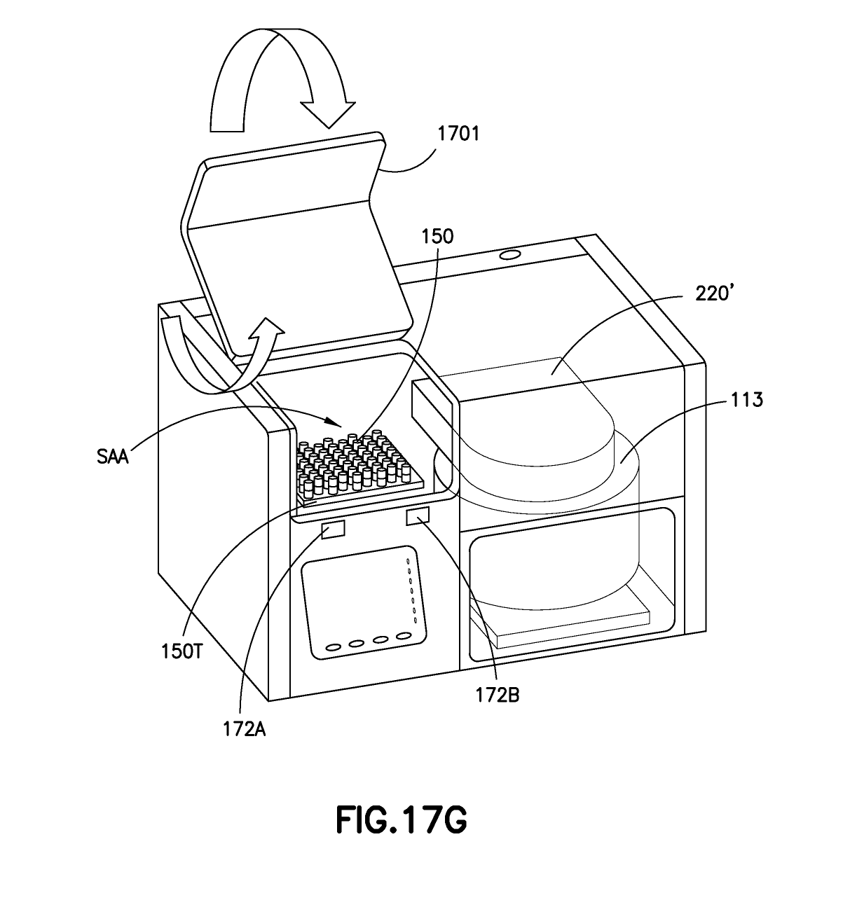

Referring now to FIGS. 17A-17G a sample handling station 1700 for handling the portable cryogenic workstations is illustrated in accordance with aspects of the disclosed embodiment. The sample handling station 1700 may be configured to isolate a human operator from an interior of the portable cryogenic workstation and/or from a transfer operation of the samples to and from the portable cryogenic workstation. In one aspect the sample handling station 1700 may be automated or it may be manually operated as will be described below. Transfer of samples 150 from a portable cryogenic workstation 110, 100′, 100″, 100′″ with the sample handling station 1700 may be substantially similar to the transfer of samples 150 with sample storage systems described above. In one aspect the sample handling station 1700 may be included with or in the sample storage systems such that an automated transfer unit, such as robot arm 933 (FIGS. 9C and 9D) transfers trays 150T from, for example, one or more cold storage units or vaults 291 of the sample storage system or a portable cryogenic workstation 100, 100′, 100″, 100′″ to the sample handling station 1700. In other aspects, the sample handling station 1700 may be a standalone unit that is placed on a laboratory workbench or other working surface.

In accordance with aspects of the disclosed embodiment the sample handling station 1700 may include a frame or housing 1700H forming a chamber therein. The housing may include a container loading aperture CLA that is sealed with a door 201TPM and a sample access aperture SAA that is sealed with a door 1701. A platform 201TP (substantially similar to that described above), a lid removal unit 220′ (substantially similar to the load port door described above) and a tray removal device 330 (substantially similar to that described above) may be disposed at least partly within the chamber formed by the housing 1700H. In one aspect the door 201TPM may be mounted to the platform 201TP so that as the platform is moved in the direction of arrow Z1 the door 201TPM moves with the platform 210TP to open the container loading aperture CLA. In other aspects the door 201TPM may be hinged or connected to the housing 1700H in any suitable manner for opening and sealing the aperture CLA and allowing the platform 201TP to extend through the aperture CLA for loading and unloading portable cryogenic workstation(s) to and from the platform 201TP. In one aspect one or more motors or drives 1700M may be included for opening and closing the door 201TPM and moving the platform 201TP in the manner described herein. In other aspects, any suitable handles 1707H may be provided to allow an operator to open and close the door 201TPM and to move the platform 201TP to insert and remove the portable workstation to and from the sample handling station 1700H.

The platform 201TP may include one or more kinematic interface/locating features 212, 212′, 212″ and a latch key LK (see e.g. FIG. 1A) such as those described above for interfacing with corresponding kinematic features and hold down features of the portable cryogenic workstation 100, 100′, 100″, 100′″ (as described above—see e.g. FIGS. 1L, 1M, 1Q, 2E and 2F). The a lid removal unit 220′ may also include one or more kinematic interface/locating features and latch keys for interfacing with corresponding kinematic locating features 113A and latch key hole LKH′ of the lid 113. It is noted that the kinematic locating features may be disposed on any suitable side(s) of the portable cryogenic workstation for interfacing with corresponding kinematic features of the sample handling station 1700 so that the portable cryogenic workstation is deterministically positioned within the sample handling station 1700. One or more of the lid removal unit 220′ and the platform 201TP are movable in the directions of arrows Y1, Y2 for causing relative movement between the lid removal unit 220′ and the platform 201TP for removing the lid 113 from the portable cryogenic workstation 100, 100′, 100″, 100′″. The tray removal device 330 may be configured for movement in the direction of arrows X1, X2 for extending into, for example, tray holder TH connected to the lid 113 for removing the tray 150T and aligning the tray 150T (and the samples 150 therein) with the sample access aperture SAA. In one aspect the tray removal device 330 may be connected to a cold block or other refrigeration source so that the sample tray 150T and samples 150 therein are cooled by conduction while being held by the tray removal device 330. In other aspects, the sample handling station 1700 may be refrigerated in any suitable manner. In one aspect, the one or more motors 1700M may provide movement of one or more of the lid removal unit 220′, the platform 201TP and tray removal device 330 while in other aspects any number of suitable handles may be provided to allow an operator to move the lid removal unit 220′, the platform 201TP and tray removal device 330 in a manner described herein while the doors 1701, 201TP remain closed.

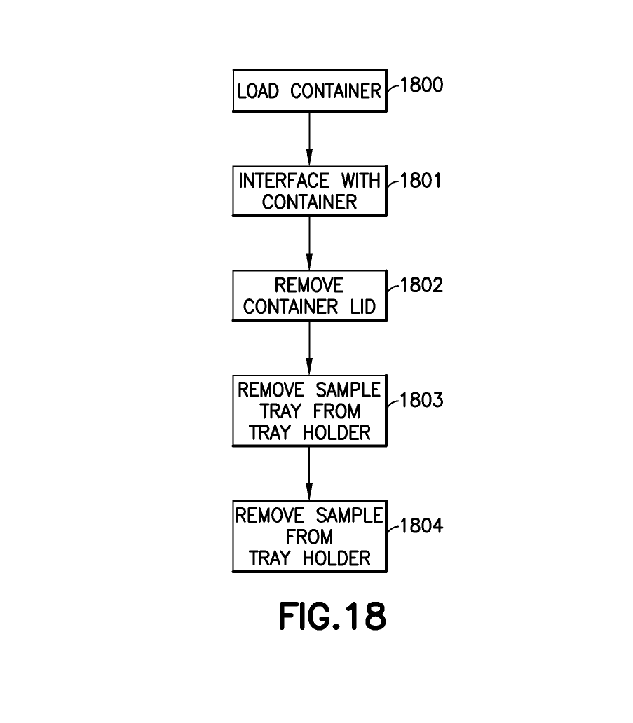

Referring also to FIG. 18, a portable cryogenic workstation 100, 100′, 100″, 100′″ may be loaded into the sample handling station 1700 (FIG. 18, Block 1800). For example, the door 201TPM and platform 201TP may be moved in the direction of arrow Z1 (FIG. 17B) so that the portable cryogenic workstation 100, 100′, 100″, 100′″ may be placed on and located relative to the platform 201TP through the kinematic locating features 212′ (FIG. 17C). In one aspect the portable cryogenic workstation 100, 100′, 100″, 100′″ may also be held down on the platform 201TP with the latch key LK in a manner similar to that described above. The portable cryogenic workstation 100, 100′, 100″, 100′″ may be transported into the housing where the platform 210TP and door 201TPM are moved in the direction of arrow Z2 so that the door 201TPM seals aperture CLA and the portable cryogenic workstation 100, 100′, 100″, 100′″ is located in a predetermined location within the housing relative to, for example, the lid removal unit 220′ and the tray removal device 330.

Relative movement between the lid removal unit 220′ and the platform 201TP towards each other may be provided so that the lid removal unit 220′ interfaces with the lid 113 (in a manner substantially similar to that described above) so that the lid 113 is coupled to the lid removal unit 220′ (FIG. 18, Block 1801). In this aspect the lid removal unit is configured to move in the direction of arrows Y1, Y2 for interfacing with the lid (FIG. 17D) but in other aspects the platform 210TP may be configured to move in the direction of arrows Y1, Y2 for interfacing the lid 113 with the lid removal unit 220′. In still other aspects both the platform 201TP and the lid removal unit 220′ may be movable in the direction of arrows Y1, Y2. The lid 113 may be removed from the portable cryogenic workstation 100, 100′, 100″, 100′″ (FIG. 18, Block 1802) by providing relative movement between the lid removal unit 220′ and the platform 201TP away from each other. As noted above, one or more of the lid removal unit 220′ and platform 201TP may be configured to move in the direction of arrows Y1, Y2 for removing the lid 113 (FIG. 17E). As also noted above, the tray holder TH may be coupled to the lid 113 so that as the lid 113 is moved away from the housing 110 the tray holder is moved out of the chamber 110C for providing access to one or more trays 150T held by the tray holder TH (FIG. 17E). In this aspect, the tray 150T and the samples 150 held therein may be removed from the tray holder TH (FIG. 18, Block 1803) by the tray removal device 330. Here the tray removal device 330 may be configured to move in the direction of arrows X1, X2 (e.g. sideways relative to the portable cryogenic workstation and the tray holder) so that the tray removal device 330 is inserted through a side of the tray holder TH for transferring the tray 150T from the tray holder TH and positioning the tray 150T and the samples 150 therein relative to the sample access aperture SAA (FIG. 174E). In other aspects the tray holder TH may not be coupled to the lid 113 such that the tray removal device 330 may be configured to reach into cavity 110C for removing the tray 150T and/or samples 150 from the cavity. In one aspect the lid 113 may be placed back on the housing 110 prior to opening the door 1701 to assist in preserving the cryogenic temperature within the chamber 110C. One or more samples 150 may be removed from the tray 150T (FIG. 18, Block 1804) by opening the door 1701 (FIG. 17G). Opening the door 1701 provides operator access to the samples (or access to the samples by any suitable automation). In one aspect the sample handling station 1700 may include sample tracking (similar to that described above and may be in communication with the portable cryogenic workstation 100, 100′, 100″, 100′″ so that samples 150 removed from and inserted to the tray 150T can be updated in, for example, the memory 169M of the portable cryogenic workstation 100, 100′, 100″, 100′″. In a manner similar to that described above, sample location sensors 172A, 172B may be provided in the sample handing station 1700 to effect picking predetermined samples 150 from the tray 150T where sample location information is provided to the operator through display 7169D. In other aspects, the display 7169D may also provide the operator with ephemeral information/data pertaining to one or more of the samples 150, sample tray 150T and portable cryogenic workstation in a manner described herein. The sample tray 150T and the samples 150 therein may be returned to the portable cryogenic workstation 100, 100′, 100″, 100′″ and the portable cryogenic workstation 100, 100′, 100″, 100′″ may be removed from the sample handling station 1700 in a manner substantially opposite to that described above.

In accordance with one or more aspects of the disclosed embodiment a portable cryogenic workstation includes

a housing having an internal cavity configured to hold one or more samples,

a lid for sealing the internal cavity such that the portable cryogenic workstation is configured for transporting samples between about room temperature environments to about ultra-cold environments,

at least one automation interface disposed on one or more of the housing and lid and configured for engagement with automated handling equipment,

a process data capture unit coupled to the housing and configured to capture process or ephemeral data corresponding to a predetermined processing characteristic(s) of at least one of the samples coincident with presence inside the portable cryogenic workstation.

In accordance with one or more aspects of the disclosed embodiment the process data capture unit is configured so that the process or ephemeral data captured define process history and enables analysis of the predetermined processing characteristic(s) of at least one of the samples.

In accordance with one or more aspects of the disclosed embodiment the process data capture unit communicably coupled to a controller and at least one sensor connected to the controller where the at least one sensor is configured to provide one or more of sample location data, sample identification data, temperature data and a physical state of the lid relative to the housing.

In accordance with one or more aspects of the disclosed embodiment, the portable cryogenic workstation includes a consumable media level detector.

In accordance with one or more aspects of the disclosed embodiment a portable cryogenic workstation includes

a housing having an opening forming an interior cavity configured to hold one or more racks of cryogenic samples, a workstation interface and a lid interface disposed around a periphery of the opening, and

a lid configured to close the opening and substantially seal the interior cavity, the lid having a housing interface configured to engage the lid interface so that the lid effects sealing of the interior cavity and to disengage the lid interface and unseal the interior cavity with a single axis movement of the lid relative to the housing

wherein the housing is configured to engage a closable input/output port of a workstation.

In accordance with one or more aspects of the disclosed embodiment engagement of the housing with the input/output port effects a seal between the input/output port and the workstation interface so that when the lid is opened the interior cavity is in sealed communication with an interior of the workstation.

In accordance with one or more aspects of the disclosed embodiment, the portable cryogenic workstation includes a consumable media level detector.

In accordance with one or more aspects of the disclosed embodiment the housing is configured to effect the seal between the input/output port and the workstation interface with the lid engaged to the housing.

In accordance with one or more aspects of the disclosed embodiment the housing is configured to effect the seal between the input/output port and the workstation interface with the lid separated from the housing.

In accordance with one or more aspects of the disclosed embodiment the housing is configured to effect the seal between the input/output port and the workstation interface with the lid engaged to the housing and separated from the housing.

In accordance with one or more aspects of the disclosed embodiment the portable cryogenic workstation is configured to record process data related to predetermined characteristics of one or more of the samples, the housing and the lid.

In accordance with one or more aspects of the disclosed embodiment the portable cryogenic workstation is connected to a controller, a memory is connected to the controller and at least one sensor is connected to the controller, the controller being configured to effect a recordation of process tracking data in the memory based on signals from the at least one sensor.

In accordance with one or more aspects of the disclosed embodiment the controller is configured to effect the recordation of process tracking data in response to a triggering event.

In accordance with one or more aspects of the disclosed embodiment the controller is configured to allow analysis of the process tracking data.

In accordance with one or more aspects of the disclosed embodiment the controller, memory and at least one sensor are integral with the one or more of the housing and the lid.

In accordance with one or more aspects of the disclosed embodiment a cryogenic portion of the workstation includes

a storage module having an ultra-cold storage vault configured to store racks of cryogenic samples, and

a loading module disposed external to the storage module and including a load port and a closeable opening, the closeable opening communicably connecting the loading module to the storage module where the cryogenic samples are transferred between the storage module and the loading module through the closeable opening, the load port including a closeable input/output port configured to engage a portable cryogenic workstation where engagement of the load port with the portable cryogenic workstation effects a seal between the load port and the portable cryogenic workstation so that when the load port is opened an interior of the loading module is in sealed communication with an interior of the portable cryogenic workstation.

In accordance with one or more aspects of the disclosed embodiment the cryogenic samples are transferred between the storage module and the loading module through or in the racks.

In accordance with one or more aspects of the disclosed embodiment the seal between the load port and the portable cryogenic workstation seals the interior of the loading module from an external atmosphere.

In accordance with one or more aspects of the disclosed embodiment the seal between the load port and the portable cryogenic workstation seals the interior of the portable cryogenic workstation from an outside atmosphere.

In accordance with one or more aspects of the disclosed embodiment the load port includes a load port door configured to engage a lid of the portable cryogenic workstation.

In accordance with one or more aspects of the disclosed embodiment the engagement is a magnetic engagement.

In accordance with one or more aspects of the disclosed embodiment movement of the load port door opens and closes the portable cryogenic workstation.

In accordance with one or more aspects of the disclosed embodiment the load port is configured such that when the load port is opened, a housing of the portable cryogenic workstation closes the closeable input/output port.

In accordance with one or more aspects of the disclosed embodiment the portable cryogenic workstation effects a thermal block to heat load entry into the cryogenic portion of the workstation through the load port.

In accordance with one or more aspects of the disclosed embodiment a cryogenic workstation includes

a storage module having an ultra-cold storage vault configured to store racks of cryogenic samples,

a loading module disposed external to the storage module and including a load port and a closeable opening, the closeable opening communicably connecting the loading module to the storage module where the cryogenic samples are transferred between the storage module and the loading module through the closeable opening, and the load port including a closeable input/output port, and

a portable cryogenic workstation module configured to engage the closeable input/output port.

In accordance with one or more aspects of the disclosed embodiment engagement of the portable cryogenic workstation with the closeable input/output port effects a seal between the load port and the portable cryogenic workstation so that when the load port is opened an interior of the loading module is in sealed communication with an interior of the portable cryogenic workstation.

In accordance with one or more aspects of the disclosed embodiment the cryogenic samples are transferred between the storage module and the loading module through or in the racks.

In accordance with one or more aspects of the disclosed embodiment the seal between the load port and the portable cryogenic workstation seals the interior of the loading module from an external atmosphere.

In accordance with one or more aspects of the disclosed embodiment the seal between the load port and the portable cryogenic workstation seals the interior of the portable cryogenic workstation from an outside atmosphere.

In accordance with one or more aspects of the disclosed embodiment the load port includes a load port door and the portable cryogenic workstation includes a lid, the load port door being configured to engage the lid of the portable cryogenic workstation for removing the lid from the portable cryogenic workstation.

In accordance with one or more aspects of the disclosed embodiment movement of the load port door opens and closes the portable cryogenic workstation.

In accordance with one or more aspects of the disclosed embodiment the portable cryogenic workstation includes a housing configured to close the closeable input/output port when the load port is opened.

In accordance with one or more aspects of the disclosed embodiment the portable cryogenic workstation is configured to effect a thermal block to heat load entry into the cryogenic workstation through the load port.

In accordance with one or more aspects of the disclosed embodiment a portable cryogenic workstation includes

a housing having an opening forming an interior cavity configured to hold one or more racks of cryogenic samples and a lid interface disposed around a periphery of the opening, and

a lid configured to close the opening and substantially seal the interior cavity, the lid having a housing interface configured to engage the lid interface so that the lid effects sealing of the interior cavity and to disengage the lid interface and unseal the interior cavity with a single axis movement of the lid relative to the housing.

In accordance with one or more aspects of the disclosed embodiment, the lid is configured to disengage the lid interface and unseal the interior cavity with no more than a single axis movement of the lid relative to the housing.

In accordance with one or more aspects of the disclosed embodiment the housing and lid are thermally insulated.

In accordance with one or more aspects of the disclosed embodiment the interior cavity includes a cryogenic refrigerant cooling unit.

In accordance with one or more aspects of the disclosed embodiment the cryogenic refrigerant cooling unit includes an absorbent pad configured to hold the cryogenic refrigerant within the cryogenic refrigerant holding space.

In accordance with one or more aspects of the disclosed embodiment the interior cavity is configured to hold one or more trays of cryogenic samples.

In accordance with one or more aspects of the disclosed embodiment the portable cryogenic workstation includes a handle connected to the housing configured to allow one handed transport of the portable cryogenic workstation.

In accordance with one or more aspects of the disclosed embodiment the portable cryogenic workstation includes a temperature sensor disposed within the interior cavity and a temperature display, in communication with the temperature sensor, disposed on an exterior surface of the housing.

In accordance with one or more aspects of the disclosed embodiment an interface device for a portable cryogenic workstation includes a housing forming an internal chamber and at least one portable cryogenic workstation interface disposed at least partly within the internal chamber, the at least one portable cryogenic workstation interface being configured to access an interior of the portable cryogenic workstation and load and unload samples from the interior, where the portable cryogenic workstation is configured for porting in and out of the interface device housing while maintaining a cryogenic atmosphere within the portable cryogenic workstation.

In accordance with one or more aspects of the disclosed embodiment the interface device is configured to isolate a human operator from the interior.

In accordance with one or more aspects of the disclosed embodiment the interface device is configured as a stand alone device for bench top placement.

In accordance with one or more aspects of the disclosed embodiment the interface device may be integrated with an automated material handling system or refrigerant replenishment station.

In accordance with one or more aspects of the disclosed embodiment the at least one portable cryogenic workstation interface is configured for manual operation.

In accordance with one or more aspects of the disclosed embodiment the at least one portable cryogenic workstation interface is configured for automated operation.

In accordance with one or more aspects of the disclosed embodiment the interface device includes a display and processor for communicating process or ephemeral data to and from the portable cryogenic workstation.

In accordance with one or more aspects of the disclosed embodiment the at least one portable cryogenic workstation interface includes one or more kinematic locating features for deterministically locating the portable cryogenic workstation with respect to a predetermined reference frame of the interface device.

In accordance with one or more aspects of the disclosed embodiment an automated material handling system for transporting portable cryogenic workstations includes

a first cryogenic workstation location and a second cryogenic workstation location that is different than the first cryogenic workstation,

an automated transport configured to travel between the first and second cryogenic workstations, the automated transport having an effector for transporting at least one workstation,

the at least one portable cryogenic workstation includes

a housing configured to hold a cryogenic environment within an openable cavity of the housing through a removable closure, the housing including a first interface configured to engage the automated transport and a second interface configured to deterministically position the at least one portable cryogenic workstation at in interface station at one of the first and second cryogenic workstation location, and

an automated workpiece transport configured to automatically pick or place at least one workpiece within the at least one portable cryogenic workstation.

In accordance with one or more aspects of the disclosed embodiment the automate workpiece transport comprises a robotic arm with an end effector configured for picking workpieces.

In accordance with one or more aspects of the disclosed embodiment the automated transport comprises an overhead transport system.

In accordance with one or more aspects of the disclosed embodiment the automated transport comprises an automated guided vehicle.

In accordance with one or more aspects of the disclosed embodiment the automated transport comprises a conveyor.

In accordance with one or more aspects of the disclosed embodiment the automated transport comprises two different types of transport configured to transfer the at least one portable cryogenic workstation between the two different types of transports.

In accordance with one or more aspects of the disclosed embodiment the two different types of transport one or more of an exterior and interior transport relative to a storage housing and comprise at least two of an overhead transport system, a conveyor system and an automated guided vehicle.

In accordance with one or more aspects of the disclosed embodiment an automated material handling system includes

a portable cryogenic workstation transport unit having an effector configured to engage and transport a portable cryogenic workstation, where the portable cryogenic workstation includes a housing forming an internal cavity and a lid configured to substantially seal the internal cavity; and

an automated sample handling system configured to transport samples to and from the internal cavity, at least one of the automated sample handling system and the transport unit having a lid removal system configured to engage kinematic coupling features of the lid for deterministically locating the lid relative to the lid removal system.

In accordance with one or more aspects of the disclosed embodiment the effector is configured to engage kinematic coupling features of the housing to deterministically locate the housing relative to the automated sample handling system.

In accordance with one or more aspects of the disclosed embodiment a consumable media replenishment station includes a fill port configured to communicate a consumable media to an interior of a portable cryogenic workstation and kinematic locating features configured to interface with the portable cryogenic workstation for deterministically locating the portable cryogenic workstation relative to the fill port.

In accordance with one or more aspects of the disclosed embodiment the consumable media replenishment station is disposed at a load port of an automated cryogenic sample handling station.

In accordance with one or more aspects of the disclosed embodiment the consumable media replenishment station is a stand alone replenishment station.

In accordance with one or more aspects of the disclosed embodiment the fill port comprises a manifold configured to interface with two or more portable cryogenic workstations.

In accordance with one or more aspects of the disclosed embodiment a cryogenic workstation includes

a storage module having an ultra-cold storage vault configured to store racks of cryogenic samples,

a loading module disposed external to the storage module and including a load port and a closeable opening, the closeable opening communicably connecting the loading module to the storage module where the cryogenic samples are transferred between the storage module and the loading module through the closeable opening, the load port including a closeable input/output port configured to engage a portable cryogenic workstation where engagement of the load port with the portable cryogenic workstation effects a seal between the load port and the portable cryogenic workstation so that when the load port is opened an interior of the loading module is in sealed communication with an interior of the portable cryogenic workstation, and

a consumable media replenishment fill port disposed at the load port and configured to communicate with a fill channel of the portable cryogenic workstation.

It should be understood that the foregoing description is only illustrative of the aspects of the disclosed embodiment. Various alternatives and modifications can be devised by those skilled in the art without departing from the aspects of the disclosed embodiment. Accordingly, the aspects of the disclosed embodiment are intended to embrace all such alternatives, modifications and variances that fall within the scope of the appended claims. Further, the mere fact that different features are recited in mutually different dependent or independent claims does not indicate that a combination of these features cannot be advantageously used, such a combination remaining within the scope of the aspects of the invention.

What is claimed is:

1. A portable cryogenic workstation comprising:
a housing having an internal cavity configured to hold one or more samples;
a lid for sealing the internal cavity such that the portable cryogenic workstation is configured for transporting samples between about room temperature environments to about ultra-cold environments;
at least one automation interface disposed on one or more of the housing and lid and configured for engagement with automated handling equipment; and
a process data capture unit coupled to the housing and configured to capture process or ephemeral data corresponding to a predetermined processing characteristic(s) of at least one of the samples coincident with presence inside the portable cryogenic workstation.

2. The portable cryogenic workstation of claim 1, wherein the process data capture unit is configured so that the process or ephemeral data captured define process history and enables analysis of the predetermined processing characteristic(s) of at least one of the samples.

3. The portable cryogenic workstation of claim 1, wherein the process data capture unit is communicably coupled to a controller and at least one sensor connected to the controller where the at least one sensor is configured to provide one or more of sample location data, sample identification data, temperature data and a physical state of the lid relative to the housing.

4. The portable cryogenic workstation of claim 1, wherein the portable cryogenic workstation includes a consumable media level detector.

5. A portable cryogenic workstation comprising:
a housing having an opening forming an interior cavity configured to hold one or more racks of cryogenic samples, a workstation interface and a lid interface disposed around a periphery of the opening; and
a lid configured to close the opening and substantially seal the interior cavity, the lid having a housing interface configured to engage the lid interface so that the lid effects sealing of the interior cavity and to disengage the lid interface and unseal the interior cavity with a single axis movement of the lid relative to the housing;
wherein the housing is configured to engage a closable input/output port of a workstation.

6. The portable cryogenic workstation of claim 5, wherein engagement of the housing with the input/output port effects a seal between the input/output port and the workstation interface so that when the lid is opened the interior cavity is in sealed communication with an interior of the workstation.

7. The portable cryogenic workstation of claim 5, wherein the housing is configured to effect a seal between the input/output port and the workstation interface with the lid separated from the housing.

8. The portable cryogenic workstation of claim 6, wherein the housing is configured to effect the seal between the input/output port and the workstation interface with the lid engaged to the housing and separated from the housing.

9. The portable cryogenic workstation of claim 6, wherein the seal between the input/output port and the portable cryogenic workstation seals the interior of a loading module of the workstation from an external atmosphere.

10. The portable cryogenic workstation of claim 6, wherein the seal between the input/output port and the portable cryogenic workstation seals the interior of the portable cryogenic workstation from an outside atmosphere.

11. The portable cryogenic workstation of claim 6, wherein the housing is configured to effect the seal between the input/output port and the workstation interface with the lid engaged to the housing.

12. The portable cryogenic workstation of claim 5, wherein the portable cryogenic workstation includes a consumable media level detector.

13. The portable cryogenic workstation of claim 5, wherein the portable cryogenic workstation is configured to record process data related to predetermined characteristics of one or more of the samples, the housing and the lid.

14. The portable cryogenic workstation of claim 5, further comprising a controller, a memory and at least one sensor, the memory and the at least one sensor each being connected to the controller, the controller being configured to effect a recordation of process tracking data in the memory based on signals from the at least one sensor.

15. The portable cryogenic workstation of claim 12, wherein the controller is configured to effect the recordation of process tracking data in response to a triggering event.

16. The portable cryogenic workstation of claim 12, wherein the controller is configured to allow analysis of the process tracking data.

17. The portable cryogenic workstation of claim 12, wherein the controller, memory and at least one sensor are integral with the one or more of the housing and the lid.

18. The portable cryogenic workstation of claim 5, wherein the portable cryogenic workstation effects a thermal block to heat load entry into the cryogenic portion of the workstation through the input/output port.

19. A cryogenic workstation comprising:
a storage module having an ultra-cold storage vault configured to store racks of cryogenic samples;
a loading module disposed external to the storage module and including a load port and a closeable opening, the closeable opening communicably connecting the loading module to the storage module where the cryogenic samples are transferred between the storage module and the loading module through the closeable opening, and the load port including a closeable input/output port; and
a portable cryogenic workstation module configured to engage the closeable input/output port.

20. The cryogenic workstation of claim 19, wherein engagement of the portable cryogenic workstation with the closeable input/output port effects a seal between the load port and the portable cryogenic workstation so that when the load port is opened an interior of the loading module is in sealed communication with an interior of the portable cryogenic workstation.

21. The cryogenic workstation of claim 20, wherein the seal between the load port and the portable cryogenic workstation module seals the interior of the loading module from an external atmosphere.

22. The cryogenic workstation of claim 20, wherein the seal between the load port and the portable cryogenic workstation seals the interior of the portable cryogenic workstation module from an outside atmosphere.

23. The cryogenic workstation of claim 19, wherein the portable cryogenic workstation module includes a housing configured to close the closeable input/output port when the load port is opened.

24. The cryogenic workstation of claim 19, further comprising an interface device for a portable cryogenic workstation, the interface device includes a housing forming an internal chamber and at least one portable cryogenic workstation interface disposed at least partly within the internal chamber, the at least one portable cryogenic workstation interface being configured to access an interior of the portable cryogenic workstation and load and unload samples from the interior, where the portable cryogenic workstation is configured for porting in and out of the interface device housing while maintaining a cryogenic atmosphere within the portable cryogenic workstation.

25. The cryogenic workstation of claim 24, wherein the interface device is configured to isolate a human operator from the interior.

26. The cryogenic workstation of claim 24, wherein the interface device is configured as a stand alone device for bench top placement.

27. The cryogenic workstation of claim 24, wherein the interface device may be integrated with an automated material handling system or refrigerant replenishment station.

28. The cryogenic workstation of claim 24, wherein the at least one portable cryogenic workstation interface is configured for manual operation.

29. The cryogenic workstation of claim 24, wherein the at least one portable cryogenic workstation interface is configured for automated operation.

30. The cryogenic workstation of claim 24, wherein the interface device includes a display and processor for communicating process or ephemeral data to and from the portable cryogenic workstation.

31. The cryogenic workstation of claim 19, wherein the at least one portable cryogenic workstation interface device includes one or more kinematic locating features for deterministically locating the portable cryogenic workstation with respect to a predetermined reference frame of the interface device.

32. An automated material handling system for transporting portable cryogenic workstations comprising:
a first cryogenic workstation location and a second cryogenic workstation location that is different than the first cryogenic workstation location;
an automated transport configured to travel between the first and second cryogenic workstation locations, the automated transport having an effector for transporting at least one portable cryogenic workstation; and
the at least one portable cryogenic workstation includes a housing configured to hold a cryogenic environment within an openable cavity of the housing through a removable closure, the housing including a first interface configured to engage the automated transport and a second interface configured to deterministically position the at least one portable cryogenic workstation at an interface station at one of the first and second cryogenic workstation locations; and
an automated workpiece transport configured to automatically pick or place at least one workpiece within the at least one portable cryogenic workstation.

33. The automated material handling system of claim 32, wherein the automated workpiece transport comprises a robotic arm with an end effector configured for picking workpieces.

34. The automated material handling system of claim 32, wherein the automated transport comprises an overhead transport system.

35. The automated material handling system of claim 32, wherein the automated transport comprises an automated guided vehicle.

36. The automated material handling system of claim 32, wherein the automated transport comprises a conveyor.

37. The automated material handling system of claim 32, wherein the automated transport comprises two different types of transport configured to transfer the at least one portable cryogenic workstation between the two different types of transports.

38. An automated material handling system comprising:
a portable cryogenic workstation transport unit having an effector configured to engage and transport a portable cryogenic workstation, where the portable cryogenic workstation includes a housing forming an internal cavity and a lid configured to substantially seal the internal cavity; and
an automated sample handling system configured to transport samples to and from the internal cavity, at least one of the automated sample handling system and the transport unit having a lid removal system configured to engage kinematic coupling features of the lid for deterministically locating the lid relative to the lid removal system.

39. The automated material handling system of claim 38, wherein the effector is configured to engage kinematic coupling features of the housing to deterministically locate the housing relative to the automated sample handling system.

40. A consumable media replenishment station comprising:
a fill port configured to communicate a consumable media to an interior of a portable cryogenic workstation; and
kinematic locating features configured to interface with the portable cryogenic workstation for deterministically locating the portable cryogenic workstation relative to the fill port.

41. The consumable media replenishment station of claim 40, wherein the consumable media replenishment station is disposed at a load port of an automated cryogenic sample handling station.

42. The consumable media replenishment station of claim 40, wherein the consumable media replenishment station is a stand alone replenishment station.

43. The consumable media replenishment station of claim 40, wherein the fill port comprises a manifold configured to interface with two or more portable cryogenic workstations.
